(19) United States
(12) Patent Application Publication
(10) Pub. No.: US 2024/0324088 A1
(43) Pub. Date: Sep. 26, 2024

(54) LIGHTING EFFECTS

(71) Applicant: Apple Inc., Cupertino, CA (US)

(72) Inventors: Jean-Pierre M. MOUILLESEAUX, San Carlos, CA (US); Karlin Y. BARK, San Carlos, CA (US); Felipe BACIM DE ARAUJO E SILVA, San Jose, CA (US)

(21) Appl. No.: 18/611,568

(22) Filed: Mar. 20, 2024

Related U.S. Application Data
(60) Provisional application No. 63/453,721, filed on Mar. 21, 2023.

(51) Int. Cl. H05B 47/175; G06F 3/01

(52) U.S. Cl. CPC H05B 47/1975; G06F 3/011; H05B 47/197; G06F 3/017

(57) ABSTRACT

The present disclosure generally relates to providing lighting effects.

### CROSS-REFERENCE TO RELATED APPLICATIONS

The present application claims priority to U.S. Provisional Patent Application Ser. No. 63/453,721, entitled “LIGHTING EFFECTS” filed Mar. 21, 2023, which is hereby incorporated by reference in its entirety for all purposes.

### FIELD

The present disclosure relates generally to computer user interfaces, and more specifically to techniques for providing lighting effects.

### BACKGROUND

Light is often used for different purposes. For example, light can be used to illuminate a room and/or region of a physical environment.

### SUMMARY

Some techniques for providing lighting effects using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing lighting effects. Such methods and interfaces optionally complement or replace other methods for providing lighting effects. Such methods and interfaces reduce the cognitive burden on a user and produce a more efficient human-machine interface. For battery-operated computing devices, such methods and interfaces conserve power and increase the time between battery charges.

In some examples, a method that is performed at a computer system that is in communication with a light source is described. In some examples, the method comprises: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a non-transitory computer-readable storage medium storing one or more programs configured to be executed by one or more processors of a computer system that is in communication with a light source is described. In some examples, the one or more programs includes instructions for: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a transitory computer-readable storage medium storing one or more programs configured to be executed by one or more processors of a computer system that is in communication with a light source is described. In some examples, the one or more programs includes instructions for: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a computer system that is in communication with a light source is described. In some examples, the computer system that is in communication with a light source comprises one or more processors and memory storing one or more program configured to be executed by the one or more processors. In some examples, the one or more programs includes instructions for: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a computer system that is in communication with a light source is described. In some examples, the computer system that is in communication with a light source comprises means for performing each of the following steps: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a computer program product is described. In some examples, the computer program product comprises one or more programs configured to be executed by one or more processors of a computer system that is in communication with a light source. In some examples, the one or more programs include instructions for: detecting a request to illuminate a region of a physical space; and in response to detecting the request to illuminate the region of the physical space: in accordance with a determination that the region of the physical space has a first property, providing, via the light source, a first type of illumination; and in accordance with a determination that the region of the physical space has a second property different from the first property, forgoing providing the first type of illumination.

In some examples, a method that is performed at a computer system that is in communication with a light source is described. In some examples, the method comprises: while detecting a user in a physical space, detecting a change in user activity in the physical space; and in response to detecting the change in user activity in the physical space, changing lighting, via the light source, of the physical space while a user continues to be detected in the physical space.

In some examples, a non-transitory computer-readable storage medium storing one or more programs configured to be executed by one or more processors of a computer system that is in communication with a light source is described. In some examples, the one or more programs includes instructions for: while detecting a user in a physical space, detecting a change in user activity in the physical space; and in response to detecting the change in user activity in the physical space, changing lighting, via the light source, of the physical space while a user continues to be detected in the physical space.

In some examples, a transitory computer-readable storage medium storing one or more programs configured to be executed by one or more processors of a computer system that is in communication with a light source is described. In some examples, the one or more programs includes instructions for: while detecting a user in a physical space, detecting a change in user activity in the physical space; and in response to detecting the change in user activity in the physical space, changing lighting, via the light source, of the physical space while a user continues to be detected in the physical space.

In some examples, a computer system that is in communication with a light source is described. In some examples, the computer system that is in communication with a light source comprises one or more processors and memory storing one or more program configured to be executed by the one or more processors. In some examples, the one or more programs includes instructions for: while detecting a user in a physical space, detecting a change in user activity in the physical space; and in response to detecting the change in user activity in the physical space, changing lighting, via the light source, of the physical space while a user continues to be detected in the physical space.

In some examples, a computer system that is in communication with a light source is described. In some examples, the computer system that is in communication with a light source comprises means for performing each of the following steps: while detecting a user in a physical space, detecting a change in user activity in the physical space; and in response to detecting the change in user activity in the physical space, changing lighting, via the light source, of the physical space while a user continues to be detected in the physical space.

In some examples, a computer program product is described. In some examples, the computer program product comprises one or more programs configured to be executed by one or more processors of a computer system that is in communication with a light source. In some examples, the one or more programs include instructions for: while detecting a user in a physical space, detecting a change in user activity in the physical space; and in response to detecting the change in user activity in the physical space, changing lighting, via the light source, of the physical space while a user continues to be detected in the physical space.

In some examples, a method that is performed at a computer system that is in communication with a light source is described. In some examples, the method comprises: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a non-transitory computer-readable storage medium storing one or more programs configured to be executed by one or more processors of a computer system that is in communication with a light source is described. In some examples, the one or more programs includes instructions for: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a transitory computer-readable storage medium storing one or more programs configured to be executed by one or more processors of a computer system that is in communication with a light source is described. In some examples, the one or more programs includes instructions for: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a computer system that is in communication with a light source is described. In some examples, the computer system that is in communication with a light source comprises one or more processors and memory storing one or more program configured to be executed by the one or more processors. In some examples, the one or more programs includes instructions for: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a computer system that is in communication with a light source is described. In some examples, the computer system that is in communication with a light source comprises means for performing each of the following steps: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a computer program product is described. In some examples, the computer program product comprises one or more programs configured to be executed by one or more processors of a computer system that is in communication with a light source. In some examples, the one or more programs include instructions for: detecting an illumination request that corresponds to a request to illuminate a respective region of a physical space; and in response to detecting the illumination request: in accordance with a determination that the request corresponds to a first region of the physical space, illuminating, via the light source, the first region; and in accordance with a determination that the request corresponds to a second region of the physical space different from the first region, illuminating, via the light source, the second region.

In some examples, a method that is performed at a computer system that is in communication with a light source is described. In some examples, the method comprises: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a non-transitory computer-readable storage medium storing one or more programs configured to be executed by one or more processors of a computer system that is in communication with a light source is described. In some examples, the one or more programs includes instructions for: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a transitory computer-readable storage medium storing one or more programs configured to be executed by one or more processors of a computer system that is in communication with a light source is described. In some examples, the one or more programs includes instructions for: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a computer system that is in communication with a light source is described. In some examples, the computer system that is in communication with a light source comprises one or more processors and memory storing one or more program configured to be executed by the one or more processors. In some examples, the one or more programs includes instructions for: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a computer system that is in communication with a light source is described. In some examples, the computer system that is in communication with a light source comprises means for performing each of the following steps: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a computer program product is described. In some examples, the computer program product comprises one or more programs configured to be executed by one or more processors of a computer system that is in communication with a light source. In some examples, the one or more programs include instructions for: detecting a request to illuminate a region of a first physical space; and in response to detecting the request to illuminate the region of the first physical space: in accordance with a determination that a second physical space has a first context, illuminating, via the light source, the region of the first physical space to include a first abstract representation corresponding to the first context of the second physical space, wherein the second physical space is outside of the first physical space; and in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

In some examples, a method that is performed at a computer system that is in communication with a first device and a light source that is separate from the first device is described. In some examples, the method comprises: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

In some examples, a non-transitory computer-readable storage medium storing one or more programs configured to be executed by one or more processors of a computer system that is in communication with a first device and a light source that is separate from the first device is described. In some examples, the one or more programs includes instructions for: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

In some examples, a transitory computer-readable storage medium storing one or more programs configured to be executed by one or more processors of a computer system that is in communication with a first device and a light source that is separate from the first device is described. In some examples, the one or more programs includes instructions for: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

In some examples, a computer system that is in communication with a first device and a light source that is separate from the first device is described. In some examples, the computer system that is in communication with a first device and a light source that is separate from the first device comprises one or more processors and memory storing one or more program configured to be executed by the one or more processors. In some examples, the one or more programs includes instructions for: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

In some examples, a computer system that is in communication with a first device and a light source that is separate from the first device is described. In some examples, the computer system that is in communication with a first device and a light source that is separate from the first device comprises means for performing each of the following steps: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

In some examples, a computer program product is described. In some examples, the computer program product comprises one or more programs configured to be executed by one or more processors of a computer system that is in communication with a first device and a light source that is separate from the first device. In some examples, the one or more programs include instructions for: receiving a request to extend content being displayed on the first device to a physical space that includes a first region and a second region different from the first region; and in response to receiving the request to extend content being displayed on the first device and while content is being displayed on the first device: in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and in accordance with a determination that the first device is located at a second location in the physical space, illuminating, via the light source, the second region of the physical space that has the respective spatial arrangement relative to the second location in the physical space with the first light pattern that is based on content that is being displayed on the first device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing lighting effects, thereby increasing the effectiveness, efficiency, and user satisfaction with such devices. Such methods and interfaces may complement or replace other methods for providing lighting effects.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6B illustrate exemplary techniques for contextually aware illumination in accordance with some examples.

FIG. 7 is a flow diagram illustrating a method for providing contextually aware illumination in accordance with some examples.

FIGS. 8A-8E illustrate exemplary techniques for changing illumination based on detected user activity in accordance with some examples.

FIG. 9 is a flow diagram illustrating a method for changing illumination in accordance with some examples.

FIGS. 10A-10E illustrate exemplary techniques for communicating information using illumination location in accordance with some examples.

FIG. 11 is a flow diagram illustrating a method for communicating information in accordance with some examples.

FIGS. 12A-12D illustrate exemplary techniques for providing a representation of a context of a physical space in accordance with some examples.

FIG. 13 is a flow diagram illustrating a method for providing context in accordance with some examples.

FIGS. 14A-14D illustrate exemplary techniques for extending content onto a physical space in accordance with some examples.

FIG. 15 is a flow diagram illustrating a method for extending content in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing lighting effects. For example, light can be used to provide contextually aware illumination, react to detected user activity, communicate information, and/or extend content. Such techniques can reduce the cognitive burden on a user in a physical environment, thereby enhancing productivity. Further, such techniques can reduce processor and battery power otherwise wasted on redundant user inputs.

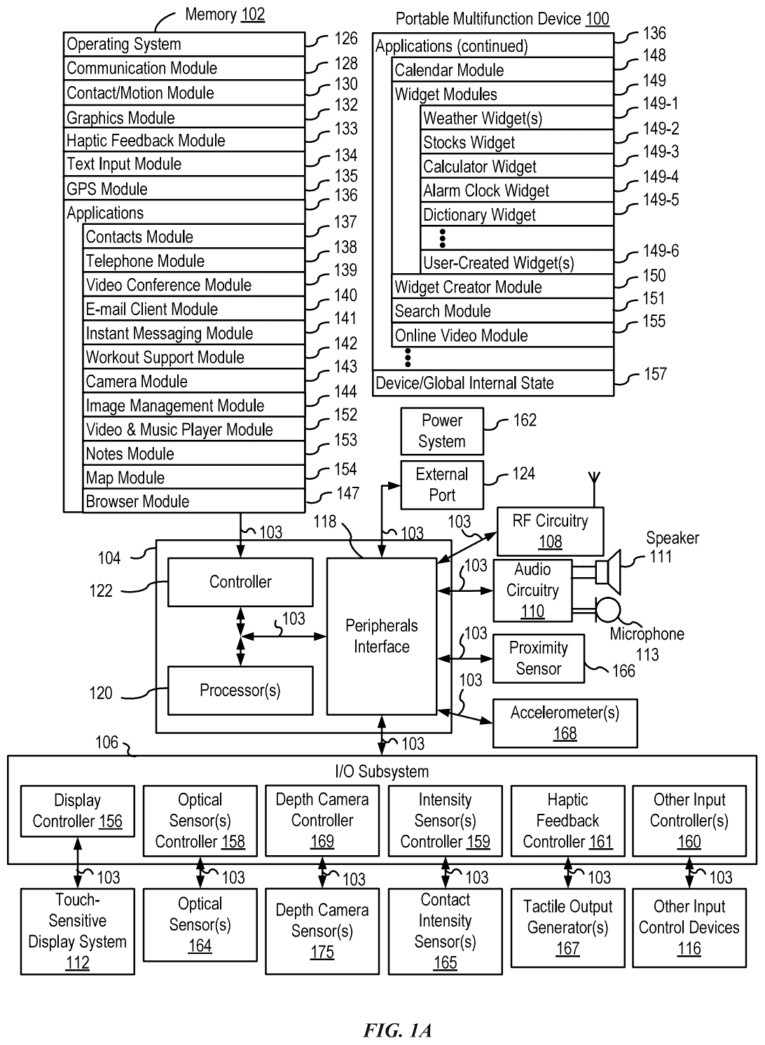

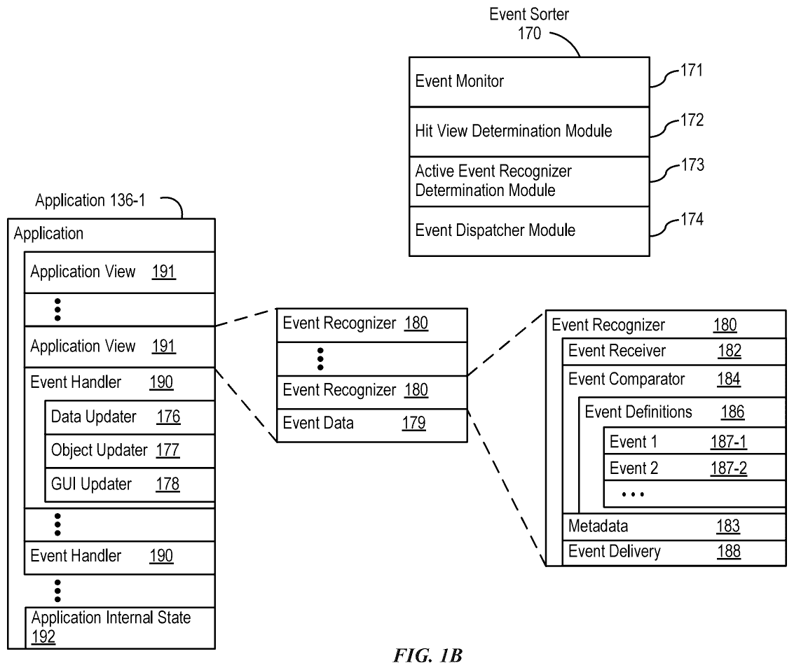

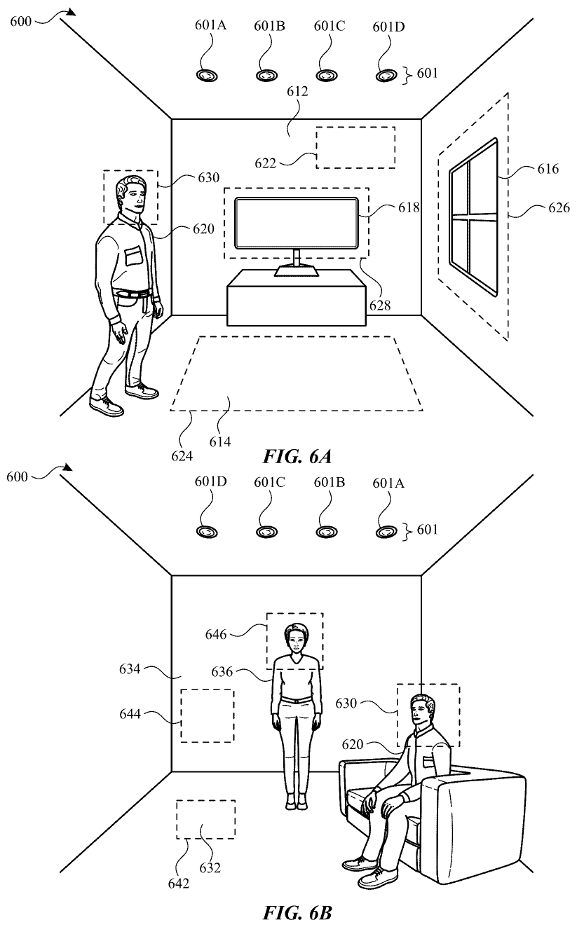

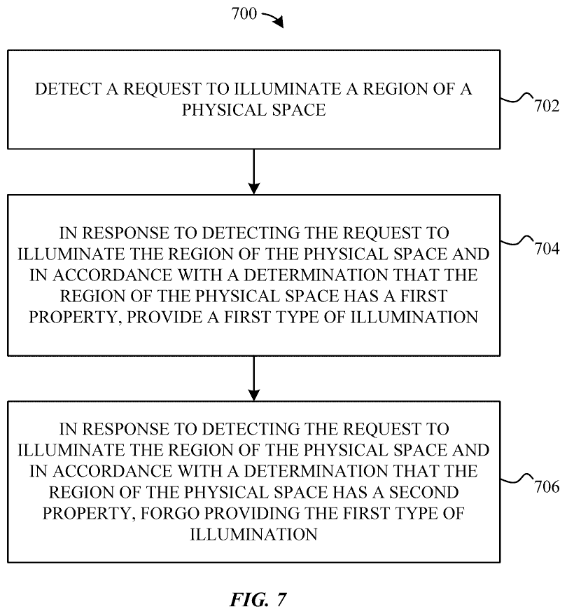

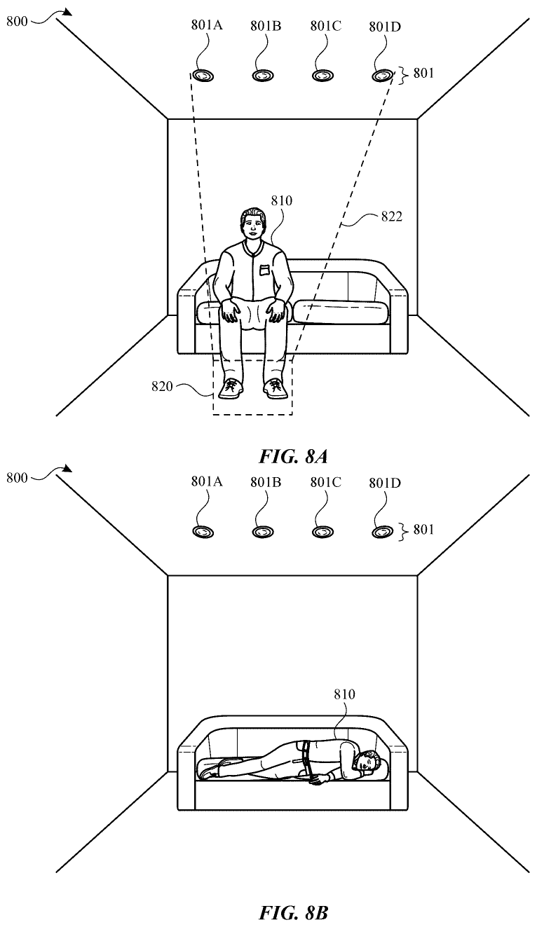

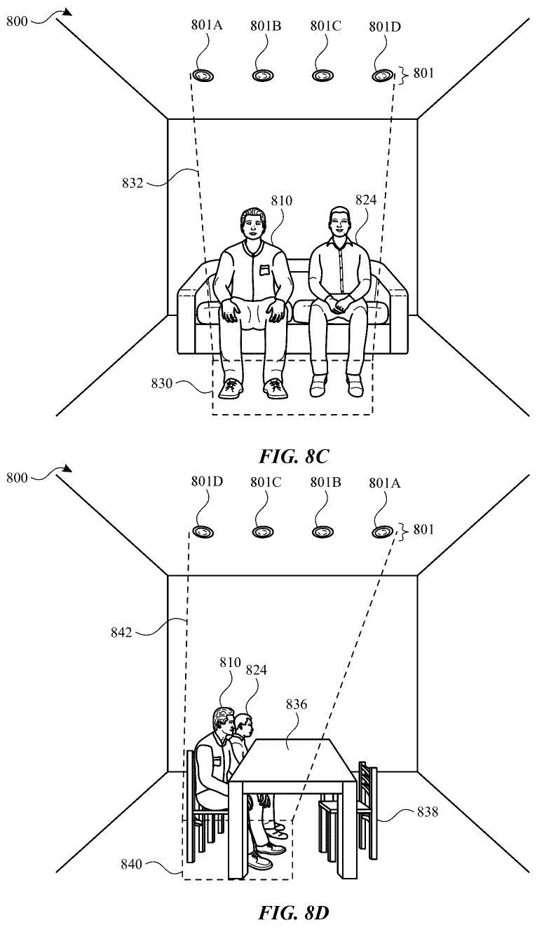

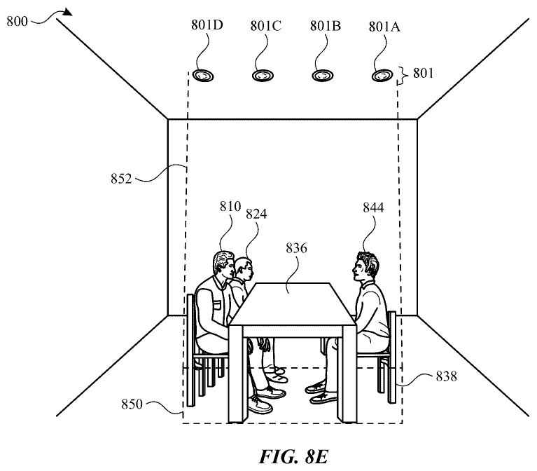

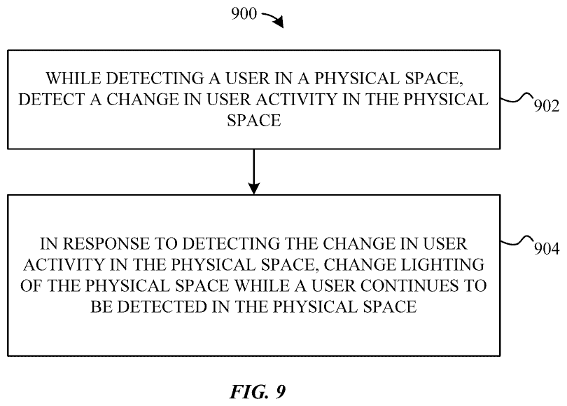

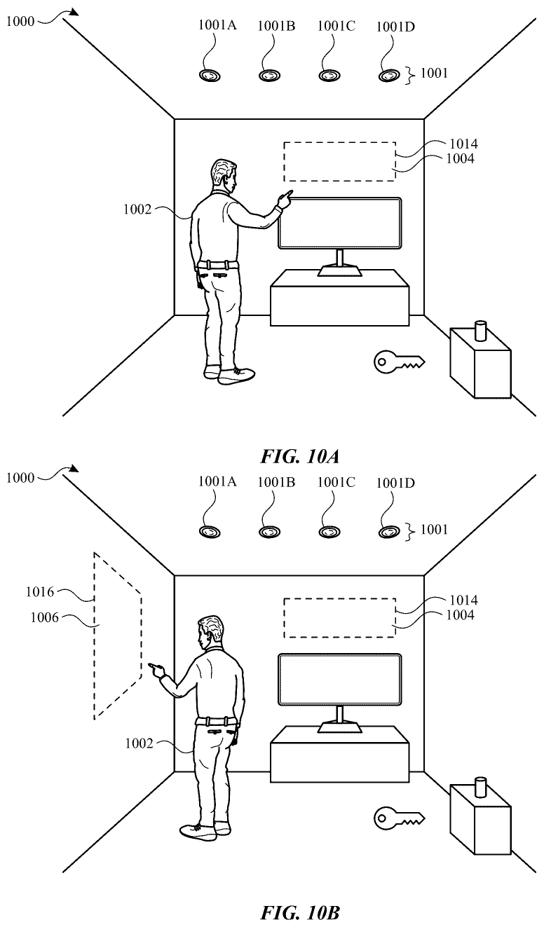

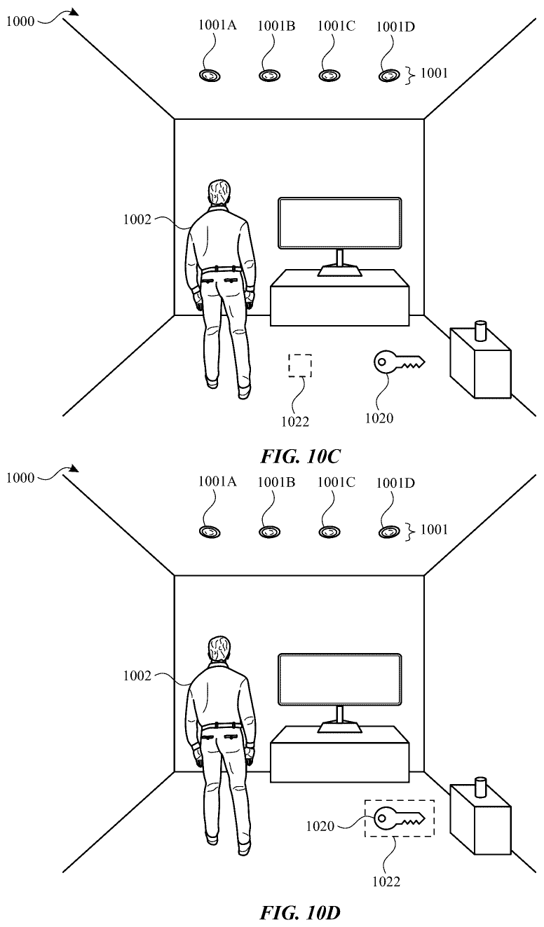

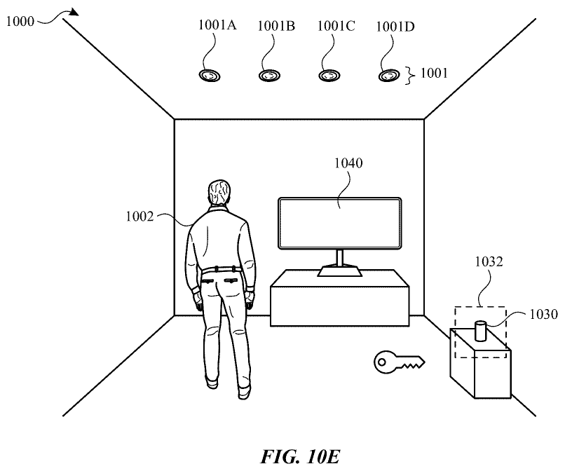

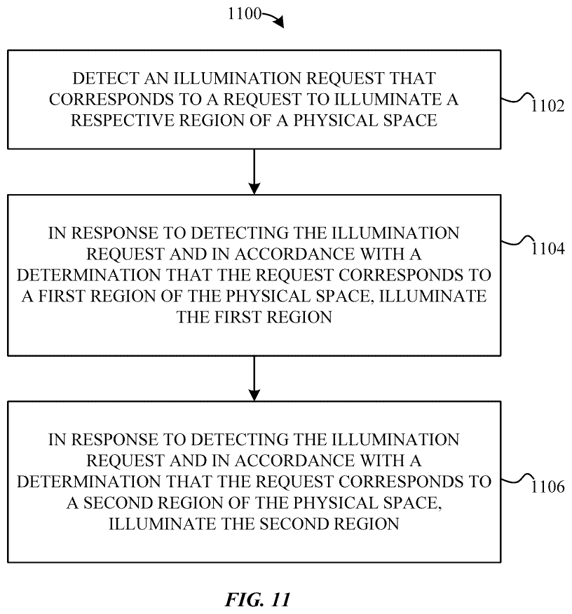

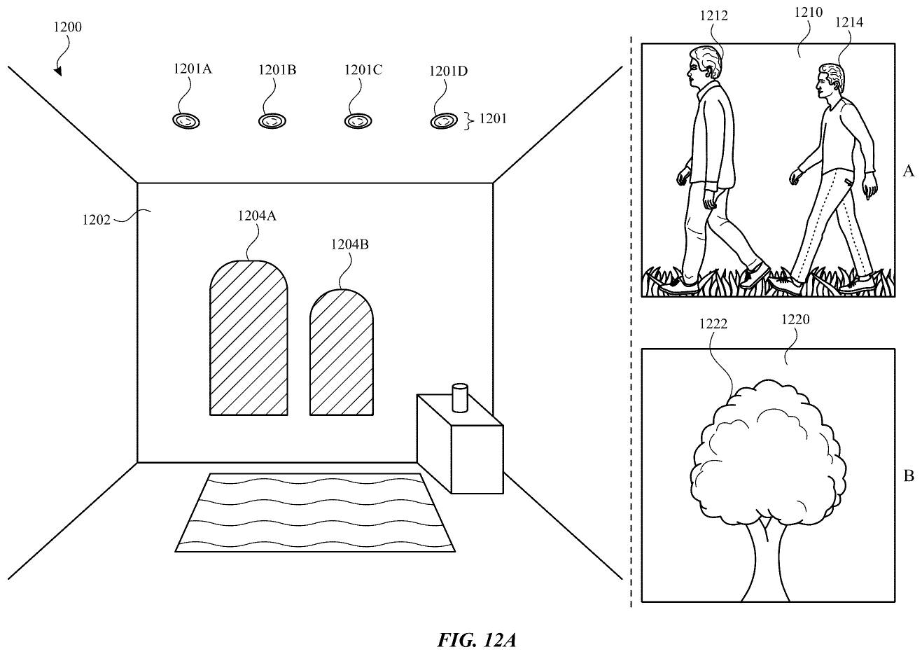

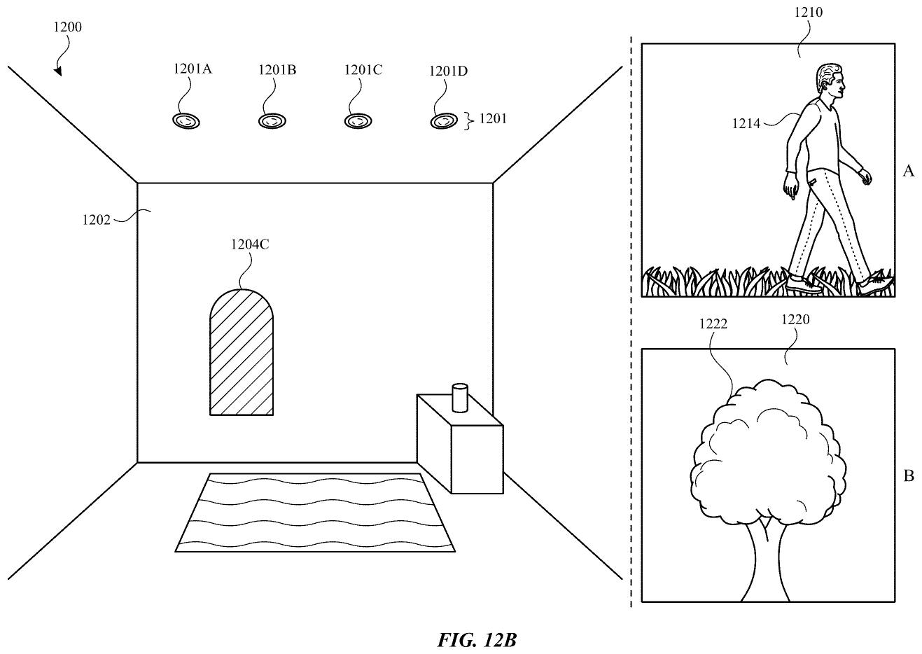

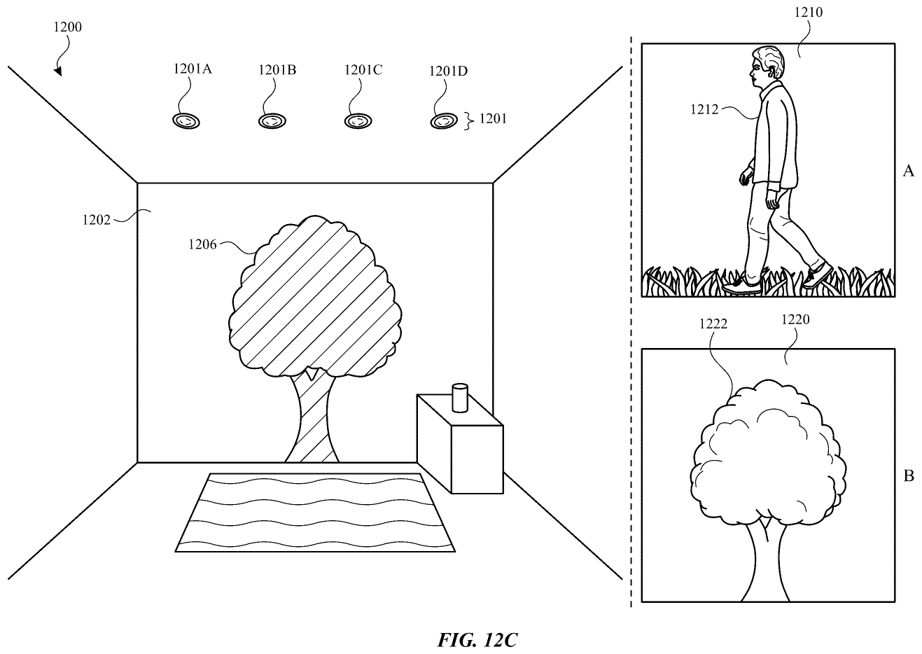

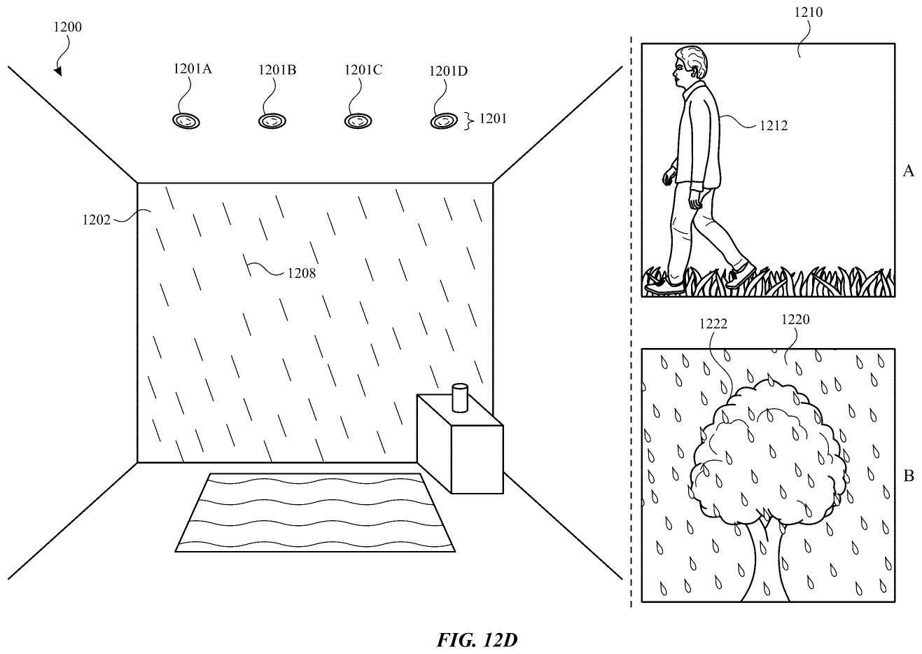

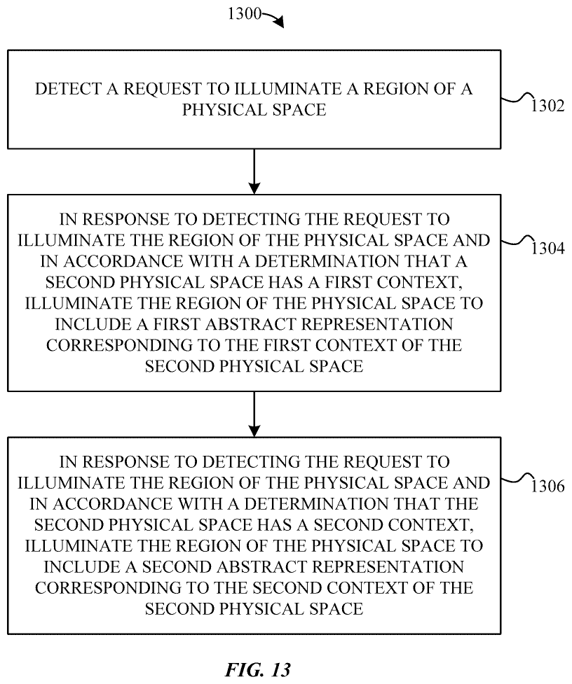

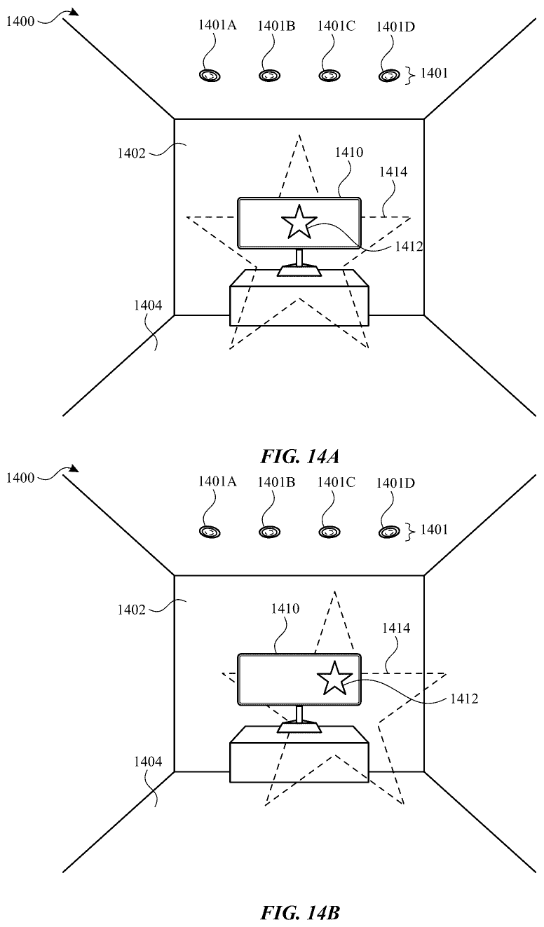

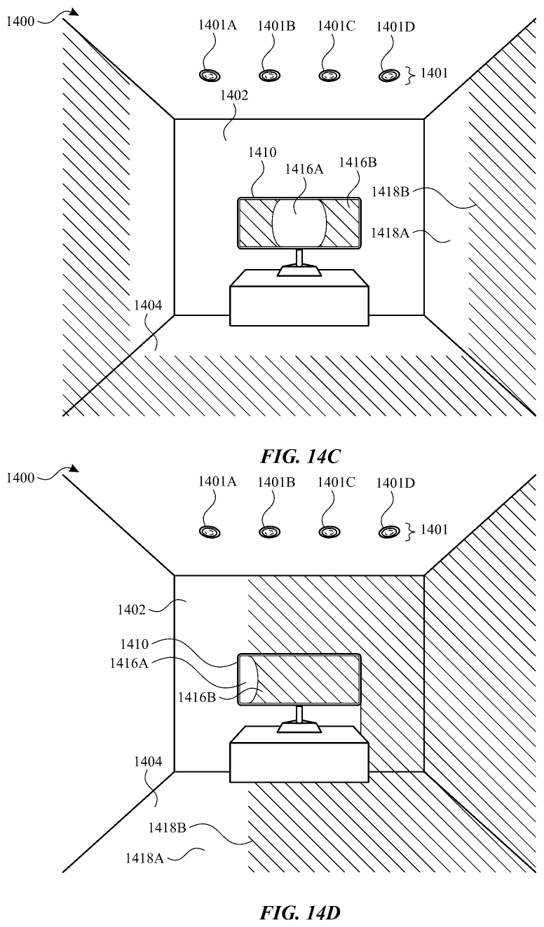

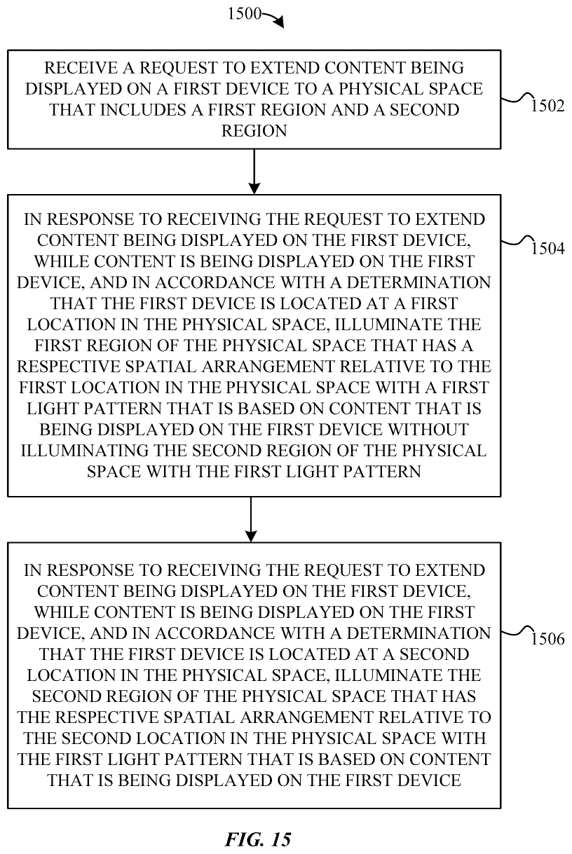

Below, FIGS. 1A-1B, 2, 3, 4A-4B, and 5A-5B provide a description of exemplary devices for performing the techniques for providing lighting effects. FIGS. 6A-6B illustrate exemplary techniques for contextually aware illumination in accordance with some examples. FIG. 7 is a flow diagram illustrating a method for providing contextually aware illumination in accordance with some examples. The user interfaces in FIGS. 6A-6B are used to illustrate the processes described below, including the processes in FIG. 7. FIGS. 8A-8E illustrate exemplary techniques for changing illumination based on detected user activity in accordance with some examples. FIG. 9 is a flow diagram illustrating a method for changing illumination in accordance with some examples. The user interfaces in FIGS. 8A-8E are used to illustrate the processes described below, including the processes in FIG. 9. FIGS. 10A-10E illustrate exemplary techniques for communicating information using illumination location in accordance with some examples. FIG. 11 is a flow diagram illustrating a method for communicating information in accordance with some examples. The user interfaces in FIGS. 10A-10E are used to illustrate the processes described below, including the processes in FIG. 11. FIGS. 12A-12D illustrate exemplary techniques for providing a representation of a context of a physical space in accordance with some examples. FIG. 13 is a flow diagram illustrating a method for providing context in accordance with some examples. The user interfaces in FIGS. 12A-12D are used to illustrate the processes described below, including the processes in FIG. 13. FIGS. 14A-14D illustrate exemplary techniques for extending content onto a physical space in accordance with some examples. FIG. 15 is a flow diagram illustrating a method for extending content in accordance with some examples. The user interfaces in FIGS. 14A-14D are used to illustrate the processes described below, including the processes in FIG. 15.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

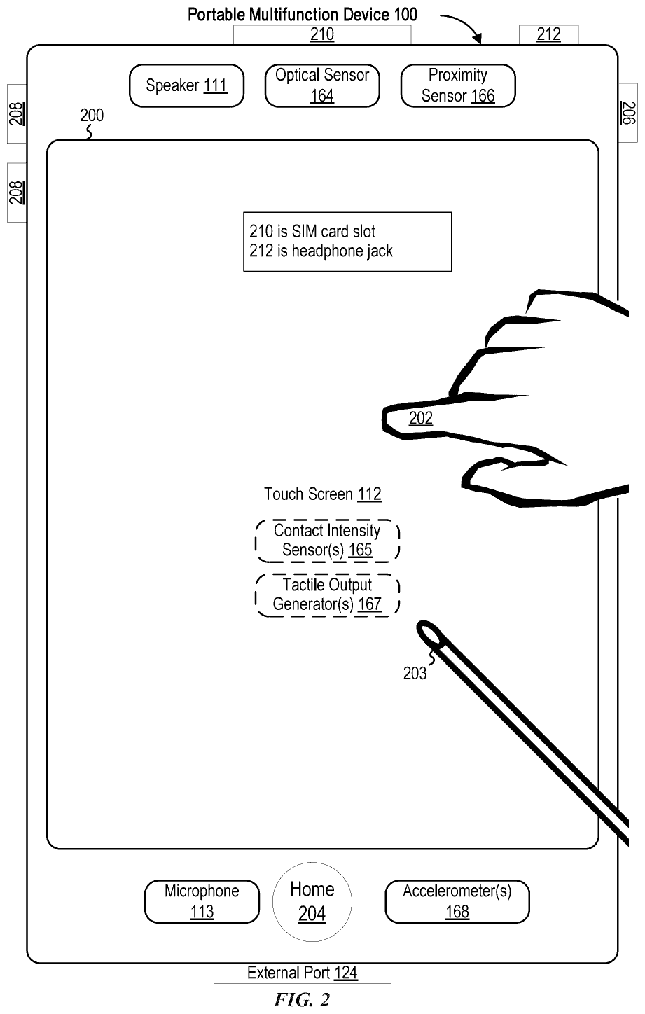

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

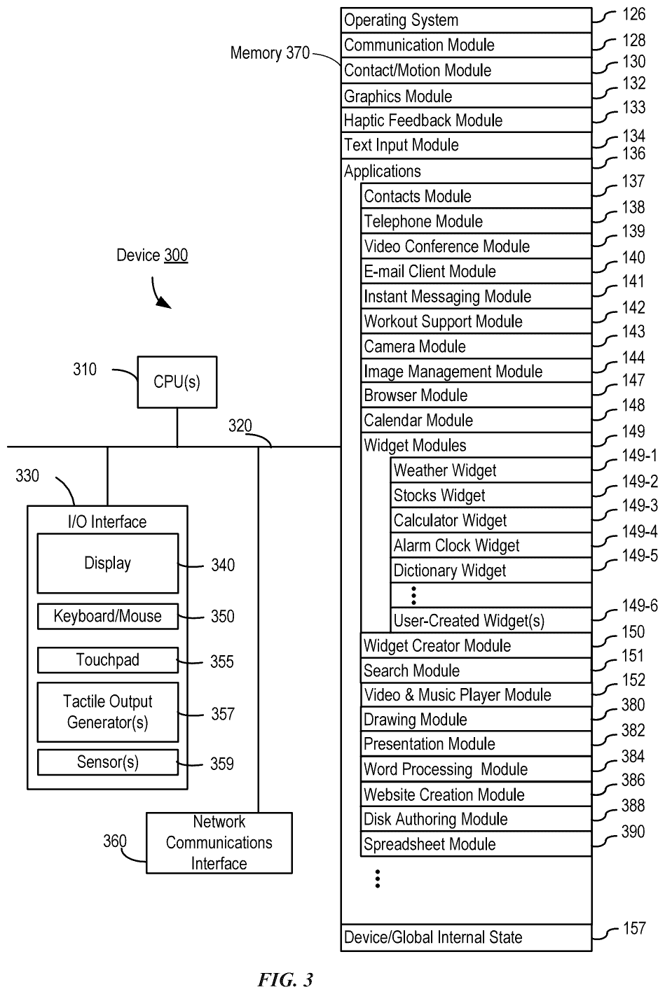

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

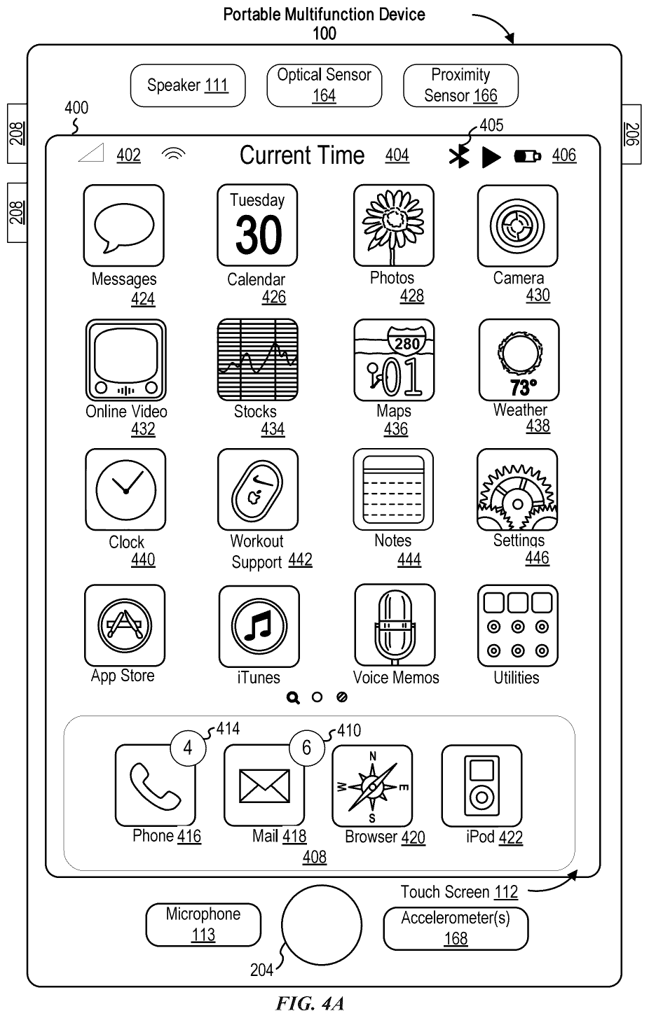

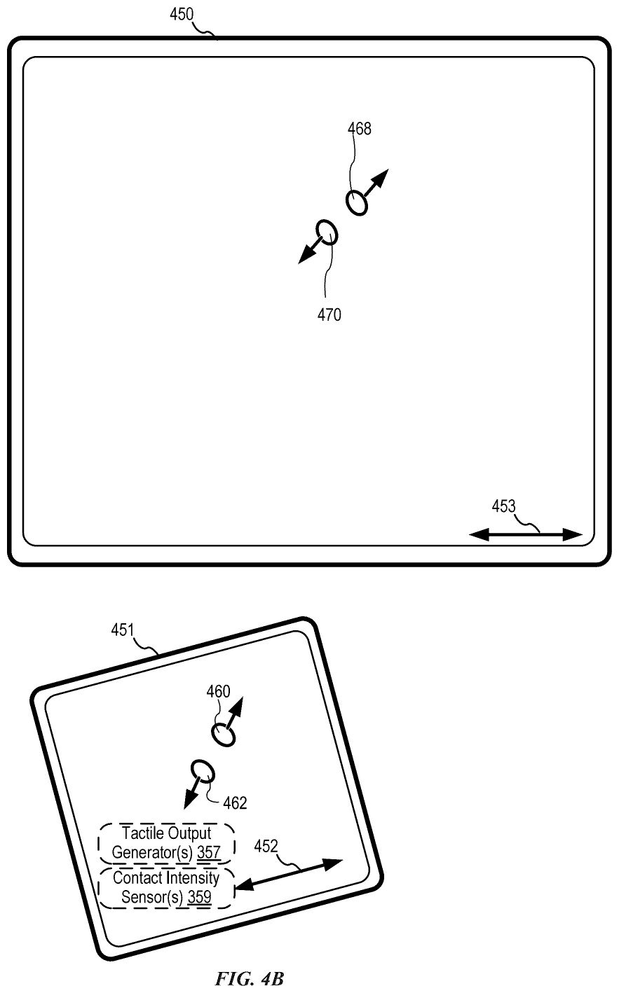

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

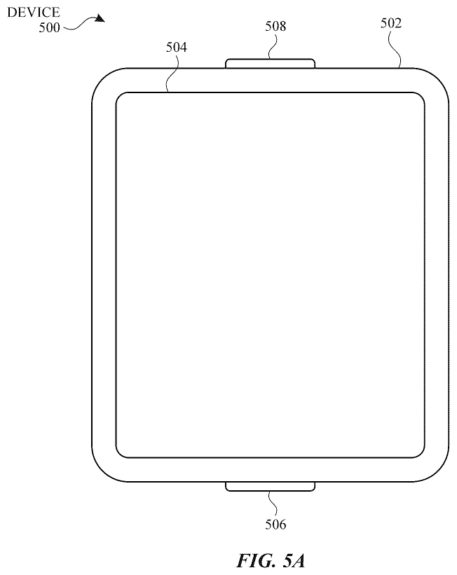

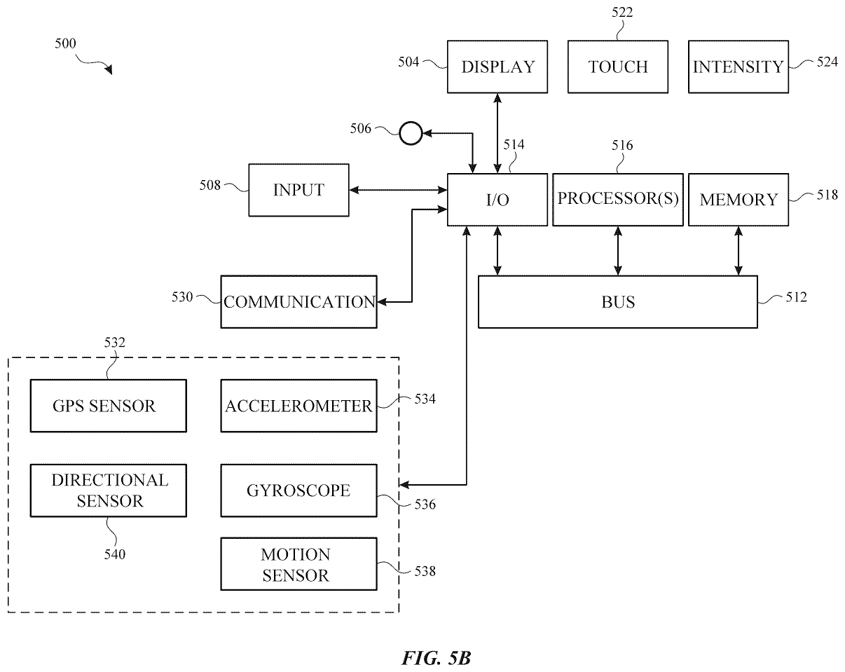

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700, 900, 1100, 1300, and 1500 (FIGS. 7, 9, 11, 13, and 15). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6B illustrate exemplary techniques for contextually aware illumination in accordance with some examples. The user interfaces in these figures are used to illustrate the processes described below, including the one or more processes described in relation to FIG. 7.

FIG. 6A illustrates physical space 600, a room in a house. Physical space 600 includes light source 601A, light source 601B, light source 601C, and light source 601D (collectively referred to hereinafter as light sources 601) to illuminate physical space 600. It should be recognized that more or fewer light sources can be included in light sources 601 (including only one light source) and the set of light sources can be arranged in any physical arrangement. In some examples, there is no physical restriction on physical placement, separation, orientation, and/or number of light sources). In some examples, each light source of light sources 601 has a separate housing (e.g., as illustrated by 601A, 601B, 601C, and 601D). In other examples, one or more light sources of light sources 601 share a common housing (e.g., a single light fixture for light source 601A, light source 601B, light source 601C, and/or light source 601D). Having a single light source and/or single light fixture to perform techniques described herein can, in some examples, be easier to install, configure, move, and/or replace than having multiple light sources and/or light fixtures perform the techniques described herein. In some examples, light sources 601 include one or more features as described herein with respect to any one or more light sources described with respect to FIGS. 8, 10, 12, and/or 14. In some examples, physical space 600 is a physical space of an area in another type of building, such as a hotel, an office, and/or a business.

In some examples, a light source (e.g., 601A, 601B, 601C, and/or 601D) includes one or more features of portable multifunction device 100, device 300, and/or device 500. For example, a light source can include and/or be in communication with one or more processors and memory that are used to store and/or execute one or more instructions for performing the processes described herein. In some examples, one or more processors cause one or more light sources (e.g., 601) to perform operations (e.g., detect input, illuminate a region, and/or determine properties of a physical space). In some examples, the one or more processors are in communication with one or more light sources (e.g., 601). In some examples, the one or more processors are separate from one or more light sources (e.g., 601).

In some examples, light sources 601 are in communication with one or more other devices (e.g., computer systems). For example, light sources 601 can communicate with one or more sensor devices (e.g., that sense one or more properties of a physical space (e.g., physical space 600) and/or an environment). For another example, light sources 601 can communicate with one or more processing devices (e.g., that process sensor data, determine illumination levels, and/or process inputs that assist and/or instruct light sources 601 to output illumination as described in the examples described herein). To be concise, various operations (e.g., outputting illumination, detecting input, and/or determining properties) are described below as being performed by light sources 601. However, it should be recognized that one or more of the operations described below can be performed by a device different from light sources 601, such as a personal computing device (e.g., a phone, a tablet, a laptop, a desktop, and/or a wearable device) or a communal device (e.g., a smart speaker, a television, a router, and/or a hub). Unless otherwise noted explicitly, this description should not be construed as limiting the scope of such operations to be performed by a single device (e.g., light sources 601) or a particular combination of devices.

As illustrated in FIG. 6A, physical space 600 includes several physical features (e.g., people, physical objects, and/or physical structures) that are physically present in the room and/or that form a part of the room. Such physical features include wall 612, floor 614, and window 616—each being physical features that make up physical space 600 (e.g., define boundaries of and/or are present in physical space 600). FIG. 6A also illustrates physical features that include display device 618 and person 620—each being physical features that are present in physical space 600 and are moveable.

As mentioned above, light sources 601 can be used to intelligently illuminate physical space 600. In some examples, light sources 601 provide illumination based on one or more properties (e.g., of physical features) of physical space 600. In some examples, light sources 601 provide illumination in response to a request (e.g., in response to detecting input, such as user input). In some examples, light sources 601 provide illumination automatically (e.g., without detecting input, such as user input) (e.g., intelligently lights physical space 600 and/or a portion thereof (e.g., a region)) based on one or more properties of physical space 600. In some examples, a property of physical space 600 includes a physical feature of physical space 600, physical properties of the physical feature (e.g., location, pose, color, material, reflectivity, and/or opacity), and/or a context of physical space 600 (e.g., events occurring within physical space 600, user activity, weather, and/or time of day). The examples provided of properties are not intended to be exhaustive, but merely illustrative. Other examples described herein are intended to be inclusive with those listed above.

In some examples, light sources 601 provide illumination of a region of physical space 600 based on one or more properties of the region. In such examples, the region of physical space 600 can be a portion of (e.g., less than all and/or a subset of) an area and/or a volume of physical space 600.

In various figures of this disclosure, reference is made to various regions that are illustrated by a dashed line border. Unless otherwise noted explicitly herein, the dashed line border is a visual aid that illustrates a location and/or extent of a corresponding region and should not be necessarily construed to be output by a device (e.g., light sources 601) or otherwise made visible within the corresponding physical space. For example, FIG. 6A illustrates physical space 600 including region 622 (e.g., a portion of wall 612), region 624 (e.g., a portion of floor 614), region 626 (e.g., a portion of wall 612 including window 616), region 628 (e.g., a portion of physical space 600 including display device 618), and region 630 (e.g., a portion of physical space 600 including the face of person 620). In some examples, light sources 601 receive data representing a region of physical space 600 from one or more sensors (e.g., internal and/or external to light sources 601). In some examples, the data representing the region includes data from one or more other devices (e.g., received from another computing system, such as another light source, a server, and/or a personal computing device).

In some examples, one or more properties of a particular region do not affect the illumination of another region of physical space 600 and/or portions of physical space 600 outside of the particular region. For example, the color of floor 614 can have no effect on illumination of wall 612.

At FIG. 6A, light sources 601 detect a request to illuminate region 622 in physical space 600. In response to detecting the request, light sources 601 illuminate region 622 based on one or more detected properties of wall 612 within region 622. In some examples, a property represents reflectivity (e.g., of a mirror, a polished stone surface, and/or a reflective metal surface), transparency (e.g., of a glass or plastic window, a glass or plastic door, and/or a glass or plastic table), color, material, time of day, type of object, frequency of use of an object or region, user activity, a presence and/or absence of one or more people in the region, and/or a presence and/or absence of one or more people's faces in the region. In some examples, detection of a request to illuminate region 622 causes light sources 601 to illuminate region 622 with light having color and/or brightness that is determined based on the color of wall 612. Thus, in some examples, light sources 601 illuminate wall 612 with a color of light that will make wall 612 appear its true color to a viewer (e.g., reducing and/or eliminating the effect that the color of illumination has on a viewer's perception of the color of an object). In some examples, a detection of a request to illuminate region 624 causes light sources 601 to illuminate region 624 with light having brightness that is determined based on the color of floor 614. In some examples, a detection of a request to illuminate region 626 causes light sources 601 to illuminate region 626 with light having color and/or brightness that is determined based on the transparency of window 616 (e.g., light sources 601 can reduce illumination within region 626 so as to reduce interior glare from window 616 and/or to avoid the unnecessary energy usage involved in generating illumination that will exit through window 616). In some examples, detection of a request to illuminate region 628 causes light sources 601 to illuminate region 628 with light having brightness that is determined based on identifying display device 618 as including a surface that is used to output content (e.g., a screen and/or a display) (e.g., light sources 601 can reduce and/or decrease illumination within region 628 so as to reduce glare on the screen of display device 618 that would interfere with a viewer (e.g., person 620)). In some examples, detection of a request to illuminate region 630 causes light sources 601 to illuminate region 630 with light having brightness that is determined based on identifying that region 630 includes a face. In some examples, light sources 601 reduce illumination within region 630 such that illumination directed at the face of person 620 is reduced (e.g., to create a “mask” of reduced illumination that includes a region in which the eyes of person 620 are located to limit light projected into the eyes of person 620). In some examples, region 630 is smaller than the size of region 630 illustrated in FIG. 6A to cover the smaller area around and/or include the eyes of person 620.

In some examples, a region has more than one property associated with it. For example, window 616 is transparent, resulting in a sensor reading that assigns region 626 the color of what lies outside of window 616 (e.g., green if green grass is visible, or blue if blue sky is visible). In some examples, because window 616 is transparent, region 626 is associated with a property that indicates the transparency. In some examples, light sources 601 determine illumination based on a set of properties of the one or more properties associated with a region. The set can be one property, multiple properties (less than all and/or a subset), or all properties associated with the region. In some examples, one or more properties can override other properties. In some examples, because region 626 includes a transparent window 616, light sources 601 ignore the color property (e.g., green) and provide no illumination in region 626. In some examples, a mirror is treated similarly to a window (e.g., reduced or no illumination in order to reduce unwanted reflections into physical space 600). In some examples, one property is ignored (and, in some examples, does not affect illumination output) while another property affects illumination output. In some examples, some properties jointly affect illumination. In some examples, light sources 601 reduce illumination in region 630 to avoid shining light into the eyes of person 620 when a property of region 630 indicates a person's face is included but provides a low level of illumination based on other properties of region 630 (e.g., color temperature and/or time of day).

FIG. 6B illustrates physical space 600 from a different point of view and at a different point in time. In FIG. 6B, the point of view is facing the opposite direction from the point of view illustrated in FIG. 6A such that in FIG. 6B wall 612 is directly behind the point of view and opposite of wall 634. As illustrated in FIG. 6B, physical space 600 includes physical features such as floor 632, wall 634, person 620 (now seated in a chair), and person 636.

At FIG. 6B, light sources 601 detect a request to illuminate region 642 in physical space 600. In response to detecting the request, light sources 601 illuminate the region 642 based on one or more detected properties of floor 632 within region 642. For example, a request to illuminate region 642 can result in light sources 601 illuminating region 642 with light having color and/or brightness that is determined based on the color of floor 632 within region 642. For another example, a request to illuminate region 644 can result in light sources 601 illuminating region 644 with light having brightness that is determined based on the color of wall 634 within region 644. For another example, a request to illuminate region 646 can result in light sources 601 illuminating region 646 with light having brightness that is determined based on identifying that region 646 includes a face (of person 636) (e.g., light sources 601 can reduce illumination within region 646, so as to reduce illumination directed at the face of person 636).

In some examples, light sources 601 change illumination of a region in response to changes in one or more properties associated with the region of physical space 600. For example, in FIG. 6B person 636 is facing the direction of light sources 601, which provide reduced illumination in region 646 as described above. Light sources 601 can change the illumination of region 646 if, for example, person 636 turns to face the opposite direction and is no longer facing light sources 601—in such case, region 646 would no longer be associated with a property indicating that a person's face is detected and so illumination can be increased. In such an example, if person 636 were to turn around again to face light sources 601, illumination in region 646 could return to the reduced illumination state due to the property changing when a face is detected.

In some examples, light sources 601 maintain illumination of a region in response to changes in one or more properties associated with the region of physical space 600. For example, light sources 601 can continue to provide reduced illumination within region 630 in FIG. 6B (with respect to illumination of region 630 in FIG. 6A). As illustrated in FIG. 6B, person 620 has changed location (e.g., to the location of the couch) and pose (e.g., from standing to sitting) within physical space 600. In some examples, in response to detecting that one or more properties associated with a region (e.g., 630) have changed, light sources 601 change illumination of that region. In some examples, light sources 601 track that the location of region 630 changes due to the movement of person 620, and in response, follow the location of region 630 (e.g., in real time or after the person settles) with the determined illumination for region 630. In this example, light sources 601 provide reduced illumination (e.g., relative to the surrounding physical space) within region 630.

In some examples, light sources 601 adjust the color temperature (and/or other property of illumination) based on a detected environmental change (e.g., within the physical space) and/or a detected time of day. For example, the color temperature of illumination that light sources 601 output can be adjusted to more closely resemble or match the color temperature of natural sunlight throughout the day (e.g., having a cooler/bluer appearance at midday and/or having a warmer/orange appearance at sunrise and/or sundown). In some examples, light sources 601 detect the color temperature change of the room (e.g., using a sensor). In some examples, the color temperature is based on the time of day and/or day of the year (e.g., which can provide approximate sunrise and/or sundown times for estimating color temperature).

FIG. 7 is a flow diagram illustrating a method (e.g., method 700) for providing contextually aware lighting in accordance with some examples. Some operations in method 700 are, optionally, combined, the orders of some operations are, optionally, changed, and some operations are, optionally, omitted.

As described below, method 700 provides an intuitive way for providing contextually aware lighting. Method 700 reduces the cognitive burden on a user for providing contextually aware lighting, thereby creating a more efficient human-machine interface. For battery-operated computing devices, enabling a user to provide contextually aware lighting faster and more efficiently conserves power and increases the time between battery charges.

In some examples, method 700 is performed at a computer system (e.g., 100, 300, and/or 500) that is in communication with a light source (e.g., an illumination device, a point light source, a spotlight, and/or one or more light sources) (e.g., 601, 601A, 601B, 601C, and/or 601D). In some examples, the computer system is a phone, a watch, a tablet, a fitness tracking device, a wearable device, an accessory, a speaker, a light, a head-mounted display (HMD), and/or a personal computing device. In some examples, the light source is not physically connected to and/or coupled to the computer system. In some examples, the computer system is in communication with one or more cameras. In some examples, the one or more cameras are not physically connected to the light source.

At 702, the computer system detects a request to illuminate a region (e.g., a location, an area, a portion, and/or part) (e.g., a general or specific region) (e.g., 622, 624, 626, 628, 630, 642, 644, and/or 646) of a physical space (e.g., a physical environment, a room, an office, and/or a building) (e.g., 600). In some examples, detecting the request includes detecting input (e.g., a tap gesture, a long press gesture, a verbal request and/or command, a physical button press, a pointing input and/or air gesture, and/or a rotation of a physical input mechanism) corresponding to the request. In some examples, detecting the request includes receiving a message from a different computer system, the message indicating that the request was received by the different computer system.

At 704, in response to detecting the request to illuminate the region of the physical space and in accordance with a determination that the region of the physical space has a first property (e.g., a first characteristic, a first state, and/or a first context, such as an amount of translucence) (e.g., of 612, 614, 616, 618, 620, 632, 634, and/or 636), the computer system provides, via the light source, a first type of illumination (e.g., a color, an intensity, and/or a size of illumination) (e.g., as illustrated in FIGS. 6A and/or 6B, such as providing less illumination to a region with a television to reduce glare as compared to a region without the television and/or providing a different color of illumination to a region of a wall with a particular color as compared to a region of a wall with a different color). In some examples, providing the first type of illumination includes activating the light source. In some examples, providing the first type of illumination includes changing light output by the light source. In some examples, providing the first type of illumination includes sending a request to the light source to modify light being output by the light source. In some examples, the first type of illumination is provided until the region of the physical space is determined to not have the first property. In some examples, the first type of illumination is provided until a request is received to stop the first type of illumination.

At 706, in response to detecting the request to illuminate the region of the physical space and in accordance with a determination that the region of the physical space has a second property (e.g., a second characteristic, a second state, and/or a second context) (e.g., of 612, 614, 616, 618, 620, 632, 634, and/or 636) different from the first property, the computer system forgoes providing (e.g., via the light source) the first type of illumination (e.g., without, in some examples, providing another type of illumination or, in some examples, while providing a different type of illumination) (e.g., as described for FIGS. 6A and/or 6B, such as providing less illumination to a region with a window to reduce the amount of light exiting the window as compared to a region without the window and/or providing less illumination to a region with a face of a person to reduce amount of illumination in the direction of the eyes of the person as compared to a region without a face of a person). Providing the first type of illumination in accordance with the determination that the region has the first property allows for illumination to automatically, without user input, be specific to and/or based on properties of the region, thereby reducing the number of inputs needed to perform an operation, providing additional control options without cluttering the user interface with additional displayed controls, and performing an operation when a set of conditions has been met without requiring further user input.

In some examples, in response to detecting the request to illuminate the region of the physical space and in accordance with a determination that the region of the physical space has a third property (e.g., the second property or a property different from the first property and the second property) (e.g., reflective and/or a surface that would affect and/or impact other illumination in the physical space) (e.g., of 612, 614, 616, 618, 620, 632, 634, and/or 636), the computer system provides a second type of illumination (e.g., as described for FIGS. 6A and/or 6B, such as providing a different color of illumination in a region of the floor with a particular color as compared to a different region of the floor with a different color and/or providing more illumination in a region with a person so that the person can see as compared to a region without a person), wherein the second type of illumination is less illumination (and/or has less, has a reduced amount of, has a lower amount of, is dimmer than, and/or is not as bright as) than the first type of illumination. In some examples, the first type of illumination includes a first amount of illumination and the second type of illumination includes a second amount of illumination that is less than the first amount of illumination. In some examples, the first type of illumination includes at least some illumination. In some examples, the second type of illumination includes a reduced amount of illumination compared (e.g., relative and/or with respect) to the first type of illumination. In some examples, the second type of illumination is different from the first type of illumination. Causing the second type of illumination in accordance with the determination that the region has the third property allows for illumination to automatically, without user input, be specific to and/or based on properties of the region, thereby reducing the number of inputs needed to perform an operation, providing additional control options without cluttering the user interface with additional displayed controls, and performing an operation when a set of conditions has been met without requiring further user input.

In some examples, in response to detecting the request to illuminate the region of the physical space and in accordance with a determination that the region of the physical space has a third property (e.g., the second property or a property different from the first property and the second property) (e.g., reflective and/or a surface that would affect and/or impact other illumination in the physical space) (e.g., of 612, 614, 616, 618, 620, 632, 634, and/or 636), the computer system forgoes providing illumination to the region of the physical space (e.g., for FIGS. 6A and/or 6B, such as forgoing illumination when a region includes a television, a window, and/or an eye of a person). Forgoing providing illumination to the region of the physical space in accordance with the determination the region has the third property allows for illumination to automatically, without user input, be specific to and/or based on properties of the region, thereby reducing the number of inputs needed to perform an operation, providing additional control options without cluttering the user interface with additional displayed controls, and performing an operation when a set of conditions has been met without requiring further user input.

In some examples, in response to detecting the request to illuminate the region of the physical space and in accordance with a determination that the region of the physical space has a fourth property (e.g., the second property, the third property, or a property different from the first, second, and/or third properties) (e.g., one or more particular colors and/or a type of surface) (e.g., of 612, 614, 616, 618, 620, 632, 634, and/or 636), the computer system provides, via the light source, a third type of illumination different from (e.g., a different color and/or more or less illumination) the first type of illumination (e.g., for FIGS. 6A and/or 6B, such as providing less illumination to a region with a window to reduce the amount of light exiting the window as compared to a region without the window and/or providing less illumination to a region with a face of a person to reduce amount of illumination in the direction of the eyes of the person as compared to a region without a face of a person). In some examples, the third type of illumination is different from the second type of illumination. In some examples, the third type of illumination includes more or less illumination than the second type of illumination. In some examples, the third type of illumination includes the same amount of illumination as the first type of illumination and/or the second type of illumination but includes a different color than the first type of illumination and/or the second type of illumination. Providing the third type of illumination in accordance with the determination the region has the fourth property allows for illumination to automatically, without user input, be specific to and/or based on properties of the region, thereby reducing the number of inputs needed to perform an operation, providing additional control options without cluttering the user interface with additional displayed controls, and performing an operation when a set of conditions has been met without requiring further user input.

In some examples, the determination that the region of the physical space has the first property includes a determination that the region has a first amount of reflectivity (e.g., an amount of light and/or a direction of light that bounces off a surface (e.g., 612, 614, 616, 618, 620, 632, 634, and/or 636)) (e.g., reflection factor) (e.g., as described above with respect to a television). In some examples, the determination that the region of the physical space has the second property includes a determination that the region has a second amount of reflectivity different from the first amount of reflectivity (e.g., as described above with respect to 612 and/614). In some examples, the third and/or fourth property is based on the reflectivity of the region. In some examples, the determination that the region has the first amount of reflectivity includes sensing, via a sensor in communication with the computer system, the first amount of reflectivity in the region of the physical space. In some examples, the determination that the region has the first amount of reflectivity includes identifying a type of object in the region (e.g., by identifying an object (e.g., 616, 618, 620, and/or 636) and identifying a type of the object) and identifying a predefined (e.g., a typical, an average, an assumed, and/or a predicted) amount of reflectivity for the type of object. The first property being based on an amount of reflectivity allows for illumination to automatically, without user input, be specific to and/or for a reflective surface, thereby reducing the number of inputs needed to perform an operation, providing additional control options without cluttering the user interface with additional displayed controls, and performing an operation when a set of conditions has been met without requiring further user input.

In some examples, the determination that the region of the physical space has the first property includes a determination that the region has a first amount of transparency (e.g., an amount of light that does not reflect in a direction away from the region) (e.g., transparent factor) (e.g., as described above with respect to a window). In some examples, the determination that the region of the physical space has the second property includes a determination that the region has a second amount of transparency different from the first amount of transparency. In some examples, the first property and/or the second property is based on the transparency of the region (and, in some examples, when the region corresponds to and/or is a window, a window pane, a glass surface, a transparent and/or semi-transparent surface, and/or a surface at which light is visible through). In some examples, in accordance with a determination that the region has a first respective amount of transparency, the first property is a first respective property; and in accordance with a determination that the region has a second respective amount of transparency that is different from the first respective amount of transparency, the first respective property is a second respective property that is different from the first respective property. In some examples, the determination that the region has the first amount of transparency includes sensing, via a sensor in communication with the computer system, the first amount of transparency in the region of the physical space. In some examples, the determination that the region has the first amount of transparency includes identifying a type of object in the region (e.g., by identifying an object and/or identifying a type of the object) and identifying a predefined (e.g., a typical, an average, an assumed, and/or a predicted) amount of transparency for the type of object. The first property being based on an amount of transparency allows for illumination to automatically, without user input, be specific to and/or for a transparent surface, thereby reducing the number of inputs needed to perform an operation, providing additional control options without cluttering the user interface with additional displayed controls, and performing an operation when a set of conditions has been met without requiring further user input.

In some examples, the determination that the region of the physical space has the first property includes a determination of whether a first person (e.g., a specific person and/or any person) (e.g., 620 and/or 636) is present (e.g., detected and/or determined to be) in the region. In some examples, the determination that the region of the physical space has the second property includes a determination of whether the first person is present in the region. In some examples, the determination that the region of the physical space has the first property includes a determination that the first person (e.g., any person and/or any particular person) is present in the region. In some examples, the determination that the region of the physical space has the first property includes a determination that the first person (e.g., a specific person and/or a particular person) is present in the region. In some examples, the determination that the region of the physical space has the second property includes a determination that the first person (e.g., any person and/or any particular person) is not present (e.g., absent and/or not identified) in the region. In some examples, the determination that the region of the physical space has the second property includes a determination that the first person (e.g., a specific person and/or a particular person) is not present (e.g., absent and/or not identified) in the region. In some examples, the determination of whether the first person is present in the region is based on information received in a communication from a different device (e.g., such as a user device of, corresponding to, and/or associated with the person). In some examples, the determination of whether the first person is present in the region is based on analysis of one or more images of the region to identify the first person. In some examples, the determination of whether the first person is present in the region is based on a whether a motion sensor in the region has been triggered (e.g., has detected motion). In some examples, in accordance with a determination that the first person is present in the region, the first property is a third respective property; and in accordance with a determination that the first person is not present in the region, the first property is a fourth respective property that is different from the first respective property. The first property being based on whether a person is present allows for illumination to automatically, without user input, react differently depending on a number of people being present, thereby reducing the number of inputs needed to perform an operation, providing additional control options without cluttering the user interface with additional displayed controls, and performing an operation when a set of conditions has been met without requiring further user input.

In some examples, the determination that the region of the physical space has the second property includes a determination of whether a face (e.g., an entire face and/or part of a face, such as one or more eyes of a face) of a second person (e.g., a specific person and/or a particular person) (e.g., 620 and/or 636) is present (e.g., detected and/or determined to be) in the region. In some examples, the determination that the region of the physical space has the first property includes a determination of whether the face of the second person is present in the region. In some examples, the determination that the region of the physical space has the first property includes a determination that a face of the second person (e.g., any person and/or any particular person) is present in the region. In some examples, the determination that the region of the physical space has the first property includes a determination that the face of the second person (e.g., a specific person and/or a particular person) is present in the region. In some examples, the determination that the region of the physical space has the second property includes a determination that a face of the second person (e.g., any person and/or any particular person) is not present (e.g., absent and/or not identified) in the region. In some examples, the determination that the region of the physical space has the second property includes a determination that the face of the second person (e.g., a specific person and/or a particular person) is not present (e.g., absent and/or not identified) in the region. In some examples, the determination of whether the face of the second person is present in the region is based on analysis of one or more images of the region to identify the face. In some examples, in accordance with a determination that the face of the second person is in the region, the first property is a fourth respective property; and in accordance with a determination that the face of the second person is in the region, the first property is a fifth respective property that is different from the fourth respective property. In some examples, in conjunction with determining whether the face of the second person is within the region, the computer system and/or another computer system creates a mask that includes a region in which the eyes of the second person are located to limit and/or reduce light projected into eyes of the second person (e.g., so that the illumination provided is provided less in the eyes of the second person (e.g., to avoid blinding and/or obstructing the vision of the second person)). The first property being based on whether a face of person is present allows for illumination to automatically, without user input, take into account people and/or shield the eyes of the people from the illumination, thereby reducing the number of inputs needed to perform an operation, providing additional control options without cluttering the user interface with additional displayed controls, and performing an operation when a set of conditions has been met without requiring further user input.

In some examples, in response to detecting the request to illuminate the region of the physical space: without regards to a property (e.g., the first property, the second property, and/or any other property) of the region of the physical space (e.g., not based on and/or not taking into account the property), the computer system provides, via the light source, a fourth type of illumination (e.g., a color, an intensity, and/or a size of illumination) with respect to a second region (e.g., 622, 624, 626, 628, 630, 642, 644, and/or 646) of the physical space, wherein the second region is different from the region. In some examples, the second region is adjacent to and/or in proximity to the region. In some examples, providing the fourth type of illumination includes activating the light source. In some examples, providing the fourth type of illumination includes changing light output by the light source. In some examples, providing the fourth type of illumination includes sending a request to the light source to modify light being output by the light source. In some examples, the fourth type of illumination is provided until a request is received to stop the fourth type of illumination. In some examples, the fourth type of illumination is provided with regard to (e.g., based on and/or taking into account) a property of the second region (e.g., the second region having different properties causes different types of illumination to be provided). In some examples, the fourth type of illumination is different from the first type of illumination and/or the second type of illumination. Providing the fourth type of illumination with respect to the second region without regard to a property of the region in response to the request to illuminate the region allows for illumination to automatically, without user input, be specific to and/or based on properties of a respective region in which the illumination is provided, thereby reducing the number of inputs needed to perform an operation, providing additional control options without cluttering the user interface with additional displayed controls, and performing an operation when a set of conditions has been met without requiring further user input.

In some examples, the light source is a single light emitting device. In some examples, the light source is included in a single enclosure and/or receives commands to illuminate different regions (e.g., 622, 624, 626, 628, 630, 642, 644, and/or 646). In some examples, the light source includes a plurality of spotlights, light emitting diodes, light bulbs, and/or lasers within a single enclosure and/or a single housing. In some examples, the light source includes a plurality of light sources (e.g., spotlights, light emitting diodes, light bulbs, and/or lasers) (e.g., 601A, 601B, 601C, and/or 601D) that are in wired communication (and, in some examples, not wireless communication). In some examples, the light source, the computer system, and/or an environment where the light source is located includes a mirror, a lens, and/or other optical component used to change a direction and/or pattern of light being emitted by the light source. In some examples, the light source moves (e.g., laterally, horizontally, vertically, inward, and/or outward) to illuminate different regions of the physical space. In some examples, the light source is configured to selectively illuminate portions of the light source so as to selectively illuminate different regions of the physical space. The light source being a single light emitting device allows less communications being sent between devices, less setup required as compared to setting up multiple devices, and/or easier installation, thereby reducing the number of inputs needed to perform an operation.

In some examples, after (and/or while) providing the first type of illumination and in accordance with a determination that the region of the physical space has changed from the first property to a fifth property (e.g., the determination that the region of the physical space has changed from the first property to the fifth property occurs while providing the first type of illumination) (e.g., a person and/or object moves and/or a person looks in a different direction) (e.g., that is different from the first property and/or the second property), the computer system provides, via the light source, a fifth type of illumination different from the first type of illumination (e.g., as described above with respect to FIGS. 6A and/or 6B, such as when person 620 is moving from the position illustrated in FIG. 6A to the position illustrated in FIG. 6B). In some examples, the fifth type of illumination is different from the second type of illumination, the third type of illumination, and/or the fourth type of illumination. In some examples, the type of illumination that is provided changes (e.g., illumination is increased and/or decreased) in response to one or more properties of the region changing. In some examples, after (and/or while) providing the first type of illumination and in accordance with a determination that the region of the physical space has not changed from the first property (and, in some examples, to the fifth property and/or any other property), the computer system does not provide the fifth type of illumination different from the first type of illumination. In some examples, the fifth property is the second property, and the fifth type of illumination is the second type of illumination. Providing the fifth type of illumination in accordance with the determination that the region has changed from the first property to the fifth property allows for illumination to automatically, without user input, adjust based on properties of the physical space changing, thereby reducing the number of inputs needed to perform an operation, providing additional control options without cluttering the user interface with additional displayed controls, and performing an operation when a set of conditions has been met without requiring further user input.

In some examples, providing the fifth type of illumination in accordance with the determination that the region of the physical space has changed from the first property to the fifth property includes changing, via the light source, from the first type of illumination to the fifth type of illumination (e.g., as described above with respect to FIGS. 6A and/or 6B, such as when person 636 is present in FIG. 6B and not FIG. 6A). In some examples, changing from the first type of illumination to the fifth type of illumination includes gradually changing between the different types of illumination (e.g., illuminating at a different type of illumination between the first type and/or the fifth type). In some examples, changing from the first type of illumination to the fifth type of illumination includes switching from the first type to the fifth type without illuminating a type different from the first and/or fifth type. In some examples, the fifth type is the second type of illumination. In some examples, in accordance with the determination that the region of the physical space has not changed from the first property to the fifth property, the computer system does not change, via the light source, from the first type of illumination to the fifth type of illumination. Changing from the first type of illumination to the fifth type of illumination in accordance with the determination that the region has changed from the first property to the fifth property allows for illumination to automatically, without user input, adjust based on properties of the physical space changing, thereby reducing the number of inputs needed to perform an operation, providing additional control options without cluttering the user interface with additional displayed controls, and performing an operation when a set of conditions has been met without requiring further user input.

In some examples, after (and/or while) providing the fifth type of illumination, the computer system changes, via the light source, from the fifth type of illumination to the first type of illumination (e.g., as described above with respect to FIGS. 6A and/or 6B, such as if person 620 returns to the location illustrated in FIG. 6A after being at the location illustrated in FIG. 6B). In some examples, changing from the fifth type of illumination to the first type of illumination includes gradually changing between the different types of illumination (e.g., illuminating at a different type of illumination between the fifth type and/or the first type). In some examples, changing from the fifth type of illumination to the first type of illumination includes switching from the fifth type to the first type without illuminating a type different from the first and/or fifth type. Changing back to the first type of illumination from the fifth type of illumination allows for illumination to automatically, without user input, adjust based on properties of the physical space changing, thereby reducing the number of inputs needed to perform an operation, providing additional control options without cluttering the user interface with additional displayed controls, and performing an operation when a set of conditions has been met without requiring further user input.

In some examples, providing, via the light source, the first type of illumination includes: in accordance with a determination that the region includes a surface (e.g., surface of a table, a wall, a solid plane and/or surface, a window, and/or an object) (e.g., 612, 614, 616, 618, 620, 632, 634, and/or 636) with a first color, causing, via the light source, output of a second color. In some examples, the second color is different from the first color. In some examples, providing, via the light source, the first type of illumination includes: in accordance with a determination that the region includes a surface (e.g., surface of a table, a wall, a solid plane and/or surface, a window, and/or an object) (e.g., 612, 614, 616, 618, 620, 632, 634, and/or 636) with a third color different from the first color (and, in some examples, does not include the surface with the first color), causing, via the light source, output of a fourth color different from the third color (e.g., without causing output of the second color and/or the first color). In some examples, the first color, the second color, the third color, and/or the fourth color are different colors. In some examples, one or more of the first color, the second color, the third color, and/or the fourth color are different colors and/or one or more of the first color, the second color, the third color, and the fourth color are the same colors. In some examples, in accordance with a determination that the region includes the surface with the first color and not the surface with the third color, the computer system causes, via the light source, output of the second color (e.g., without causing output of the fourth color and/or the third color). Causing output of the second color or the fourth color depending on a color of the surface allows for illumination to automatically, without user input, be specific to and/or based on properties of a respective region in which the illumination is provided, thereby reducing the number of inputs needed to perform an operation, providing additional control options without cluttering the user interface with additional displayed controls, and performing an operation when a set of conditions has been met without requiring further user input.

In some examples, after providing the first type of illumination (and/or while providing the first type of illumination) and in accordance with a determination that a current time of day is a first time of day, the computer system changes, via the light source, from the first type of illumination to a sixth type of illumination, wherein the first type of illumination includes a first color temperature, and wherein the sixth type of illumination includes a second color temperature different from the first color temperature (e.g., as described above with respect to FIG. 6B, where illumination changes as the day progresses). In some examples, a color temperature of illumination is changed based on the first time of day (e.g., the color temperature is changed as time passes (e.g., different color temperatures are used at different times)). In some examples, the first type of illumination is different from the sixth type of illumination. In some examples, the first type of illumination does not include the second color temperature and the sixth type of illumination does not include the first color temperature. In some examples, after providing the first type of illumination (and/or while providing the first type of illumination) and in accordance with a determination that the current time of day is a second time of day different from the first time of day, the computer system changes, via the light source, from the first type of illumination to another type of illumination (e.g., different from the sixth type of illumination and/or the first type of illumination) that has a different color temperature than the first color temperature and/or the second color temperature. Changing from the fifth type of illumination to the sixth type of illumination based on a time of day allows for illumination to automatically, without user input, be specific to and/or based on a time of day and/or change throughout the day, thereby reducing the number of inputs needed to perform an operation, providing additional control options without cluttering the user interface with additional displayed controls, and performing an operation when a set of conditions has been met without requiring further user input.

In some examples, in response to detecting the change in the physical space and in accordance with a determination that the physical space has changed in a first manner (e.g., more and/or less light is in the physical space, one or more objects and/or people have moved in the physical space), the computer system changes, via the light source, from the first type of illumination to a seventh type of illumination (as described above with respect to FIG. 6B, where person 636 is included in physical space 600 in addition to person 620), wherein the first type of illumination includes a third color temperature, and wherein the seventh type of illumination includes a fourth color temperature different from the third color temperature. In some examples, a color temperature of illumination is changed based on changing properties of the physical space (e.g., the color temperature is changed as one or more properties change (e.g., different color temperatures are used when different properties are detected in the physical space)). In some examples, in response to detecting the change in the physical space and in accordance with a determination that the physical space has changed in a second manner different from the first manner, the computer system changes, via the light source, from the first type of illumination to an eighth type of illumination different from the first type of illumination and the seventh type of illumination. Changing from the first type of illumination to the seventh type of illumination in accordance with the determination that the physical space has changed in the first manner allows for illumination to automatically, without user input, adjust based on the physical space changing, thereby reducing the number of inputs needed to perform an operation, providing additional control options without cluttering the user interface with additional displayed controls, and performing an operation when a set of conditions has been met without requiring further user input.

In some examples, the determination that the region of the physical space has the first property includes a determination that is made based on first data being detected by a sensor (e.g., one or more sensors, such as a camera or a thermostat). In some examples, the determination that the region of the physical space has the second property includes a determination that is made based on second data being detected by the sensor. In some examples, the second data is different from the first data. In some examples, the sensor is in communication with the computer system. In some examples, the first property is determined based on data detected by one or more sensors in communication with the light source. In some examples, the second property is determined based on data detected by the sensor. In some examples, in accordance with a determination that the sensor detected first data, the first property is a sixth respective property; and in accordance with a determination that the sensor detected second data that is different from the first data, the first property is a seventh respective property different from the sixth respective property. In some examples, the sensor is integrated into (e.g., included physically in and/or not separate from) the computer system and/or the light source. In some examples, the sensor is separate from (e.g., not integrated and/or not physically included in) the computer system and/or the light source. The first property and the second property being based on data detected by a sensor allows for the properties to be accurate, consistent, and/or based on real-world conditions, thereby reducing the number of inputs needed to perform an operation, providing additional control options without cluttering the user interface with additional displayed controls, and performing an operation when a set of conditions has been met without requiring further user input.

Note that details of the processes described above with respect to method 700 (e.g., FIG. 7) are also applicable in an analogous manner to other methods described herein. For example, method 900 optionally includes one or more of the characteristics of the various methods described above with reference to method 700. For example, the light source of method 900 can be the light source of method 700. For brevity, these details are not repeated below.

FIGS. 8A-8E illustrate exemplary techniques for changing illumination based on detected user activity in accordance with some examples. The user interfaces in these figures are used to illustrate the processes described below, including the one or more processes described in relation to FIG. 9.

FIGS. 8A-8B illustrate light sources 801 changing illumination based on detected user activity. Light sources 801 can be the same or similar to light sources 601. For example, light sources 801 can be the collective term used to describe one or more light sources, such as light sources 801A, 801B, 801C, and/or 801D. In some examples, light sources 801 include one or more features as described herein with respect to any one or more light source described with respect to FIGS. 6, 10, 12, and/or 14.

FIG. 8A illustrates physical space 800, a room with person 810 in a seated position on a couch. In some examples, activity of person 810 includes whether person 810 is asleep or awake. At FIG. 8A, light sources 801 detect that person 810 is awake within physical space 800 and, in response to this detection, illuminate physical space 800 based on person 810 being awake. For example, as illustrated in FIG. 8A, light sources 801 output a focused beam of illumination 822, based on the size of region 820. Region 820 represents a portion of physical space 800 determined to correspond to person 810 (e.g., their location, size, and/or activity (e.g., awake, asleep, sitting, standing, and/or lying down)).

In some examples, light sources 801 detect a change in user activity in physical space 800 and, in response to this detection, change illumination of physical space 800. For example, at FIG. 8B, light sources 801 detect that person 810 is sleeping and, in response to this detection, illuminate physical space 800 based on person 810 being asleep. For example, as illustrated in FIG. 8B, light sources 801 cease illuminating person 810 (e.g., no longer outputs illumination 822 of FIG. 8A). At FIG. 8B, person 810 continues to be detected, but their activity has changed (e.g., from awake to asleep), so light sources 801 adjust illumination based on this change (e.g., to an illumination that is appropriate to the detected user activity). At FIG. 8B, light sources 801 turn off illumination in response to detecting that person 810 is sleeping. In some examples, light sources 801 reduce illumination (e.g., dims its light output) in response to detecting person 810 is sleeping. For example, light sources 801 output a lower amount of illumination than before detecting person 810 is sleeping.

In some examples, a change in user activity in physical space 800 represents a change in a number of people detected in physical space 800. For example, at FIG. 8C, light sources 801 detect that person 810 and person 824 are both present in physical space 800 and, in response to this detection, illuminate physical space 800 based on the user activity representing the presence of both person 810 and person 824. In this example, person 810 has woken up from being asleep (as illustrated in FIG. 8B) and is now joined by person 824 seated next to them. At FIG. 8C, in addition to detecting both person 810 and person 824, light sources 801 detect that both people are awake and, in response, illuminate physical space 800 based on the presence of two awake people. For example, region 830 is larger in size compared to region 820 (of FIG. 8A), to accommodate the addition of person 824. Light sources 801 output a focused beam of illumination 832, which is wider than illumination 822 (of FIG. 8A), based on the size of region 830. In this example, region 830 is larger than region 820, so light sources 801 illuminate a larger area. Region 830 represents both person 810 and person 824. In some examples, if light sources 801 detect that person 824 in FIG. 8C leaves physical space 800 while person 810 remains in the same location and awake, in response to this detection, light sources 801 can return to providing illumination as illustrated in FIG. 8A (e.g., illumination 822 based on region 820).

FIGS. 8D-8E also illustrate light sources 802 changing illumination based on detected user activity. FIG. 8D illustrates physical space 800, a room with person 810, person 824, table 836, and chair 838 (which is unoccupied by a person). At FIG. 8D, light sources 801 detect that two people (e.g., person 810 and person 824) are present in physical space 800, and detects that they are performing an activity (e.g., eating a meal). At FIG. 8D, light sources 801 detect that chair 838 is unoccupied (e.g., not occupied by a person). As illustrated in FIG. 8D, in response to detecting user activity (e.g., of person 810 and person 824), light sources 801 output illumination 842 based on region 840 including both person 810 and person 824. Notably, chair 838 is outside of illumination 842 (e.g., because chair 838 is not within region 840). In some examples, a portion of physical space 800 (e.g., chair 838) that is outside of a particular region (e.g., 840) receives a different amount of illumination (e.g., less or more) and/or illumination having one or more different characteristics (e.g., color, brightness, color temperature, degree of focus, and/or degree of diffusion) than the illumination of the particular region. In some examples, light sources 801 detect a property of user activity, and output illumination based on the property of (e.g., associated with) user activity. For example, if two people are detected eating a meal (e.g., similar to as described with respect to FIG. 8D), light sources 801 can determine that the meal is a date and, in response, adjust illumination to be dimmer (e.g., creating romantic mood lighting for the meal). In some examples, a property of user activity is determined based on one or more of: a time of day, detection and/or identification of one or more people in physical space 800, detection of one or more features associated with the characteristic. For example, a non-limited list of properties of user activity can include: presence of candlelight and/or wine glasses for a date, presence of board games and/or crafts for leisure activity, and/or presence of a book for reading. In some examples, the presence of candlelight causes illumination to be reduced as compared to without the presence of candlelight. In some examples, the presence of wine glasses for a date causes illumination to be increased as compared to without the presence of wine glasses for a date. In some examples, the presence of board games causes illumination to be in a more neutral color as compared to without the presence of board games. In some examples, the presence of crafts for leisure activity causes illumination to be in a cooler color as compared to without the presence of crafts for leisure activity. In some examples, the presence of a book for reading causes illumination to be in a warmer color as compared to without the presence of a book for reading.

In some examples, light sources 801 change illumination based on a user (e.g., person) moving within a predetermined distance of a location (e.g., associated with an object). For example, referring to the scenario illustrated in FIG. 8D, prior to sitting down at table 836, person 810 and person 824 walk toward table 836. In some examples, light sources 801 detect that a user has moved within a predetermined distance of a location and, in response, adjust illumination of physical space 800 (e.g., a region that includes the location). In the example of FIG. 8D, in response to detecting that person 810 and/or person 824 are within a threshold distance from table 836 (or one or more chairs associated with table 836), light sources 801 adjust illumination of region 840 (e.g., adds additional illumination or reduces illumination). Whether illumination increases or decreases can depend on user activity. For example, if light sources 801 detect that persons 810 and 824 are about to play a board game on table 836, in response light sources 801 can increase illumination. If light sources 801 detect that persons 810 and 824 are about to have a meal, in response light sources 801 can reduce illumination.

In some examples, light sources 801 detect movement of an object in physical space 800 and, in response, move illumination of the object to follow the object as it moves. For example, in the scenarios illustrated in FIGS. 8C and 8D, light sources 801 can move the illumination of person 810 and person 824 (e.g., based on region 830 in FIG. 8C) to follow them throughout their movement through physical space 800 from the couch (where illumination is based on region 830) to their sitting position at table 836 (e.g., where illumination is based on region 840 in FIG. 8D). In some examples, light sources 802 output the same illumination for an object (e.g., person 810) as it moves through physical space 800 (e.g., the illumination is a spotlight that follows person 810 from the couch to the table while maintaining the same illumination characteristics). In other examples, light sources 802 output different amount of illumination for the object as it moves, such as by changing the size of the illumination (e.g., spotlight changes size as the light follows the user and/or based on the spaces that the light is moving between). In some examples, different illumination is based on final location of movement (e.g., different lighting for couch as compared to the table).

At FIG. 8E, light sources 801 detect that person 810, person 824, and person 844 (seated in chair 838) are all present in physical space 800 and, in response to this detection, illuminate physical space 800 based on the user activity representing the presence of these three people. In this example, person 838 has joined the other two people (person 810 and person 824) at table 836. At FIG. 8E, in addition to detecting person 810, person 824, and person 844, light sources 801 detect that multiple people are eating a meal and, in response, illuminate physical space 800 based on the activity of the three people eating a meal. For example, region 850 is larger in size compared to region 840 (of FIG. 8D), to accommodate the addition of person 844. Light sources 801 output illumination 852, which is wider than illumination 842 (of FIG. 8D), based on the size of region 850. In this example, region 850 is larger than region 840, so light sources 801 output more total area of illumination. Region 850 represents three people, including person 810, person 824, and person 844. In some examples, light sources 801 detect that person 844 in FIG. 8E leaves physical space 800 while persons 810 and 824 remain in the same location and awake, and in response to this detection light sources 801 can return to providing illumination as illustrated in FIG. 8D (e.g., illumination 842 based on region 840).

FIG. 9 is a flow diagram illustrating a method (e.g., method 900) for changing illumination in accordance with some examples. Some operations in method 900 are, optionally, combined, the orders of some operations are, optionally, changed, and some operations are, optionally, omitted.

As described below, method 900 provides an intuitive way for changing illumination. Method 900 reduces the cognitive burden on a user for changing illumination, thereby creating a more efficient human-machine interface. For battery-operated computing devices, enabling a user to change illumination faster and more efficiently conserves power and increases the time between battery charges.

In some examples, method 900 is performed at a computer system (e.g., 100, 300, and/or 500) that is in communication with a light source (e.g., a point light source, a spotlight, and/or one or more light sources) (e.g., 801, 801A, 801B, 801C, and/or 801D). In some examples, the computer system is a phone, a watch, a tablet, a fitness tracking device, a wearable device, an accessory, a speaker, a light, a head-mounted display (HMD), and/or a personal computing device. In some examples, the light source is not physically connected to and/or coupled to the computer system. In some examples, the computer system is in communication with one or more cameras. In some examples, the one or more cameras are not physically connected to the light source. In some examples, the light source is a single light emitting device (e.g., as described above in relation to method 700).

At 902, while detecting a user (e.g., 810, 824, and/or 844) in a physical space (e.g., a physical environment, a room, an office, and/or a building) (e.g., 800), the computer system detects a change in user activity (e.g., activity of a person (e.g., 810, 824, and/or 844)) in the physical space. In some examples, detecting the change in user activity includes detecting a location of the user. In some examples, detecting the change in user activity includes detecting a state of the user. In some examples, detecting the change in user activity includes detecting an object (e.g., 836 and/or 838) near the user. In some examples, the change in user activity is detected while lighting, via the light source, in the physical space has a first set of properties (e.g., non-zero properties (e.g., color, intensity, tone, and/or brightness)) (e.g., where at least one light source in communication with the computer system is outputting light).

At 904, in response to detecting the change in user activity in the physical space, the computer system changes lighting, via the light source, of the physical space while a user (e.g., a person) continues to be detected in the physical space (e.g., as illustrated between FIGS. 8A and 8B, FIGS. 8A and 8C, FIGS. 8B and 8C, and/or FIGS. 8D and 8E). In some examples, changing the lighting includes activating the light source. In some examples, changing the lighting includes changing light output by the light source. In some examples, changing the lighting includes sending a request to the light source to modify light being output by the light source. In some examples, changing the lighting includes causing a first light source to change in a first manner (e.g., increase/decrease brightness, tone, intensity, and/or warmth and/or change color) and causing a second light source to change in a second manner (e.g., increase/decrease brightness, tone, intensity, and/or warmth and/or change color) different from the first manner. In some examples, the lighting of the physical space is changed to have a second set of properties (e.g., where at least one light source in communication with the computer system is outputting light) different from the first set of properties. In some examples, the change in user activity is detected by the same sensor that detects the user in the physical space. In some examples, the change in user activity is detected by a different sensor than a sensor that detects the user in the physical space. In some examples, the change in user activity does not correspond to a change in location (e.g., as illustrated between FIGS. 8A and 8B). In some examples, the lighting is changed based on a particular user activity detected in the physical space. In some examples, the lighting is changed in a first manner (e.g., illumination, color, color intensity, color hue, color temperature, and/or brightness is increased and/or decreased) in accordance with a determination that the change in user activity is a change to a first type of user activity, and the lighting is changed in a second manner different from the first manner in accordance with a determination that the change in user activity is a change to a second type of user activity different from the first type of user activity. In some examples, the lighting is changed in a third manner in accordance with a determination that the change in user activity is a change from a third type of user activity, and the lighting is changed in a fourth manner different from the third manner in accordance with a determination that the change in user activity is a change from a fourth type of user activity different from the third type of user activity. In some examples, the user is detected in the physical space via a motion sensor and the change in user activity is detected via a different type of sensor than a motion sensor. Changing light of the physical space while a user continues to be detected in the physical space and in response to detecting change in user activity allows for automatic, without user input, effects to occur with respect to not only presence of users in the physical space but also their activity (e.g., separating the two types of detection into different determinations that can each cause different results respectively), thereby reducing the number of inputs needed to perform an operation, providing additional control options without cluttering the user interface with additional displayed controls, and performing an operation when a set of conditions has been met without requiring further user input.

In some examples, detecting the change in user activity in the physical activity includes detecting a change in sleep state (or wake or awake state) of a first user (e.g., the user and/or another user) (e.g., the first user has woken up (e.g., for a predetermined period of time (e.g., 1-10000 seconds) and/or fallen asleep (e.g., 1-10000 seconds))) (e.g., based on a change in sleep state of the first user) (e.g., 810). In some examples, detecting the change in the sleep state of the first user is based on analysis of one or more images of the physical space (e.g., detecting movement and/or no movement for a period of time of the first user). In some examples, detecting the change in the sleep state of the first user is based on detecting input (e.g., a tap input and/or a non-tap input (e.g., a voice input, a gaze input, an air gesture, a pointing gesture a swipe input, and/or a mouse click)) by the first user. In some examples, detecting the change in the sleep state of the first user is based on a whether a motion sensor in the physical space has been triggered (e.g., has detected motion). In some examples, detecting the change in the sleep state is determined via one or more wearable, fitness tracking devices, and/or stationary devices, such as smart watch and/or a computer. Detecting a change in sleep state to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, detecting the change in user activity in the physical activity includes detecting that a first number of users (e.g., people) (e.g., 810 and/or 824) detected in the physical space has changed (e.g., within an area and/or region of the physical space and/or in the entirety of the physical space) from a first number (e.g., 1 as illustrated in FIGS. 8A and 8B and/or 2 as illustrated in FIG. 8D) to a second number (e.g., 2 as illustrated in FIG. 8C and/or 3 as illustrated in FIG. 8E) different from the first number. In some examples, detecting that the first number of users detected in the physical space has changed from the first number to the second number is based on information received in a communication from a different device (such as a user device of one or more of the users). In some examples, detecting that the first number of users detected in the physical space has changed from the first number to the second number is based on analysis of one or more images of the physical space. In some examples, detecting that the first number of users detected in the physical space has changed from the first number to the second number is based on a whether a motion sensor in the physical space has been triggered (e.g., has detected motion). Detecting a change in number of users to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, the second number is greater than the first number (e.g., that the number of users in the physical space and/or in an area and/or region in the physical space has increased) (e.g., as illustrated in FIG. 8C with two people as compared to the one person illustrated in FIGS. 8A-8B and/or as illustrated in FIG. 8E with three people as compared to the two people illustrated in FIG. 8D). Detecting an increase in number of users to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, the second number is less than the first number (e.g., that the number of users in the physical space and/or in an area and/or region in the physical space has decreased). Detecting a decrease in number of users to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, detecting the change in user activity in the physical activity includes detecting that a second number of users (e.g., the first number of users or a different number of users than the first number of users) detected in the physical space are performing an activity (e.g., a particular and/or specific activity, such as sitting together at a table (e.g., as illustrated in FIG. 8D), dancing, talking, sleeping (e.g., as illustrated in FIG. 8B), and/or watching television on a couch). In some examples, detecting that the second number of users detected in the physical space are performing the activity is based on analysis of one or more images of the physical space. In some examples, detecting that the second number of people detected in the physical space are performing the activity is based on a state (e.g., on and/or off) of a device (e.g., a user device of a user of the second number of users) in the physical space. Detecting a change in number of users performing an activity to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, changing lighting of the physical space while the user continues to be detected in the physical space includes turning on or turning off at least a portion of lighting of the physical space (e.g., via the light source) (e.g., as described above with respect to FIG. 8B). In some examples, the lighting of the physical space is turned off while the user continues to be detected in the physical space. Turning on or turning off at least a portion of the physical space as the user continues to be detected in the physical space allows for illumination to automatically, without user input, adjust to the user (e.g., with or without motion), thereby reducing the number of inputs needed to perform an operation, providing additional control options without cluttering the user interface with additional displayed controls, and performing an operation when a set of conditions has been met without requiring further user input.

In some examples, changing lighting of the physical space while the user continues to be detected in the physical space includes changing an extent of lighting (e.g., increase or decrease extent of light) (e.g., increase and/or add or decrease and/or reduce amount of light) within the physical space (e.g., via the light source) (e.g., as described above with respect to FIG. 8B, when person 810 falls asleep and illumination is reduced). In some examples, changing the extent of lighting within the physical space includes increasing the amount of light output by one set of lighting while decreasing, increasing, and/or maintaining the amount of light output by another set of lighting. In some examples, changing the extent of lighting in the physical space includes decreasing the amount light output by one set of lighting while decreasing, increasing, and/or maintaining the amount of light output by another set of lighting. Instead of turning off and/or on lighting, changing an extent of light within the physical space while the user continues to be detected in the physical space allows for illumination to automatically, without user input, adjust to the user (e.g., with or without motion), thereby reducing the number of inputs needed to perform an operation, providing additional control options without cluttering the user interface with additional displayed controls, and performing an operation when a set of conditions has been met without requiring further user input.

In some examples, detecting the change in user activity in the physical activity includes detecting that a second user (e.g., the user and/or another user) (e.g., 810, 824, and/or 844) is within a predetermined (e.g., predefined and/or preconfigured) distance (e.g., 0.1-20 meters) of a location within the physical space (e.g., approaching an object and/or device in the physical space) (e.g., a location for which there is inadequate illumination for the user (and/or the second user) to see). In some examples, detecting that the second user is within the predetermined distance of the location is based on information received in a communication from a different device (such as a user device of the second user). In some examples, detecting that the second user is within the predetermined distance of the location is based on analysis of one or more images of the physical space. In some examples, detecting that the second user is within the predetermined distance of the location is based on a whether a motion sensor in the physical space has been triggered (e.g., has detected motion). Detecting that the second user is within a predetermined distance of the location within the physical space to change the light of the physical space allows for illumination to automatically, without user input, adjust to changes in user activity and/or ensure a comfortable environment for users that adjusts to their activity, thereby reducing the number of inputs needed to perform an operation, providing additional control options without cluttering the user interface with additional displayed controls, and performing an operation when a set of conditions has been met without requiring further user input.

In some examples, changing lighting of the physical space while the user continues to be detected in the physical space includes changing a region (as described above in relation to method 700) of the physical space that is illuminated from a first region of the physical space to a second region of the physical space different from the first region of the physical space (e.g., as the user moves in the physical space, such as from the first region of the physical space to the second region of the physical space) (e.g., follow the user from one location to another as the person moves in the physical space so that, for example, the user is able to see) (e.g., as illustrated in FIGS. 8C, 8D, and/or 8E). In some examples, the second region is a region that does not include (e.g., initially and/or when changing lighting) the user (e.g., the second region is where the user is heading and/or looking). In some examples, the lighting is changed (e.g., a new region is illuminated) without the user moving. In some examples, the computer system detects movement of the user; and in response to detecting movement of the user, the computer system changes a region of the physical space that is currently illuminated from the region of the physical space to the second region of the physical space. In some examples, the first region is not included with and/or does not include the second region, and/or vice-versa. Changing the region of the physical space that is illuminated from the first region to the second region while the user continues to be detected in the physical space allows for illumination to automatically, without user input, adjust to changing needs of the user (e.g., following the user from one region to another), thereby reducing the number of inputs needed to perform an operation, providing additional control options without cluttering the user interface with additional displayed controls, and performing an operation when a set of conditions has been met without requiring further user input.

In some examples, the first region and the second region are illuminated by the same light source (e.g., a single spotlight that is either able to target different regions and/or be moved). In some examples, the size of the lighting changes as the lighting follows the user and/or based on regions of the physical space that are being lit and/or that light is moving between.

In some examples, the first region is illuminated via a first light source (e.g., 801, 801A, 801B, 801C, and/or 801D). In some examples, the second region is illuminated via a second light source (e.g., 801, 801A, 801B, 801C, and/or 801D) different from the first light source. In some examples, the computer system is in communication with the first light source and/or the second light source. In some examples, the first light source is not in communication with the second light source. In some examples, different light sources are used for different regions of the physical space (e.g., different lighting for couch as compared to table). In some examples, a region of the physical space is defined by an object (e.g., couch in FIGS. 8A-8C, 836, and/or 838) that is included in the region, such as a couch and/or a table.

Note that details of the processes described above with respect to method 900 (e.g., FIG. 9) are also applicable in an analogous manner to the methods described herein. For example, method 700 optionally includes one or more of the characteristics of the various methods described above with reference to method 900. For example, the region in method 700 can include the change in user activity of method 900. For brevity, these details are not repeated below.

FIGS. 10A-10E illustrate exemplary techniques for communicating information using illumination location in accordance with some examples. The user interfaces in these figures are used to illustrate the processes described below, including the one or more processes described in relation to FIG. 11.

FIG. 10A illustrates physical space 1000, a room with person 1002 (e.g., the same as person 620 and/or person 810). In some examples, light sources 1001 communicate information (e.g., to a user) using location of an illumination. In some examples, light sources 1001 include one or more features as described herein with respect to any one or more light sources described with respect to FIGS. 6, 8, 12, and/or 14.

At FIG. 10A, light sources 1001 detect a request by person 1002 to illuminate wall 1004. The request can include input that is one or more of: input including one or more trigger words (e.g., “Hey Personal Assistant”), input representing a physical gesture (e.g., a pointing gesture if person 1002 is pointing at a particular location on wall 1004, such as with a finger and/or a remote control in the hand of person 1002), input representing a spoken request (e.g., “Please light that area with blue light”), and/or other input (e.g., input at a device in communication with a light source, such as a remote control, a controller device, and/or a smartphone). In some examples, the request includes multiple different requests for different colors (e.g., colors, color temperatures, hues, intensities, and/or color saturations) and/or lighting locations. In some examples, the request indicates one or more physical locations rather than a physical zone. In some examples, the request does not indicate one or more colors (e.g., colors, color temperatures, hues, intensities, and/or color saturations) for one or more specific light sources and instead indicates one or more physical locations. In some examples, the request does not indicate one or more specific light sources and instead indicates one or more physical locations. As illustrated in FIG. 10A, the request to illuminate wall 1004 includes input representing a pointing gesture being made by person 1002. At FIG. 10A, light sources 1001 detect the request to illuminate wall 1004 at the location toward which person 1002 is gesturing, region 1014, which is illustrated within a dotted line box for illustrative purposes. In response to detecting the request, light sources 1001 illuminate region 1014 with the requested type of illumination (e.g., blue light). In some examples, region 1014 covers the entire area of wall 1004. In some examples, region 1014 covers less than the entire area of wall 1004 (e.g., the area inside the dashed line in FIG. 10A).

FIG. 10B illustrates a user requesting illumination at a second location in physical space 1000. At FIG. 10B, light sources 1001 detect a request (e.g., one or more inputs representing a request) by person 1002 to illuminate wall 1006 (a different wall at a different location than wall 1004). For example, light sources 1001 detect a request that includes moving a pointing gesture to a different location and/or a voice input (e.g., “Please light that area with blue light”) representing a voice command to illuminate wall 1006 and input representing a pointing gesture by person 1002 toward region 1016. As illustrated in FIG. 10B, in response to detecting the request, light sources 1001 illuminate region 1016 with the requested type of illumination (e.g., blue light).

In some examples, in response to a request to illuminate a particular location, light sources 1001 illuminate the particular location with the requested illumination while maintaining some or all existing illumination of one or more other regions within physical space 1000. For example, at FIG. 10B, light sources 1001 illuminate region 1016 while leaving the previously requested illumination of region 1014 unchanged (e.g., now both regions 1016 and 1014 are illuminated in blue light per their respective requests), as well as leaving the illumination of the wall area surrounding region 1016 unchanged. In some examples, in response to a request to illuminate a particular location, light sources 1001 illuminate the particular location with the requested illumination and change some or all existing illumination of physical space 1000. For example, light sources 1001 can cease illuminating region 1014 in response to a request to illuminate region 1016 (e.g., a subsequent request cancels illumination resulting from a previous request), and/or change (e.g., dim) the illumination of the wall area surrounding region 1016.

In some examples, a request to illuminate includes (e.g., is) an input representing a pointing gesture. For example, FIGS. 10A and 10B each illustrate person 1002 performing a pointing gesture, which light sources 1001 can detect as input representing a request to illuminate a region. In some examples, if the request is an input representing a pointing gesture not accompanied by a second type of input, light sources 1001 cease outputting the requested illumination in response to ceasing to detect input representing the pointing gesture toward the region. For example, at FIG. 10B, if light sources 1001 detect that the request to illuminate wall 1006 is made by person 1002 without an accompanying and/or preceding gesture, button press, and/or voice input representing a voice command, then light sources 1001 cease to output the illumination in region 1016 in response to the input representing the pointing gesture. In some examples, if the request includes an input representing a pointing gesture accompanied or preceded by a second type of input (e.g., an accompanying and/or preceding gesture, button press, and/or voice input representing a voice command), light sources 1001 continue outputting the requested illumination in response to ceasing to detect the input representing the pointing gesture. For example, at FIG. 10B, if the request to illuminate wall 1006 is made by person 1002 with the second type of input (e.g., a voice command that says “Please light that area with blue light”), then light sources 1001 can continue to output the illumination in region 1016 performed in response to the request (e.g., inputs representing pointing gesture and voice command) after ceasing to detect the input representing the pointing gesture (e.g., the user stops pointing).

As should be appreciated from the description above, a user does not necessarily have to specify a particular uniquely named portion of physical space 1000 in order for light sources 1001 to react. For example, an input representing a voice command can identify a general location/area/object (e.g., “that area,” “this,” “here,” and/or “that object”) and/or make an input representing a pointing gesture toward a general location, area, and/or object. This stands in contrast to some home control devices available today that require interaction with a specific preprogrammed button (e.g., physical or virtual) or use of a preprogrammed identifier (e.g., name) associated with a device and/or room in order to adjust illumination of that device and/or room (e.g., “Turn off living room,” or “Turn off table lamp 2”).

In some examples, light sources 1001 determine (e.g., dynamically) one or more characteristics (e.g., size, shape, and/or intensity) of illumination based on one or more properties of an object at a location associated with a request. For example, at FIG. 10B, if wall 1006 includes a painting hanging on it and person 1002 points to the painting and utters the voice command “Please light up that painting with bright white light,” light sources 1001 can detect this request (e.g., inputs representing a pointing gesture and a voice command) and, in response, perform one or more operations that: determine the location and/or area where user is pointing, identify the painting, determine the dimensions (e.g., shape) of the painting, and/or illuminate the painting with bright white light.

FIGS. 10C-10D illustrate an example technique for using illumination to identify the location of an object. FIG. 10C illustrates physical space 1000, a room with person 1002 and key 1020 (an example of an object). In some examples, light sources 1001 receive a request to identify the location of one or more objects. For example, at FIG. 10C, light sources 1001 detect input representing a request by person 1002 to locate their key 1020, after person 1002 says out loud: “Where is my key?” In some examples, in response to receiving a request to identify the location of one or more objects and while illuminating wall 1006 (e.g., as described above with respect to FIG. 10B), light sources 1001 determine the location of the one or more objects. For example, at FIG. 10C, light sources 1001 use data from one or more sensors in communication with light sources 1001 to determine a location of key 1020 within physical space 1000. Examples of sensors include image sensors and location sensors. Light sources 1001 can also use saved location data to determine the location of an object (e.g., the location of the object is tracked and recorded so determining the location includes accessing such recorded data). In some examples, light sources 1001 indicate a location of an object using a visual illumination (e.g., a spot of light output onto physical space 1000). For example, at FIG. 10C, illumination 1022 is illustrated. Illumination 1022 can be used to indicate a current location of a search (e.g., point where light sources 1001 have determined that key 1020 is located). Spotlight illumination 1022 can also be displayed transitioning from an initial location (e.g., wall 1006) to the current location of the search by moving illumination between the two locations, as illustrated between FIGS. 10B-10D.

FIG. 10D illustrates illumination 1022 illuminating key 1020. In some examples, in response to receiving a request to identify one or more objects, light sources 1001 illuminate the one or more objects. For example, at FIG. 10D, light sources 1001 determine the location of key 1020 and illuminate key 1020 by outputting illumination 1022. As mentioned above, in some examples, light sources 1001 cause illumination (e.g., a spotlight) to move across physical space 1000 to the location of the one or more objects. For example, at FIG. 10C illumination 1022 begins at wall 1006, after which it can move in a continuous motion (e.g., smoothly) toward the key 1020 until key 1020 is illuminated. In some examples, the continuous motion includes not stopping before reaching the destination. In some examples, the continuous motion is along the shortest line from a starting point to the destination. In some examples, a smooth motion includes moving at a constant and/or consistent rate. In some examples, a smooth motion includes moving in a straight line. In some examples, a smooth motion includes moving along a particular surface and/or type of surface. In some examples, a smooth motion includes moving at a consistent and/or constant distance from one or more people (e.g., 1002) in physical space 1000. In some examples, a smooth motion includes moving at a rate corresponding to a mathematical equation (e.g., a bell curve, exponentially, linearly, and/or other mathematical equations). The use of movement of the illumination can allow light sources 1001 to effectively attract a user's attention to the requested one or more object locations (e.g., the user can more quickly recognize movement and follow it to the object).

In some examples, illumination changes size as it moves through the physical space. For example, in FIG. 10C, illumination 1022 is a small square and, as it moves toward key 1020, it expands in size and/or changes shape to match the requested object location. At FIG. 10D, light sources 1001 change the shape and/or size of illumination 1022 as it moves (and/or in response) to illuminating (e.g., arriving at) the location of key 1020, and it is now larger than illumination 1022 of FIG. 10C. In some examples, the initial size of illumination 1022 depends on the size of an object at the initial location and/or an illumination at an initial location. For example, the size of illumination 1022 in FIG. 10C can be based on a first object that was requested to be illuminated that is at the initial location (e.g., wall 1006). After illuminating the first object, light sources 1001 receive the request to locate key 1020 and move from the initial location of the first object until reaching the location of key 1020, a second object at a second location. During such movement (and/or in response to arriving at a location of key 1020), the size, shape, and/or properties of illumination 1022 can change (e.g., to match the size of key 1020).

In some examples, light sources 1001 remain stationary (e.g., do not move) as illumination is changed (e.g., moved). In some examples, light sources 1001 are comprised of multiple light sources that output illumination in different directions (e.g., enough to cover a field of view of physical space 1000 from the perspective of light sources 1001), and illumination 1022 can be formed by selectively adjusting (e.g., turning on or off and/or changing illumination properties) one or more subset of the multiple light sources making up light sources 1001 in order to form illumination 1022 (e.g., in FIGS. 10C and 10D). Light sources 1001 remaining stationary while changing (e.g., moving) illumination stands in contrast to other techniques for moving illumination that require moving parts (e.g., moving the light sources and/or one or more lenses and/or shutters).

In some examples, one or more properties of illumination can be configured based on a confidence that an object is located at the location being illuminated. For example, in FIG. 10D, key 1020 is not obscured from one or more image sensors in communication with light sources 1001 (e.g., that are located on the ceiling), and light sources 1001 have a high confidence that the key 1020 is at the location illuminated by illumination 1022—illumination 1022 can have bright illumination to indicate high confidence. If light sources 1001 had lower confidence of the location of key 1020 (e.g., if key 1020 is partially or totally obscured by a piece of furniture) than the high confidence, illumination at that location can appear bigger (e.g., to cover a larger area) and/or dimmer (e.g., than as described for the high confidence scenario).

In some examples, one or more characteristics of illumination are based on a location of a device with which person 1002 is interacting. For example, as illustrated in FIG. 10E, smart speaker 1030 is illuminated by illumination 1032. In this example, person 1002 interacts with smart speaker 1030 using voice input asking for smart speaker 1030 to cause display device 1040 to begin playing back media (e.g., playing a movie). As illustrated in FIG. 10E, smart speaker 1030 is illuminated (e.g., while it outputs a response or indication that the voice input was received and/or understood). In some examples, illumination moves to another device in response to an event (e.g., that represents a change in the device that person 1002 should interact with). For example, for the scenario in FIG. 10E, subsequent to smart speaker 1030 being finished outputting a response to person 1002 and/or successfully instructing display device 1040 to begin media playback as requested, illumination 1032 can move to the location of display device 1040 (or can cease to be displayed and a new spotlight illuminated at the location of display device 1040).

FIG. 11 is a flow diagram illustrating a method (e.g., method 1100) for communicating information in accordance with some examples. Some operations in method 1100 are, optionally, combined, the orders of some operations are, optionally, changed, and some operations are, optionally, omitted.

As described below, method 1100 provides an intuitive way for communicating information. Method 1100 reduces the cognitive burden on a user for communicating information, thereby creating a more efficient human-machine interface. For battery-operated computing devices, enabling a user to communicate information faster and more efficiently conserves power and increases the time between battery charges.

In some examples, method 1100 is performed at a computer system (e.g., 100, 300, and/or 500) that is in communication with a light source (e.g., an illumination device, a point light source, a spotlight, and/or one or more light sources that are integrated into a single device) (e.g., 1001, 1001A, 1001B, 1001C, and/or 1001D). In some examples, the computer system is a phone, a watch, a tablet, a fitness tracking device, a wearable device, an accessory, a speaker, a light, a head-mounted display (HMD), and/or a personal computing device. In some examples, the light source is not physically connected to and/or coupled to the computer system. In some examples, the computer system is in communication with one or more cameras. In some examples, the one or more cameras are not physically connected to the light source.

At 1102, the computer system detects an illumination request (e.g., as illustrated by 1002 in FIGS. 10A and/or 10B) that corresponds to a request to illuminate a respective region (e.g., a respective location, a respective area, a respective portion, and/or a respective part) (e.g., 1004 and/or 1006) of a physical space (e.g., a physical environment, a room, an office, and/or a building) (e.g., 1000). In some examples, detecting the illumination request includes detecting input (e.g., a tap gesture, a long press gesture, a verbal request and/or command, a physical button press, a pointing input and/or air gesture, and/or a rotation of a physical input mechanism) corresponding to the request. In some examples, detecting the illumination request includes receiving a message from a different computer system, the message indicating that the request was received by the different computer system. In some examples, the request to illuminate the respective region of the physical space does not include a request to illuminate a first region (e.g., 1004 and/or 1006) of the physical space and/or a second region (e.g., 1004 and/or 1006) of the physical space.

At 1104, in response to detecting the illumination request and in accordance with a determination that the request corresponds to a first region (e.g., 1004 and/or 1006) (and/or the respective region includes and/or is the first region) (e.g., as described above in relation to method 700) of the physical space, the computer system illuminates, via the light source, the first region (e.g., without illuminating (and/or without directly illuminating) the second region) (e.g., as illustrated in FIGS. 10A, 10B, 10C, 10D, and/or 10E). In some examples, illuminating the first region includes activating the light source. In some examples, illuminating the first region includes changing light output by the light source. In some examples, illuminating the first region includes sending a request to the light source to modify light being output by the light source. In some examples, illuminating the first region includes causing a first light source (e.g., 1001, 1001A, 1001B, 1001C, and/or 1001D) to change in a first manner (e.g., increase/decrease brightness, tone, intensity, and/or warmth and/or change color) and causing a second light source (e.g., 1001, 1001A, 1001B, 1001C, and/or 1001D) to change in a second manner (e.g., increase/decrease brightness, tone, intensity, and/or warmth and/or change color) different from the first manner.

At 1106, in response to detecting the illumination request and in accordance with a determination that the request corresponds to a second region (and/or the respective region includes and/or is the second region) (e.g., as described above in relation to method 700) (e.g., 1004 and/or 1006) of the physical space different from (e.g., not overlapping, at least not partially overlapping, and/or separate from) the first region, the computer system illuminates, via the light source, the second region (e.g., without illuminating (and/or without directly illuminating) the first region) (e.g., as illustrated in FIGS. 10A, 10B, 10C, 10D, and/or 10E). In some examples, illuminating the second region includes activating the light source. In some examples, illuminating the second region includes changing light output by the light source. In some examples, illuminating the second region includes sending a request to the light source to modify light being output by the light source. In some examples, illuminating the second region is different from illuminating the first region. In some examples, illuminating the second region includes causing a third light source (e.g., 1001, 1001A, 1001B, 1001C, and/or 1001D) to change in a third manner (e.g., increase/decrease brightness, tone, intensity, and/or warmth and/or change color) and causing a fourth light source (e.g., 1001, 1001A, 1001B, 1001C, and/or 1001D) to change in a fourth manner (e.g., increase/decrease brightness, tone, intensity, and/or warmth and/or change color) different from the third manner. In some examples, the third light source is the same as the first or second light source. In some examples, one or more of the first light source and the second light source are different from the third light source and/or the fourth light source. In some examples, the third light source is different from the fourth light source. Illuminating, via the light source, different regions of the physical space in accordance with a determination that a request corresponds to a respective region allows for illumination to occur automatically, without user input, in a proper region and not other regions, thereby reducing the number of inputs needed to perform an operation, providing additional control options without cluttering the user interface with additional displayed controls, and performing an operation when a set of conditions has been met without requiring further user input.

In some examples, detecting the illumination request includes detecting (e.g., via one or more sensors (e.g., a camera and/or a depth sensor in communication with the computer system)) a first pointing input (e.g., the facing and/or pointing of an object (e.g., 1002), such as a device (e.g., a portable device, a fitness tracking device, a wearable device, and/or a remote control) (e.g., the computer system), a finger, hand, arm, and/or head nod of a user) (e.g., a pointing air gesture and/or an input detected by a fitness tracking and/or wearable device) (or, in some examples, a non-pointing input, such as a mouse click, a swipe gesture/input, a tap gesture/input, and/or a voice command) in the direction of (and/or directed to) the respective region of the physical space. Detecting the first pointing input in the direction of the respective region to illuminate the first region or the second region allows the user to direct what is illuminated through the first pointing input, thereby reducing the number of inputs needed to perform an operation, providing additional control options without cluttering the user interface with additional displayed controls, and performing an operation when a set of conditions has been met without requiring further user input.

In some examples, detecting the illumination request includes detecting (e.g., receives, obtains, and/or acquires) a request to identify a location (e.g., a current, precise, and/or last-identified location) (e.g., 1022 and/or 1032) of an object (e.g., a movable object, such as a portable device, keys, a book, a person, and/or a tablet, or a non-movable object, such as a wall, a room, a region, a couch, or a table) (e.g., 1020 and/or 1030). Detecting the request to identify the location of the object to illuminate the first region or the second region allows the user to identify where the object is located through the illumination request, thereby reducing the number of inputs needed to perform an operation, providing additional control options without cluttering the user interface with additional displayed controls, and performing an operation when a set of conditions has been met without requiring further user input.

In some examples, the location of the object is specified in the illumination request (e.g., and not solely determined via the computer system) (e.g., the user asks to illuminate the painting on the wall). In some examples, the location of the object is determined based on (e.g., without other input) the illumination request.

In some examples, the location of the object is determined via the computer system (e.g., without a user specifying the location in the illumination request). In some examples, the location of the object is determined after detecting the illumination request. In some examples, the illumination request includes an identification of the object. In some examples, after detecting the illumination request, the computer system determines a location (e.g., 1022 and/or 1032) of the object by locating the object in the physical space. The computer system determining the location of the object allows for the user to identify where the object is located without the user knowing where it is located, thereby reducing the number of inputs needed to perform an operation, providing additional control options without cluttering the user interface with additional displayed controls, and performing an operation when a set of conditions has been met without requiring further user input.

In some examples, in response to detecting the illumination request, in accordance with a determination that the request corresponds to the first region, and in accordance with a determination that the object has a first likelihood (e.g., a first confidence and/or accuracy level) of being in the first region, the first region is illuminated in a first manner (e.g., color, intensity, color temperature, and/or size of the illumination). In some examples, in accordance with a determination that the request corresponds to the first region and in accordance with a determination that the object has a second likelihood (e.g., different from the first likelihood) (e.g., a second confidence and/or accuracy level) of being in the first region, the first region is illuminated in a second manner (e.g., color, intensity, color temperature, and/or size of the illumination) different from the first manner (e.g., without the first region being illuminated in the first manner). In some examples, the same object is illuminated differently depending on how confident the computer system is that the object is in the respective region. In some examples, in accordance with a determination that the request corresponds to the second region and in accordance with a determination that the object has a third likelihood (e.g., a third confidence and/or accuracy level) of being in the second region, the second region is illuminated in the first manner; and in accordance with a determination that the request corresponds to the second region and in accordance with a determination that the object has a fourth likelihood (e.g., different from the third likelihood) (e.g., a fourth confidence and/or accuracy level) of being in the second region, the second region is illuminated in the second manner. In some examples, the first likelihood is above a threshold confidence level while the second likelihood is below the threshold confidence level and/or vice-versa. Illuminating the first region in different manners in accordance with a determination of the likelihood that the object is in the first region allows for a user to understand the likelihood at a glance, thereby providing improved visual feedback to the user and performing an operation when a set of conditions has been met without requiring further user input.

In some examples, illuminating, via the light source, the first region includes: for a first timeframe, moving the illumination from a first portion of the first region to a second portion of the first region at a first rate (e.g., as illustrated between FIGS. 10B and 10C); and after the first timeframe and for a second timeframe moving the illumination of the second portion of the first region to a third portion of the first region at the first rate (e.g., as illustrated between FIGS. 10C and 10D), wherein the second portion of the first region is adjacent to (e.g., shares a side and/or border with and/or next to) the first portion of the first region and the third portion of the first region. In some examples, the second portion of the first region is different from (e.g., not included within and/or does not include) the first portion of the first region, the first portion of the first region is different from the third portion of the first region, and the third portion of the first region is different from the second portion of the first region. In some examples, the first timeframe and the second timeframe are the same length of time. In some examples, the light source is moved across the first region at a constant and/or regular rate. In some examples, each region of a plurality of regions is adjacent to at least one other region of the plurality of regions. In some examples, the first region is adjacent to a region of the plurality of regions. In some examples, the plurality of regions includes the first region. In some examples, each region of the plurality of regions is illuminated for the same amount of time. In some examples, the plurality of regions are illuminated consecutively and sequentially. In some examples, sequentially illuminating the plurality of regions includes illuminating a first region without illuminating a second region and, after illuminating the first region, illuminating the second region without illuminating the first region. Illuminating different portions of the first region at the first rate in response to detecting the illumination request allows for the user to follow where the illumination while it is moving, thereby providing improved visual feedback to the user and performing an operation when a set of conditions has been met without requiring further user input.

In some examples, the light source maintains a particular location (and/or position) while moving the illumination of the first portion of the first region to the second portion of the first region and moving the illumination of the second portion of the first region to the third portion of the first region. In some examples, the light source does not move while sequentially illuminating portions of a region. Maintaining the particular location of the light source while moving the illumination allows for less movement of the light source, thereby reducing wear on parts of the light source.

In some examples, detecting the illuminating request includes detecting input (e.g., a pointing input (as described above) and/or a non-pointing input (as described above)) (e.g., as illustrated by person 1002 pointing at 1004 in FIG. 10A and 1006 in FIG. 10B). In some examples, the one or more portions of the first region are identified based on the input. In some examples, the illumination request identifies a plurality of locations corresponding to a plurality of regions and/or one or more portions of a respective region. In some examples, the plurality of regions and/or one or more portions of the respective region are regions and/or portions of regions between the respective region and a location being illuminated while detecting the illumination request. In some examples, different regions and/or portions of regions are identified when detecting different input. Identifying the one or more portions of the first region based on detected input allows for illumination movement to coincide with where the user is looking, thereby providing improved visual feedback to the user and performing an operation when a set of conditions has been met without requiring further user input.

In some examples, in accordance with a determination that a size of the object is a first size in the first portion of the first region and a size of a second object (e.g., the first object, another portion of the first object, and/or a different object from the first object) is a second size in the second portion of the first region, wherein the first size is smaller than the second size, a size of the illumination of the first portion of the first region is smaller than a size of the illumination of the second portion of the first region. In some examples, in accordance with a determination that a size of the object is the first size in the first portion of the first region and the size of the second object is a third size in the second portion of the first region, wherein the first size is larger than the third size, the size of the illumination of the first portion of the first region is larger than the size of the illumination of the second portion of the first region (e.g., as illustrated between FIGS. 10B and 10D, with 1016 larger in FIG. 10B than 1022 in FIG. 10D). In some examples, in accordance with a determination that the first region (e.g., the region being illuminated) is to be illuminated a first amount (e.g., intensity and/or size of the illumination) and in accordance with a determination that a third region (e.g., a current region that is being illuminated) that is illuminated while detecting the illumination request is illuminated a second amount (e.g., intensity and/or size of the illumination) (e.g., the same and/or different from the first amount), a fourth region (e.g., a region between the first region and the third region) of the plurality of regions is illuminated a third amount (e.g., intensity and/or size of the illumination) different from the first amount and/or the second amount; and in accordance with a determination that the first region is to be illuminated the first amount and in accordance with a determination that the third region is illuminated a fourth amount (e.g., intensity and/or size of the illumination) different from the second amount, the fourth region of the plurality of regions is illuminated a fifth amount (e.g., intensity and/or size of the illumination) different from the first amount and/or the third amount; and in accordance with a determination that the first region is to be illuminated a sixth amount (e.g., intensity and/or size of the illumination) different from the first amount and in accordance with a determination that the third region is illuminated the second amount, the fourth region of the plurality of regions is illuminated a seventh amount (e.g., intensity and/or size of the illumination) different from the third amount and/or the sixth amount; and in accordance with a determination that the first region is to be illuminated the sixth amount and in accordance with a determination that the third region is illuminated the fourth amount, the fourth region of the plurality of regions is illuminated an eighth amount (e.g., intensity and/or size of the illumination) different from the fifth amount and/or the sixth amount. In some examples, illumination changes size while moving across the physical space (e.g., as illustrated between FIGS. 10B, 10C, and 10D, where 1016 of FIG. 10B becomes smaller in 1022 of FIG. 10C and then bigger in 1022 of FIG. 10D), where size change is dependent on size of illumination at original location and the new location. Having different sizes of illumination while moving the illumination allows for a signal to the size of the object (or likelihood that an object is where is being illuminated) before reaching the object, thereby providing improved visual feedback to the user and performing an operation when a set of conditions has been met without requiring further user input.

In some examples, the illumination request corresponds to a request for a device (e.g., a smart speaker, a television, a telephone, a smart watch, and/or a wearable device) (e.g., 1030 and/or 1040), different from the computer system, to output content (e.g., visual and/or auditory content). In some examples, the device different from the computer system is a smart speaker (e.g., 1030). In some examples, the device different from the computer system is a television (e.g., 1040). In some examples, in accordance with the determination that the first region includes the device, the respective region is the first region (e.g., as illustrated by 1032 in FIG. 10E). In some examples, in accordance with the determination that the second region includes the device, the respective region is the second region. In some examples, the illumination is based on a location of the device with which the user is interacting with and/or is requesting to perform an action. In some examples, the device is not the computer system and/or a device that is interpreting a voice request. In some examples, detecting the illumination request includes detecting user interaction with a device different from the computer system. In some examples, the user interaction is a request that the causes the device to output and/or adjust content, a user looking at and/or gazing at the device, and/or a user providing input to the device (e.g., via a touch input/gesture, an air gesture, a voice command, and/or another type of gesture).

In some examples, illuminating the first region includes: in accordance with a determination that the illumination request corresponds to a first object, providing, via the light source, a first type of illumination (e.g., size, shape, and/or intensity) (e.g., as described above in relation to method 700); and in accordance with a determination that the illumination request corresponds to a second object different from the first object, providing, via the light source, a second type of illumination (e.g., size, shape, and/or intensity) (e.g., as described above in relation to method 700) different from the first type of illumination (e.g., as illustrated by 1022 in FIG. 10D being different from 1032 in FIG. 10E). In some examples, the type of illumination is dynamically determined based on a location of an object. In some examples, the type of illumination is dynamically determined based on a type of an object. Providing different types of illumination in accordance with a determination that the illumination request corresponds to different objects allows the user to identify a type of the object through the illumination request, thereby reducing the number of inputs needed to perform an operation, providing additional control options without cluttering the user interface with additional displayed controls, and performing an operation when a set of conditions has been met without requiring further user input.

In some examples, in response to detecting that the second pointing input is no longer facing the first region and in accordance with a determination that a respective input (e.g., a lock input and/or an input indicating that illumination should not only correspond to a direction of the pointing input) has been detected (e.g., while illuminating the first region and/or with respect to the illumination request), the computer system continues to illuminate (and, in some examples, maintaining the illumination of and/or the same type of illumination of), via the light source, the first region (e.g., as described above with respect to FIG. 10B). In some examples, in response to detecting that the second pointing input is no longer facing the first region and in accordance with a determination that the respective input has not been detected (e.g., while illuminating the first region and/or with respect to the illumination request), the computer system ceases to illuminate, via the light source, the first region (e.g., as described above with respect to FIG. 10B). Ceasing to illuminate the first region in accordance with a determination that the respective input has not been detected allows for the user to choose when illumination is maintained, thereby reducing the number of inputs needed to perform an operation, providing additional control options without cluttering the user interface with additional displayed controls, and performing an operation when a set of conditions has been met without requiring further user input.

In some examples, the illumination request does not include an identifier of the respective region (e.g., the first region or the second region). In some examples, the request that corresponds to the first region does not include a request identifying (e.g., by an identifier, name, textual representation, and/or nomenclature associated with) the first region. In some examples, the request that corresponds to the second region does not include a request identifying (e.g., by an identifier, name, textual representation, and/or nomenclature associated with) the second region. In some examples, the respective region is automatically identified (e.g., by the computer system and/or another computer system).

Note that details of the processes described above with respect to method 1100 (e.g., FIG. 11) are also applicable in an analogous manner to the methods described herein. For example, method 700 optionally includes one or more of the characteristics of the various methods described above with reference to method 1100. For example, the light source of method 700 can be the light source of method 1100. For brevity, these details are not repeated below.

FIGS. 12A-12D illustrate exemplary techniques for providing a representation of a context of a physical space in accordance with some examples. The user interfaces in these figures are used to illustrate the processes described below, including the one or more processes described in relation to FIG. 13.

FIG. 12A illustrates physical space 1200: a room with light sources 1201 and wall 1202 (a physical feature). In some examples, light sources 1201 include one or more features as described herein with respect to any one or more light sources described with respect to FIGS. 6, 8, 10, and/or 14. FIG. 12A also illustrates environment 1210 (shown in box A), which includes person 1212 and person 1214, and also illustrates environment 1220 (shown in box B), which includes tree 1222.

In some examples, light sources 1201 illuminate a region (e.g., wall 1202) of physical space 1200 with a representation of a context of an environment (e.g., an external environment). For example, FIG. 12A illustrates light sources 1201 outputting representation 1204A and representation 1204B, both of which indicate a context of environment 1210. In this example, environment 1210 is an external environment (e.g., external to physical space 1200). Environment 1210 can be the environment directly behind wall 1202, or any other arbitrary physical location, outside of physical space 1200. In some examples, a context of an environment includes one or more of: a number of persons in the environment, a general level of activity in the environment, lighting conditions (e.g., location of the sun and/or color of sunlight), and/or weather conditions (e.g., windy, rainy, sunny, and/or cloudy). In FIG. 12A, representation 1204 (collectively used to refer to representation 1204A and representation 1204B) each represent a person in environment 1210. In particular, representation 1204A represents person 1212 in environment 1210, and representation 1204B represents person 1214 in environment 1210. In some examples, light sources 1201 output and/or modify the appearance of representation 1204A and 1204B in conjunction (e.g., in response to, as a part of, while and/or concurrently with) with an external computer system (e.g., a computer system external to light sources 1201 and/or a computer system that is in communication with light sources 1201) receiving a communication request. For example, light sources 1201 output representation 1204A and 1204B in response to the external computer system receiving the communication request, light sources 1201 change the appearance of representation 1204A and/or 1204B to an appearance that is associated with the communication request (e.g., an environment of where the communication request originated and/or a current illumination coming from the external computer system), the external computer system receives a request to change the appearance of representation 1204A and/or 1204B while receiving the communication request and/or after the communication request is accepted, and/or the external computer system can detect a request to change representation 1204A and/or 1204B based on the communication request. In some examples, the communication request originates from environment 1210 and/or a computer system in environment 1210. For example, the communication request is initiated by a user who is located in environment 1210 and/or a computer system that is positioned within an external environment. In some examples, the communication request includes an identification of environment 1210. For example, a user of another computer system (e.g., a computer system positioned within environment 1202 and/or a computer system that is external to environment 1202) can select environment 1210 to be used as the basis for illuminating environment 1202 with respect to the communication request and an indication of environment 1210 is sent with the communication request. In some examples, the external computer system that receives the communication request can detect, either before or after receiving the communication request, an input to select environment 1210 to be used as the basis for illuminating environment 1202. For example, a user can configure environment 1210 to be used as the basis for illuminating environment 1202 when the external computer receives communications requests from particular users, using particular applications, and/or that are particular types of communication (e.g., audio or video). In some examples, the computer system that is positioned within environment 1210 is connected to the external computer system positioned in the external environment in response to the communication request being accepted (e.g., as discussed above) (e.g., by a user of the external computer system). In some examples, while the computer system that is positioned within environment 1210 is connected to the external computer system, light sources 1201 illuminate environment 1202 based on the illumination of an environment of the external computer system.

In some examples, light sources 1201 modify the appearance of representation 1204A and/or 1204B in response to external computer system receiving and/or generating a notification. For example, the appearance of representation 1204A and/or 1204B will pulsate in response to the external computer system receiving and/or generating a notification. In some examples, light sources 1201 illuminate environment 1202 based on a current illumination of an external environment in response to the external computer system detecting an input that corresponds to selection of a user interface element. In some examples, the external computer system displays the user interface object as part of displaying a preview of a communication between the computer system that is positioned within environment 1210 and the external computer system. For example, in response to receiving the communication request (e.g., as described above) the external computer system displays the user interface object with a representation (e.g., textual representation and/or graphical representation) of a user of the external computer system, a live feed of a user of the external computer system, and/or a live feed of a user of the computer system that is positioned within environment 1210. In some examples, the external computer system displays the user interface element as part of displaying a representation of the communication between the external computer system and the computer system that is positioned within environment 1210.

In some examples, light sources 1201 output a representation (e.g., 1204A) of a context as an area with reduced illumination (e.g., less direct illumination than the area surrounding the representation). In some examples, light sources 1201 output a representation (e.g., 1204A) of a context as an unilluminated area (e.g., an area with no direct illumination from light sources 1201). For example, a representation formed as an area with reduced or no illumination can appear darker than the area surrounding the representation (e.g., having the appearance of a silhouette and/or shadow). This can be achieved by light sources 1201 illuminating the area surrounding the representation but not illuminating the area within the representation (or illuminating it with less or different illumination). In some examples, light sources 1201 output a representation by projecting an image and/or illumination within the area of the representation. For example, rather than appearing as a silhouette, light sources 1201 can output representation 1204 to appear as an image and/or a representation of person 1212.

As illustrated in FIG. 12A, representation 1204A is an example of an abstract representation of person 1212, and representation 1204B is an example of an abstract representation of person 1214. Together, representations 1204A and 1204B form an abstract representation of a context of environment 1210, where the context is user activity. Representations 1204A and 1204B generally represent the activity, but are not detailed representations of person 1212 and person 1214. For example, representations 1204A and 1204B represent the respective sizes of person 1212 and person 1214 (e.g., person 1212 is larger than person 1214, so representation 1204A is larger than representation 1204B), the respective locations of person 1212 and person 1214 (e.g., representation 1204A is to the left of representation 1204B, which matches the positions of corresponding persons in environment 1210), and the respective movements of person 1212 and person 1214 (e.g., representation 1204A and representation 1204B move to the left to match movement of person 1212 and person 1214 who are walking to the left in environment 1210). Representation 1204A and representation 1204B represent the size, location, and movement of person 1212 and person 1214, but do not include the same level of detail of person 1212 and person 1214 as illustrated in environment 1210 in FIG. 12A. For example, the representation 1204A and representation 1204B do not include detail that reveals the shapes, facial features, gender, or other features that allow unique identification of the people in environment 1210 in FIG. 12A. In some examples, a representation (e.g., 1204A and/or 1204B) is an abstract representation of a context (e.g., a representation that abstracts at least one visible property of a context in an environment). In some examples, a representation is not an abstract representation of a context (e.g., does not abstract away at least one visible property) (e.g., the representation is a captured image or video of a context). In some examples, light sources 1201 output representation 1204A and/or representation 1204B with an appearance based on a time of day when the user requests that representation 1204A and/or representation 1204B have an appearance that mimics a particular time of day. For example, light sources 1201 output representation 1204A and/or representation 1204B with an appearance that is based on a sunrise when the user makes the request that representation 1204A and/or representation 1204B have an appearance based on a sunrise. In some examples, light sources 1201 output representation 1204A and/or representation 1204B with an appearance based on an event when the user requests that representation 1204A and/or representation 1204B have an appearance that mimics a particular event. For example, light sources 1201 output representation 1204A and/or representation 1204B with an appearance that mimics a solar eclipse when the user makes the request that representation 1204A and/or representation 1204B have an appearance based on a solar eclipse.

In some examples, a user can select a location of (e.g., ceiling and/or wall) of environment 1202 in which light is simulated as originating from. For example, light sources 1201 can simulate light as originating from the left wall of environment 1202 based on a user input. In some examples, a representation (e.g., 1204A and/or 1204B) is an abstract representation of shadows of one or more objects that are positioned in environment 1202 based on the user defined location of a light source. For example, a representation can appear on the left side of an object when a user selects that light is originating from the right wall of environment 1202.

In some examples, light sources 1201 illuminate environment 1202 based on the illumination (e.g., a current illumination, a previous illumination and/or a future illumination) of an external environment (e.g., an environment external to environment 1202) (e.g., environment 1210 and/or environment 1220). When light sources 1201 illuminate environment 1202 based on the illumination of the external environment, light sources 1201 simulate the location of a light sources within the external environment. For example, if it is noon at the external environment, light sources 1201 will simulate a sun in the center of environment 1202. In some examples, when light sources 1201 illuminate environment 1202 based on the illumination of the external environment, light sources 1201 simulate the shadows of objects in the external environment. For example, if the external environment includes a building with a shadow directed in the west direction, light sources 1201 will simulate a shadow of the building directed in the west direction within environment 1202.

FIG. 12B illustrates physical space 1200: a room with representation 1204C. In some examples, the level of abstraction of a representation (e.g., 1204C) can be any level between a higher level of abstraction (e.g., higher than illustrated in FIG. 12A) or a lower level of abstraction (e.g., lower than illustrated in FIG. 12A). In some examples, the amount of abstraction of a representation is configurable (e.g., selectable and/or adjustable by a user). At FIG. 12B, representation 1204C is an abstract representation of a context, the general state of activity, of environment 1210 as illustrated in box A of FIG. 12B. The level of abstraction of representation 1204C is higher than the level of abstraction of representation 1204B, for at least the reasons discussed below. At FIG. 12B, representation 1204C is an abstraction of person 1214. In particular, representation 1204C abstracts the location and movement of person 1214. Representation 1204C is displayed on the left side of wall 1202 and moving to the left, yet person 1214 is on the right side of environment 1210 and moving (e.g., walking) to the right. As should be appreciated, representation 1204C represents that a person is present in the environment, but not specifically where they are and their particular movement direction or speed. By not representing the particular location or movement of the corresponding person, representation 1204C is a higher level of abstraction of position and location than representation 1204B. Put another way, representation 1204C indicates that a person is located in the environment and is moving, but not necessarily where and how fast. In some examples, levels of abstraction of one or more properties can be combined with any other level of abstraction of one or more other properties. For example, representation 1204C can represent the movement speed of person 1214, but not the location information (e.g., representation 1204C moves to the left (or some arbitrary direction) at the same speed as person 1214 who is walking to the right).

Representation 1204C also abstracts the identity of person 1214 (as described above with respect to representation 1204B). Representation 1204C also abstracts the size of person 1214. In some examples, the size of representation 1204C does not correspond to the size of person 1214. For example, if both person 1212 and person 1214 were illustrated as representations in FIG. 12B, their respective representations can be the same size. In some examples, representation 1204C is an abstract representation of multiple persons (e.g., both person 1212 and person 1214 as illustrated in environment 1210 in FIG. 12A). For example, a single representation 1204C can be used to represent more than one person, object, or combination thereof. In some examples, the size of an abstract representation (e.g., 1204C) represents a context of an environment. For example, light sources 1201 can increase the size of representation 1204C to reflect a great level of activity in environment 1210 (e.g., appear larger when more persons are detected, and appear smaller when fewer persons are detected).

In some examples, light sources 1201 receive a request to illuminate an abstract representation of a different environment (e.g., physical space). The request can be a request to change the current abstract representation to represent a different environment than what is currently represented. For example, the different environment can be another physical space (e.g., a room in another house different than the one in which physical space 1200 is located) or environment (e.g., outdoor space at any location, not limited to being near the physical space 1200). The request, for example, can come from a user in physical space 1200. For instance, the user of light sources 1201 can request to view environment 1220.

FIG. 12C illustrates physical space 1200, a room with representation 1206. Light sources 1201 output representation 1206, on wall 1202, as an area of reduced illumination (e.g., a silhouette). At FIG. 12C, representation 1206 is an abstract representation of a context (e.g., the weather) of environment 1220 as illustrated in box B of FIG. 12C. In particular, representation 1206 is an abstract representation of tree 1222 in environment 1220. As illustrated, representation 1206 is a silhouette of tree 1222 that resembles the shape of tree 1222 but does not include all of the details (e.g., details of individual leaves).

In some examples, representation 1206 includes a context of an environment, such as weather, climate, and/or lighting conditions of the environment. For example, light sources 1201 can output representation 1206 to move (e.g., sway) in a way that that represents how windy environment 1220 is (e.g., the swaying motion increases with windier conditions). In some examples, light sources 1201 can output representation 1206 to indicate the direction of wind as well, such as by swaying in a certain direction and/or outputting an additional representation of wind moving in a particular direction (e.g., one or more arrows and/or lines with spiraled ends as wind is commonly illustrated).

In some examples, representation 1206 includes a representation of the location of the sun in environment 1220. For example, light sources 1201 can output representation 1206 to include (or output a new representation of) a representation of the time of day. A representation of the time of day can include a representation of the sun (e.g., an area of increased illumination appearing as a ball of light). Light sources 1201 can output the representation of the sun (and/or the rest of wall 1202 or physical space 1200) to resemble or match the color temperature of the sunlight currently in environment 1220. For example, light sources 1201 illuminate physical space 1200 with bright white light during the middle of day, but illuminate physical space 1200 with dimmer red-orange light during the period of time around sundown. In some examples, light sources 1201 illuminate physical space 1200 with a representation of sunrise and/or sunset. For example, the representation of the sun can appear on a simulated horizon (e.g., bottom of wall 1202) and rise at the same time as sunrise in the environment (e.g., based on geographical location or sensor data associated with environment 1220). In some examples, without detecting user input, light sources 1201 move the representation of the sun within environment 1202 based on a detected passage of time and/or a predicted, estimated, and/or determined location of the sun within environment 1202. For example, light sources 1201 can initially output the representation of the sun within a left side of environment 1202 and gradually move the representation of the sun towards the right side of environment 1202 as the day progresses. In some examples, light sources 1201 can illuminate the representation of the sun with an appearance that corresponds to different times of the day (e.g., sunrise, noon, and/or sunset) in response to the computer system that is positioned within environment 1202 detecting an input. For example, a user can cause light sources 1201 to illuminate the representation of the sun with an appearance that corresponds to the sun at sunrise or sunset by selecting a setting of the computer system that is positioned within environment 1202. It should be recognized that the sun is just one example of an object being represented by light sources 1201 and that other objects, including other celestial objects (e.g., a moon or a star), can be represented by light sources 1201.

As illustrated in FIG. 12C, representation 1206 does not include an abstract representation of person 1212 of environment 1210 illustrated in box A. For example, the context selected to be represented by representation 1206 is a context in environment 1220 different from environment 1210. In some examples, if person 1212 was present in environment 1220, light sources 1201 do not output an abstract representation of person 1212 in physical space 1200 (e.g., on wall 1202, such as part of representation 1206). For example, light sources 1201 do not include an abstract representation of a person if a selected context to be represented is weather (e.g., light sources 1201 ignore person 1212 during creation of one or more abstract representations of the weather context of environment 1220). In some examples, environment 1210 and environment 1220 are the same environment where box A illustrates a first context (e.g., general activity which can include persons, and which can exclude static objects such as tree 1222) and where box B illustrates a second context (e.g., weather which can include trees, and which can exclude persons and/or buildings). In some examples, when environment 1210 is different and/or distinct from environment 1220, light sources 1201 concurrently illuminate an abstract representation of a context from environment 1210 and environment 1220 within environment 1202. In some examples, light sources 1201 transitions from outputting representations that correspond to environment 1210 to outputting representations that correspond to environment 1220 at a first rate. In some examples, light sources 1201 transitions from outputting representations that correspond to environment 1210 and/or environment 1220 to outputting representations that correspond to environment 1202 at a second rate that is faster than the first rate. In some examples, light sources 1201 gradually transitions from outputting representations that correspond to environment 1210 and/or environment 1220 to outputting representations that correspond to environment 1202 over a period of time.

FIG. 12D illustrates physical space 1200, a room with representation 1208. Light sources 1201 output representation 1208, on wall 1202, as an area of reduced illumination (e.g., a silhouette). Representation 1208 is an abstract representation of the weather context of environment 1220 of box B in FIG. 12D. In particular, representation 1208 represents rain drops representing the current weather of environment 1220 (e.g., where it is currently raining). In FIG. 12D, light sources 1201 do not output a representation of general activity (e.g., such as person 1212 in environment 1210), as it is outputting based on a context of environment 1220. Unlike in FIG. 12C, at FIG. 12D light sources 1201 do not output a representation of the tree (in environment 1220). Light sources 1201 can output illumination representing context in many ways. As FIG. 12D illustrates, a representation of weather does not necessarily include objects in the environment (e.g., tree 1222). In some examples, light sources 1201 output an abstract representation of tree 1222 as part of or in addition to representation 1208 of rain. For example, the scene illustrated in FIG. 12D can additionally include representation 1206 from FIG. 12C, and represent a later time within environment 1220 (e.g., in FIG. 12C the conditions were windy, and in FIG. 12D the conditions changed to rainy). In some examples, representations of context change over time. For example, as described above, the weather can change, the general activity can change, and/or the color of light can change.

FIG. 13 is a flow diagram illustrating a method (e.g., method 1300) for providing context in accordance with some examples. Some operations in method 1300 are, optionally, combined, the orders of some operations are, optionally, changed, and some operations are, optionally, omitted.

As described below, method 1300 provides an intuitive way for providing context. Method 1300 reduces the cognitive burden on a user for providing context, thereby creating a more efficient human-machine interface. For battery-operated computing devices, enabling a user to provide context faster and more efficiently conserves power and increases the time between battery charges.

In some examples, method 1300 is performed at a computer system (e.g., 100, 300, and/or 500) that is in communication with a light source (e.g., an illumination device, a point light source, a spotlight, and/or one or more light sources) (e.g., 1201, 1201A, 1201B, 1201C, and/or 1201D). In some examples, the computer system is a phone, a watch, a tablet, a fitness tracking device, a wearable device, an accessory, a speaker, a light, a head-mounted display (HMD), and/or a personal computing device. In some examples, the light source is not physically connected to and/or coupled to the computer system. In some examples, the computer system is in communication with one or more cameras. In some examples, the one or more cameras are not physically connected to the light source.

At 1302, the computer system detects a request to illuminate a region (e.g., as described above in relation to method 700) (e.g., 1202) of a first physical space (e.g., a physical environment, an at least partially enclosed area, a room, an office, and/or a building) (e.g., 1200). In some examples, detecting the request includes detecting input (e.g., a tap gesture, a long press gesture, a verbal request and/or command, a physical button press, a pointing gesture and/or air gesture, and/or a rotation of a physical input mechanism) corresponding to the request. In some examples, detecting the request includes receiving a message from a different computer system, the message indicating that the request was received by the different computer system. In some examples, detecting the request is irrespective of input. In some examples, detecting the request includes detecting an event has occurred in the first physical space and/or the second physical space.

At 1304, in response to detecting the request to illuminate the region of the first physical space and in accordance with a determination that a second physical space (e.g., 1210 and/or 1220) has a first context (e.g., a context that includes one or more illumination properties and/or light properties, such as the color, brightness, intensity, warmth, and/or tone of light and/or illumination of a physical space), the computer system illuminates, via the light source, the region of the first physical space to include (e.g., and/or such that the region of the first physical space includes) a first abstract representation (e.g., 1204A, 1204B, 1204C, 1206, and/or 1208) corresponding to the first context of the second physical space (e.g., a representation that includes one or more lighting properties (e.g., colors, tones, brightness levels, and/or intensity levels) that correspond to and/or that match the first context of the second physical space and/or the second physical space at an instance of time) (e.g., without including an abstract representation corresponding to a second context (e.g., described below) of the second physical space), wherein the second physical space is outside of (e.g., different from, separate from, on opposite sides of a surface, and/or at a different location in a physical environment) the first physical space (and, in some examples, the first physical space is not included within the second physical space). In some examples, the first abstract representation corresponding to the first context includes representations of one or more objects (e.g., 1212, 1214, and/or 1220) detected in the second physical space. In some examples, the first abstract representation corresponding to the first context includes one or more objects not detected in the second physical space. In some examples, the first abstract representation corresponding to the first context indicates user activity in the second physical space. In some examples, the first abstract representation is generated from one or more images of the second physical space such that the first abstract representation is different from the one or more images. In some examples, the first abstract representation indicates activity occurring in the second physical space without displaying one or more images of the second physical space. In some examples, the first abstract representation includes a blurred version of an object included in an image of the second physical space. In some examples, the first abstract representation uses shadows to represent objects in the second physical space. In some examples, the first abstract representation is different from a camera feed of the second physical space.

At 1306, in response to detecting the request to illuminate the region of the first physical space and in accordance with a determination that the second physical space has a second context different from the first context, the computer system illuminates, via the light source, the region of the first physical space to include (e.g., and/or such that the region of the first physical space includes) a second abstract representation (e.g., 1204A, 1204B, 1204C, 1206, and/or 1208) corresponding to the second context of the second physical space that is different from the first abstract representation corresponding to the first context of the second physical space (e.g., a representation that includes one or more lighting properties (e.g., colors, tones, brightness levels, and/or intensity levels) that correspond to and/or that match the first context of the second physical space and/or the second physical space at an instance of time) (e.g., without including the abstract representation corresponding to the first context of the second physical space). In some examples, the second abstract representation corresponding to the second context includes representations of one or more objects detected in the second physical space. In some examples, the second abstract representation corresponding to the second context includes one or more objects not detected in the second physical space (e.g., as described above with respect to FIG. 12B). In some examples, the second abstract representation corresponding to the second context indicates user activity in the second physical space (e.g., as described above with respect to FIGS. 12A-12B). In some examples, illuminating the first region includes activating the light source. In some examples, illuminating the first region includes changing light output by the light source. In some examples, illuminating the first region includes sending a request to the light source to modify light being output by the light source. In some examples, the second abstract representation is generated from one or more images of the second physical space such that the second abstract representation is different from the one or more images. In some examples, the second abstract representation indicates activity occurring in the second physical space without displaying one or more images of the second physical space. In some examples, the second abstract representation includes a blurred version (e.g., 1204A, 1204B, and/or 1206) of an object (e.g., 1212, 1214, and/or 1222) included in an image of the second physical space. In some examples, the second abstract representation uses shadows to represent objects in the second physical space. In some examples, the second abstract representation is different from a camera feed of the second physical space. Illuminating the region of the first physical space to include different abstract representations corresponding to a context of the second physical space allows for information to be known about the second physical space even though it is outside of the first physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, illuminating the region to include the first abstract representation includes illuminating a portion of the region to form a simulated silhouette (e.g., in the negative space of the region and/or a darker portion in comparison to other portions of the region) (e.g., 1204A, 1204B, and/or 1204C) representing a first person (e.g., 1212 and/or 1214) (e.g., in the shape of the person and/or in the shape of a representation of a person (such as a blob or other object)). In some examples, multiple simulated silhouettes are used to represent different people (e.g., as illustrated in FIG. 12A). In some examples, illuminating the portion of the region to form the simulated silhouette includes providing some light to part of the region that includes the simulated silhouette and more light to part of the region that does not include (e.g., outside of) the simulated silhouette. Illuminating a portion of the region to form the simulated silhouette representing the first person allows for a user to identify when people are in the second physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the simulated silhouette corresponds to (e.g., indicates and/or represents) a second person (e.g., 1212 and/or 1214) detected (e.g., via a sensor, such as a camera and/or a motion detector) in the second physical space. The simulated silhouette corresponding to the second person detected in the second physical space allows the user to identify when people are in the second physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the first person is not detected in the second physical space. In some examples, the first abstract representation indicates a general activity level (e.g., as described above with respect to FIG. 12B) in the second physical space, such as without including representations of objects in the second physical space. In some examples, the simulated silhouette corresponds to a general level of activity of the second person. The first person not being detected in the second physical space allows for the abstract representation to maintain anonymity of people in the second physical space, thereby improving privacy.

In some examples, illuminating the region to include the first abstract representation includes illuminating a portion of the region to form a simulated silhouette (e.g., 1206) (e.g., in the negative space of the region and/or a darker portion in comparison to other portions of the region) representing a tree (e.g., 1222) (e.g., in the shape of one or more trees and/or in the shape of a representation of one or more trees (such as a blob or other object)). In some examples, multiple simulated silhouettes are used to represent different trees. Illuminating a portion of the region to form the simulated silhouette representing the tree allows for a user to identify what is in the second physical space and its current state, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the illumination changes over time based on weather (e.g., amount and/or direction of wind and/or the sun) in the second physical space. In some examples, in accordance with a determination that the current weather is in a first state, the illumination changes in a first manner (e.g., as illustrated in FIG. 12C or 12D); and in accordance with a determination that the current weather is in a second state that is different from the first state, the illumination changes in a second manner (e.g., as illustrated in FIG. 12C or 12D) that is different from the first manner. The illumination changing over time based on weather allows for a user to identify what is in the second physical space and its current state, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the first abstract representation (and/or the second abstract representation) indicates a time of day (e.g., a time of day at the first physical space or a time of day at the second physical space) (e.g., morning, evening, afternoon, night, and/or 7 AM-8 AM). In some examples, the first abstract representation includes light to represent a current location of the sun. In some examples, the first abstract representation includes a color to represent the time of day. The first abstract representation indicating the time of day allows for a user to identify the time of day, thereby providing improved visual feedback to the user, reducing the number of inputs needed to perform an operation, providing additional control options without cluttering the user interface with additional displayed controls, and performing an operation when a set of conditions has been met without requiring further user input.

In some examples, a color characteristic (e.g., color temperature, hue, intensity, and/or color saturation) of the first abstract representation (and/or the second abstract representation) is based on the time (e.g., a current and/or present time) of day (e.g., of the first physical space and/or the second physical space). In some examples, in accordance with a determination that the time of day is a first time of day, the color characteristic is a first color characteristic; and in accordance with a determination that the time of day is a second time of day different from the first time of day, the color characteristic is a second color characteristic different from the first color characteristic. Having the color characteristic of the first abstract representation based on the time of day allows for a user to identify the time of day, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the first abstract representation (and/or the second abstract representation) indicates weather (e.g., wind, rain, snow, tornados, hurricanes, sun, and/or clouds) (e.g., 1208) of the second physical space. The abstract representation indicating weather of the second physical space allows for a user to identify a current state of the second physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, while illuminating the region of the first physical space to include the first abstract representation corresponding to the first context of the second physical space, the computer system detects that a context of the second physical space has changed from the first context to a third context different from the first context (and/or the second context). In some examples, in response to detecting that the context of the second physical space has changed to the third context, the computer system illuminates, via the light source, the region of the first physical space to include a third abstract representation (e.g., 1204C and/or 1208) corresponding to the third context of the second physical space, wherein the third abstract representation is different from the first abstract representation (and/or the second abstract representation). After illuminating the first abstract representation, illuminating the region of the first physical space to include the third abstract representation corresponding to the third context of the second physical space allows for a user to identify changes in context through the illumination, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the third abstract representation includes a representation of a current location (and/or position) of the sun (e.g., in the first physical space and/or the second physical space). In some examples, the third abstract representation includes a representation of a sunrise or sunset. The third abstract representation including the representation of the current location of the sun allows for a user to identify a current state of a physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the first abstract representation includes a first indication (e.g., 1206 and/or 1208) of weather of the second physical space. In some examples, the third abstract representation includes a second indication of the weather of the second physical space. In some examples, the second indication is different from (e.g., visually different from and/or includes one or more representations not included in) the first indication. In some examples, the second indication represents a change in the weather of the second physical space. Including the second indication that represents the change in the weather of the second physical space allows for a user to identify changes in the weather of the second physical space through the illumination, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the first abstract representation (and/or the second abstract representation) changes over a period of time (e.g., is animated) (e.g., as illustrated in FIG. 12B and/or 12D). Automatically, without user input, changing the first abstract representation over the period of time allows for the user to identify time passing, thereby providing improved visual feedback to the user, reducing the number of inputs needed to perform an operation, providing additional control options without cluttering the user interface with additional displayed controls, and performing an operation when a set of conditions has been met without requiring further user input.

In some examples, in accordance with a determination that an object (e.g., a physical object, a tree, and/or people) (e.g., 1212, 1214, and/or 1222) in the second physical space is a first size, the first abstract representation is a second size (e.g., 1204A, 1204B, 1204C, and/or 1206). In some examples, in accordance with a determination that the object in the second physical space is a third size that is different from the first size, the first abstract representation is a fourth size that is different from the second size. In some examples, the first size is different from the second size and/or the third size. In some examples, the fourth size is different from the first size and/or the third size. In some examples, the first abstract representation is the same size as the physical object in the second physical space. In some examples, the first abstract representation is a different size than the physical object in the second physical space. In some examples, the size of the first abstract representation is relative to (e.g., correlates to) the size of the physical object. The first abstract representation being a different size based on a size of the object in the second physical space allows for a user to identify what is in the second physical space while in the first physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, in accordance with a determination that a user has selected a first setting (e.g., the first setting represents an amount of detail that the user wants in abstract representations of the second physical space), the first abstract representation includes a first detail (e.g., an object and/or a portion of the object) of the second physical space. In some examples, in accordance with a determination that the user has selected a second setting (e.g., the second setting represents an amount of detail that the user wants in abstract representations of the second physical space) different from the first setting, the first abstract representation does not include the first detail of the second physical space. The first abstract representation conditionally including the detail in accordance with a determination that the user has selected a respective setting allows for the user to control the information provided by the first abstract representation, thereby providing improved visual feedback to the user, reducing the number of inputs needed to perform an operation, providing additional control options without cluttering the user interface with additional displayed controls, and performing an operation when a set of conditions has been met without requiring further user input.

In some examples, after (and/or while) illuminating the region of the physical space to include an abstract representation corresponding to the second physical space, the computer system detects a request to change the abstract representation to correspond to a third physical space (e.g., 1210 and/or 1220) different from the second physical space. In some examples, in response to detecting the request to change the abstract representation to correspond to the third physical space, the computer system illuminates, via the light source, the region of the first physical space to include a fourth abstract representation corresponding to a context of the third physical space, wherein the third physical space is outside of (e.g., does not encompass, does not include, and/or is not within) the first physical space and the second physical space (e.g., as illustrated between FIGS. 12B and 12C). In some examples, the third physical space and/or the second physical space is in another state, country, city, geographic region, building, and/or physical structure than the first physical space. Changing the abstract representation to correspond to the third physical space in response to the request allows for the user to control the information provided by the first abstract representation, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the region of the first physical space is gradually illuminated (e.g., the brightness of the first physical space gradually increases and/or the fourth abstract representation gradually fills out) over a period of time (e.g., 2-60 seconds) to include the fourth abstract representation (e.g., 1204A, 1204B, 1206, and/or 1208) corresponding to the context of the third physical space (e.g., 1210 and/or 1210). In some examples, the first physical space is gradually illuminated to include the fourth abstract representation over a period of time that is chosen by one or more users. In some examples, the first physical space is gradually illuminated to include the fourth abstract representation over a predetermined period of time that is not chosen by one or more users. The region of the first physical space being gradually illuminated over the period of time to include the fourth abstract representation in response to detecting the request to change the abstract representation allows the computer system to not abruptly make such illumination changes but instead case a user into the changes, thereby providing improved visual feedback to the user and performing an operation when a set of conditions has been met without requiring further user input.

In some examples, in accordance with a determination that the third physical space (e.g., 1210 and/or 1210) (e.g., corresponds to the first physical space (e.g., 1210 and/or 1210) (e.g., the third physical space is a portion of the first physical space or the third physical space is the first physical space), the region of the first physical space is illuminated at a first rate and in accordance with a determination that the third physical space does not correspond to the first physical space (e.g., the third physical space is different and/or distinct from the first physical space), the region of the first physical space is illuminated at a second rate, wherein the first rate is faster (e.g., 1.5×, 2×, 2.5×, or 3× faster) than the second rate. Illuminating the region of the first physical space at a respective rate when prescribed conditions are satisfied automatically allows the computer system to indicate to the user whether the region of the first space is being illuminated based on one or more characteristics of the first space or one or more characteristics of a different space, thereby providing improved visual feedback to the user and performing an operation when a set of conditions has been met without requiring further user input. Illuminating the region of the first physical space at a faster rate when illuminating to correspond to the first physical space rather than another physical space allows the computer system to case a user into illumination corresponding to different physical spaces while more abruptly illuminating to correspond to a current physical space, thereby providing improved visual feedback to the user and performing an operation when a set of conditions has been met without requiring further user input.

In some examples, the first abstract representation (e.g., 1204A, 1204B, 1206, and/or 1208) includes a representation (e.g., a textual and/or graphical representation) of a celestial object (e.g., a sun, a moon, a black hole, and/or a star). In some examples, in accordance with a determination that the celestial object is at a first position relative to (e.g., within, at a location that includes, and/or inside) the second physical space (e.g., a position within the sky relative to the second physical space (e.g., the sun setting or the sun rising), the representation of the celestial object is positioned at a first location within the first abstract representation (e.g., as described above in relation to FIG. 12C) (e.g., the first location has a direct correlation or an indirect correlation with the first position) (e.g., the representation of the celestial object is in a location within the first abstract representation that corresponds to a current location of the celestial object with respect to the second physical space or the representation of the celestial object is in a location within the first abstract representation that corresponds to a different location than the current location of the celestial object with respect to the second physical space) in accordance with a determination that the celestial object is at a second position relative to the second physical space, the representation of the celestial object is positioned at a second location within the first abstract representation (e.g., the second location has a direct correlation or an indirect correlation with the second position), wherein the second location is different from the first location, and wherein the first position is different from the second position (e.g., as described above in relation to FIG. 12C). In some examples, the representation of the celestial object moves from the first location to the second location based on a determination that the celestial object moves from the first position to the second position. In some examples, the representation of the celestial object ceases to be included in the first abstract representation based on a time of day of the second physical space (e.g., if the celestial object is a sun, the representation of the celestial object is not included in the first abstract representation when it is nighttime at the second physical space or if the celestial object is a moon, the representation of the celestial object is not included in the first abstract representation when it is midday at the second physical space). Positioning the representation of the celestial object at a specific location within the first abstract representation when prescribed conditions are satisfied automatically allows the computer system to indicate to a user the positioning of the celestial object relative to the second physical space, thereby providing improved visual feedback to the user and performing an operation when a set of conditions has been met without requiring further user input.

In some examples, while the representation of the celestial object is positioned at the first location within the first abstract representation (e.g., 1204A, 1204B, 1206, and/or 1208), the computer system detects a passage of time (e.g., passage of minutes, hours, days, months, and/or years). In some examples, in response to detecting the passage of time and without detecting a respective user input (e.g., a voice command, a hand air gesture, and/or a tactile input), the computer system moves the representation of the celestial object from the first location within the first abstract representation to a third location (e.g., as described above in relation to FIG. 12C) (e.g., the third location is different from the first and second location) within the first abstract representation. In some examples, the distance between the first position within the first abstract representation and the second position within the first abstract representation corresponds and/or proportional to the amount of time that has passed. In some examples, the distance between the first position within the first abstract representation and the second position within the first abstract representation corresponds and/or proportional to an amount that the celestial object has moved relative to the second physical space. In some examples, the representation of the celestial object ceases to be included in the first abstract representation while the representation of the celestial object is moved from the first location to the third location. In some examples, the representation of the celestial object ceases remains included in the first abstract representation while the representation of the celestial object is moved from the first location to the third location. Moving the representation of the celestial object from the first location within the first abstract representation from the first location to a third location in response to detecting the passage of time allows the computer system to indicate an amount of time that has passed since the representation of the celestial object was positioned at the first location, thereby providing improved visual feedback and providing additional control options without cluttering the user interface with additional displayed control.

In some examples, illuminating the region of the first physical space (e.g., 1200, 1210, and/or 1220) to include the first abstract representation (e.g., 1204A, 1204B, 1206, and/or 1208) includes illuminating a third portion of the region to form a set of one or more silhouettes (e.g., in the negative space of the region and/or a darker portion in comparison to other portions of the region) representing a first set of one or more objects (e.g., inanimate objects within the first physical space and/or animate objects within the first physical space) (e.g., in the shape of the first set of one or more objects and/or in the shape of a representation of the first set of one or more objects (such as a blob or other object)) (e.g., the celestial object), wherein the first set of one or more objects is positioned within (and/or relative to) the first physical space (e.g., and not the second physical space) (e.g., as described above in relation to FIG. 12A). In some examples, the first set of one or more silhouettes representing the first set of one or more objects move based on movements of the first set of one or more objects within the first physical space. In some examples, the first set of one or more silhouettes ceases to be included in the first abstract representation based on a determination that the first set of one or more objects is no longer positioned within the first physical space. Illuminating a third portion of the region to form a set of one or more silhouettes representing a first set of one or more objects that are positioned within the first physical space allows for the computer system to indicate what objects are in the first physical space and its current state, thereby providing improved visual feedback to the user, reducing the number of inputs needed to perform an operation, providing additional control options without cluttering the user interface with additional displayed controls, and performing an operation when a set of conditions has been met without requiring further user input.

In some examples, illuminating the region of the first physical space (e.g., 1200, 1210, and/or 1220) to include the first abstract representation (e.g., 1204A, 1204B, 1206, and/or 1208) includes illuminating a fourth portion of the region to form a simulated silhouette (e.g., in the negative space of the region and/or a darker portion in comparison to other portions of the region) representing a second set of one or more objects (e.g., inanimate objects within the second physical space and/or animate objects within the second physical space) (e.g., in the shape of the second set of one or more objects and/or in the shape of a representation of the second set of one or more objects (such as a blob or other object)) (e.g., the celestial object), wherein the second set of one or more objects is positioned within (and/or relative to) the second physical space (e.g., and not the first physical space) (e.g., as described above in relation to FIG. 12A). In some examples, the set of one or more silhouettes representing the first set of one or more objects move based on movements of the first set of one or more objects within the first physical space. In some examples, the set of one or more silhouettes ceases to be included in the first abstract representation based on a determination that the firsts et of one or more objects is removed from the first physical space. Illuminating a fourth portion of the region to form a simulated silhouette representing a second set of one or more objects that is positioned within the second physical space allows for the computer system to indicate what objects are in the second physical space and its current state, thereby providing improved visual feedback to the user, reducing the number of inputs needed to perform an operation, providing additional control options without cluttering the user interface with additional displayed controls, and performing an operation when a set of conditions has been met without requiring further user input.

In some examples, the computer system is a first computer system. In some examples, before detecting the request to illuminate the region of the first physical space (e.g., 1200, 1210, and/or 1220), the computer system receives, from a second computer system (e.g., a phone, a watch, a tablet, a fitness tracking device, a wearable device, an accessory, a speaker, a light, a head-mounted display (HMD), and/or a personal computing device of another user) different from the first computer system, a request to establish a communication (e.g., a telephone call, a video conference, and/or electronic mail) between the first computer system and the second computer system, wherein the request to illuminate the region of the first physical space is associated with (and/or corresponds to and/or is in conjunction with) the communication (e.g., as described above in relation to FIG. 12A) (e.g., the first request to establish the communication includes the request to illuminate the region of the first physical space) (e.g., the request to illuminate the region of the first physical space is detected after receiving the first request to establish the communication) (e.g., the request to illuminate the region of the first physical space is detected while establishing the communication) (e.g., the request to illuminate the region of the first physical space is detected while the communication is established). In some examples, receiving the first request to establish the communication interrupts illumination of the region of the first physical space (e.g., the illumination of a region of the first physical space ceases, the illumination of a region of the first physical space is accelerated or the illumination of a region of the first physical space occurs at a slower rate than if the first request to establish the communication was not received. The request to illuminate the region of the first physical space being associated with a communication from the second computer system allows the first computer system to indicate to a user using illumination that a request for the communication has been received and/or that the communication is on-going, thereby providing improved visual feedback to the user and performing an operation when a set of conditions has been met without requiring further user input.

In some examples, the second physical space (e.g., 1200, 1210, and/or 1220) corresponds to the communication with the second computer system (e.g., as described above at FIG. 12A) (e.g., the request to establish the communication originates from the second physical space, the request to establish the communication originates from a person and/or a device who is located at the second physical space, and/or the second computer system is located in and/or at the second physical space). The second physical space corresponding to the communication with the second computer system allows the first computer system to illuminate based on a state corresponding to the second computer system (e.g., as if the first computer system is at a location of the second computer system) so that a user can receive additional information regarding the second computer system, thereby providing improved visual feedback to the user and performing an operation when a set of conditions has been met without requiring further user input.

In some examples, the communication includes a first user and a second user different from the first user, and wherein the second physical space (e.g., 1200, 1202, and/or 1204) is selected by the first user or the second user (e.g., in conjunction with the communication) (e.g., as described above in relation to FIG. 12A). In some examples, before detecting the request to illuminate the region of the first physical space, the computer system detects an input (e.g., a user input, a tap input, a swipe input, voice command, and/or a hand gesture) that corresponds to selection of the second physical space. In some examples, in response to detecting the input that corresponds to selection of the second physical space and in accordance with a determination that selection of the second physical space corresponds to a first physical environment (e.g., a city, state, country, outdoor area, and/or interior area), the second physical space corresponds to the first physical environment (e.g., the second physical space is the first physical environment and/or the first physical environment is assigned to the second physical space). In some examples, in response to detecting the input that corresponds to selection of the second physical space and in accordance with a determination that the selection of the second physical space corresponds to a second physical environment (e.g., a city, state, country, outdoor area, and/or interior area), the second physical space corresponds to the second physical environment (e.g., the second physical space is the second physical environment and/or the second physical environment is assigned to the second physical space), wherein the second physical environment is different from the first physical environment. In some examples, the second physical space is preselected before sending and/or receiving the first request to establish the communication.

In some examples, the computer system is a third computer system, wherein the third computer system is in communication (e.g., wired communication and/or wireless communication) with a display generation component (e.g., a monitor, a television, a desktop computer, and/or laptop). In some examples, before detecting the request to illuminate the region of the first physical space, the computer system receives, from a fourth computer system (e.g., a smartphone, a tablet, laptop, television, and/or desktop computer) different from (e.g., separate and/or external to) the third computer system, a second request to establish a communication (e.g., a telephone call, a video conference call, and/or electronic mail) between the third computer system and the fourth computer system. In some examples, after (and/or in response to) receiving the second request (e.g., or while receiving the second request), the computer system displays, via the display generation component, a user interface element, wherein the request to illuminate the region of the first physical space corresponds to a selection of the user interface element (e.g., the user interface element is displayed while the request to illuminate the region of the first physical space is detected and/or selection of the user interface element is the request to illuminate the region of the first physical space) (e.g., as described above in relation to FIG. 12A). In some examples, the user interface element ceases to be displayed when a determination is made that the second request is accepted or declined. In some examples, the user interface element ceases to be displayed in response to detecting the request to illuminate the region of the first physical space. In some examples, the second request corresponds to the second physical space (e.g., the second request originates from the second physical space, the second request is made by a person and/or a device at the second physical space, and/or the fourth computer system is located in and/or at the second physical space. Displaying a user interface element in response to receiving the request to establish communication between two respective computer systems allows the computer system to visually alert a user that the computer system is receiving and/or has received a communication (e.g., phone call and/or video call) request, thereby providing improved visual feedback to the user and providing additional control options without cluttering the user interface with additional displayed controls.

In some examples, after (and/or in response to) receiving the second request and before establishing the communication between the third computer system and the fourth computer system, the computer system displays, via the display generation component, a preview (e.g., a representation (e.g., a graphical and/or textual representation) of a user of the computer system and/or a representation (e.g., a graphical and/or textual representation) of an individual that made the second communication request) of the communication between the third computer system and the fourth computer system, wherein the preview is displayed while the user interface element is displayed (e.g., as described above in relation to FIG. 12A). In some examples, the user interface element is displayed as overlaid on top of the preview of the communication. In some examples, the user interface element is not displayed as overlaid on top of the preview of the communication. In some examples, the preview includes the user interface element. ISE, the preview does not include the user interface element. Displaying the user interface element before establishing the communication between the third computer system and the fourth computer system allows the computer system to alert the user that a communication request is pending, thereby providing improved visual feedback to the user and providing additional control options without cluttering the user interface with additional displayed controls.

In some examples, the user interface element is displayed (e.g., initially displayed) after establishing the communication between the third computer system and the fourth computer system (and/or while the communication between the third computer system and the fourth computer system is established) (e.g., as described above in relation to FIG. 12A). In some examples, while displaying the preview, the computer system detects an input (e.g., a tap input, a swipe input, a voice command, depression of a button and/or a hand air gesture) to establish the communication between the third computer system and the fourth computer system (e.g., accept the second request). In some examples, in response to detecting the input to establish the communication between the third computer system and the fourth computer system, the third computer system displays, via the display generation component, a representation (e.g., a live video of the environment that corresponds to the computer system and a live video of the environment that corresponds to the external computer system and/or a still photo representative of a user of the computer system and a still photo representative of a user of the external computer system) of the communication between the third computer system and the fourth computer system. In some examples, the representation of the communication between the third computer system and the fourth computer system is displayed while the user interface element is displayed. In some examples, in response to detecting the input to establish the communication between the third computer system and the fourth computer system, the user interface element is displayed. In some examples, the user interface element is displayed as overlaid on top of the representation of the communication. In some examples, the user interface element is not displayed as overlaid on top of the representation of the communication. Displaying the user interface element after establishing the communication between the third computer system and the fourth computer system allows the computer system to alert the user that the communication request has been accepted and/or is on-going, thereby providing improved visual feedback to the user and providing additional control options without cluttering the user interface with additional displayed controls.

In some examples, in response to detecting the request to illuminate the region of the first physical space (e.g., 1200, 1210, and/or 1220) and while illuminating, via the light source (e.g., 1201), the region of the first physical space to include the first abstract representation (e.g., 1204A, 1204B, 1206, and/or 1208), the computer system illuminates, via the light source, the region of the first physical space to include a fifth abstract representation (e.g., 1204A, 1204B, 1206, and/or 1208) corresponding to a fourth physical space (e.g., 1200, 1210, and/or 1220) (e.g., a representation that includes one or more lighting properties (e.g., colors, tones, brightness levels, and/or intensity levels) that correspond to and/or that match the fourth physical space and/or the fourth physical space at an instance of time), wherein the fourth physical space is different (e.g., and/or distinct) from the second physical space. In some examples, the fourth physical space is outside of the first physical space. In some examples, the fourth physical space is within the first physical space. In some examples, abstract representation corresponding to the fourth physical space does not overlap with the first abstract representation. In some examples, the fifth abstract representation overlaps with the abstract representation corresponding to a context of the second physical space. In some examples, the fifth abstract representation does not overlap with the abstract representation corresponding to a context of the second physical space. In some examples, the appearance of the fifth abstract representation is different or the same as the abstract representation corresponding to a context of the second physical space. Illuminating the region of the first physical space to include the fifth abstract representation corresponding to a fourth physical space while illuminating the region of the first physical space to include the first abstract representation allows for information to be known about multiple different physical spaces (e.g., the second physical space and the fourth physical space) even though the different physical spaces are outside of the first physical space, thereby providing improved visual feedback to the user, reducing the number of inputs needed to perform an operation, providing additional control options without cluttering the user interface with additional displayed controls, and performing an operation when a set of conditions has been met without requiring further user input.

In some examples, in conjunction with detecting the request to illuminate the region of the first physical space (e.g., 1202, 1210, and/or 1220), the computer system detects an input corresponding to a respective time indication (e.g., time and/or date) (e.g., current time, previous time, and/or future time). In some embodiments, in response to detecting the request to illuminate the region of the first physical space and in accordance with a determination that the respective time indication is a first time indication, the computer system illuminates, via the light source (e.g., 1201), the region of the first physical space to include (e.g., and/or such that the region of the first physical space includes) a sixth abstract representation (e.g., 1202, 1210, and/or 1220) corresponding to the first time indication and in accordance with a determination that the respective time indication is a second time indication different from the first time indication, the computer system illuminates, via the light source, the region of the first physical space to include (e.g., and/or such that the region of the first physical space includes) a seventh abstract representation (e.g., 1202, 1210, and/or 1220) corresponding to the second time indication, wherein the seventh abstract representation is different from the sixth abstract representation. In some examples, the sixth and/or seventh abstract representation is temporarily provided. In some examples, the sixth and/or seventh abstract representation is persistent. In some examples, the sixth and/or seventh abstract representation obstructs view of the first and/or second abstract representation. In some examples, the sixth and/or seventh abstract representation does not obstruct the view of the first and/or second abstract representation. In some examples, the light source illuminates the region of the first physical space to include the respective abstract representation that corresponds to the respective time indication while the light source illuminates the region of the first physical space to include the respective abstract representation corresponding to the second physical space. In some examples, the sixth and seventh abstract representations correspond are representations that correspond to a respective time of day (e.g., morning, afternoon, or evening) and/or day (e.g., a holiday, the first day of the week, or the last day of the week). In some examples, the sixth and seventh abstract representations correspond to a context of the first physical space and/or the second physical space (e.g., the sixty and/or seventh abstract representations corresponds to precipitation if it is snowing and/or raining at the first physical space and/or the second physical space and/or the sixth and/or seventh abstract representation corresponds to soundwaves with high peaks and low valleys if it is noisy at the first physical space and/or the second physical space). Illuminating the region of the first physical space differently depending on what time is specified by an input allows a user to control illumination using time and location, thereby providing improved visual feedback and performing an operation when a set of conditions has been met without requiring further user input.

In some examples, in conjunction with detecting the request to illuminate the region of the first physical space (e.g., 1202, 1210, and/or 1220), the computer system detects an input corresponding to a respective event (e.g., sunrise, sunset, and/or weather event (e.g., thunderstorm, tornado, and/or hurricane)). In some examples, in response to detecting the input corresponding to the respective event and in accordance with a determination that the respective event is a first event, the computer system illuminates, via the light source (1202), the region of the first physical space to include (e.g., and/or such that the region of the first physical space includes) an eight abstract representation (e.g., 1204A, 1204B, 1204C, and/or 1206) corresponding to the first event and in accordance with a determination that the respective event is a second event different from the first event, the computer system illuminates, via the light source (e.g., 1201), the region of the first physical space to include (e.g., and/or such that the region of the first physical space includes) a ninth abstract representation (e.g., 1204A, 1204B, 1204C, and/or 1206) corresponding to the second event, wherein the eighth abstract representation is different from the ninth abstract representation. In some examples, the seventh and/or eighth abstract representation is temporarily provided. In some examples, the seventh and/or eighth abstract representation is persistent. In some examples, the seventh and/or eighth abstract representation obstructs view of the first and/or second abstract representation. In some examples, the seventh and/or eighth abstract representation does not obstruct the view of the first and/or second abstract representation. In some examples, the light source illuminates the region of the first physical space to include the respective abstract representation that corresponds to the respective event while the light source illuminates the region of the first physical space to include the respective abstract representation corresponding to the second physical space. In some examples, the eighth and ninth abstract representations are representations that correspond to a respective event (e.g., sunrise, sunset, solar eclipse) and/or at the first or second physical space. In some examples, the eighth and ninth abstract representations correspond to a context of the first physical space and/or the second physical space (e.g., the eighth and ninth abstract representations correspond to an event that has occurred, is occurring, and/or will occur at the first physical space and/or the second physical space. Illuminating the region of the first physical space differently depending on what event is specified by an input allows a user to control illumination using different events rather than requiring a specific time for the illumination to be based on, thereby providing improved visual feedback and performing an operation when a set of conditions has been met without requiring further user input.

In some examples, illuminating the region of the first physical space to include the first abstract representation (e.g., 1204A, 1204B, 1204C, and/or 1206) includes progressing through various visual states of the first abstract representation. In some examples, (e.g., before and/or while illuminating, via the light source, the region of the first physical space to include the first abstract representation) the computer system detects a selection of a setting (e.g., a brightness setting, a tone setting, a rate of illumination setting, and/or duration setting) that corresponds to illuminating, via the light source (e.g., 1201), the region of the first physical space to include the first abstract representation. In some examples, in response to detecting the selection of the setting and in accordance with a determination that the selection of the setting corresponds to a first setting, the illumination of the region of the first physical space to include the first abstract representation progresses through the various visual states of the first abstract representation at a first rate (e.g., 0.5×, 1×, 2×, 3×, 5×, or 10× of real time speed) and in accordance with a determination that the selection of the setting corresponds to a second setting that is different from the first setting, the illumination of the region of the first physical space to include the first abstract representation progresses through the various visual states of the first abstract representation at a second rate (e.g., 0.5×, 1×, 2×, 3×, 5×, or 10× of real time speed) that is different from the first rate (e.g., the first rate is faster or slower than the second rate) (e.g., as described above in relation to FIG. 12C). In some examples, the illumination of the region transitions from progressing through the various states of the first representation from the first rate to the second rate in response to detecting that a respective setting is elected. In some examples, the first abstract representation does not include various states. Progressing through the various visual states of the first abstract representation at a respective rate based on which setting is selected allows the user to control how fast or are slow the computer system progresses through the various visual states, thereby and performing an operation when a set of conditions has been met without requiring further user input.

In some examples, while illuminating, via the light source (e.g., 1201), the region of the first physical space (e.g., 1202, 1210, and/or 1220) corresponding to the first context of the second physical space e.g., 1202, 1210, and/or 1220), the computer systems detects a notification (e.g., a notification that is generated by an operating system of the computer system, and/or a notification that is generated by a native application and/or a third-party application that is installed on the computer system). In some examples, in response to detecting the notification, the computer system modifies the illumination of the region of the first physical space (e.g., increasing a brightness of the light source, decreasing a brightness of the light source, changing a primary and/or secondary color of the light source, pulsating the light source) (e.g., as discussed above at FIG. 12A). In some examples, the light source is powered off in response to detecting the notification. In some examples, the illumination of the region of the first physical space is not modified in response to detecting the notification. In some examples, the illumination of the region of the first physical space is modified while the notification is detected and is ceases to be modified when the notification is no longer detected. Modifying the illumination of the region of the first physical space in response to detecting the notification allows the computer system to alert the user with respect to the state of the compute system (e.g., that the computer system has detected and/or received a notification), thereby providing improved visual feedback and providing additional control options without cluttering the user interface with additional displayed controls.

Note that details of the processes described above with respect to method 1300 (e.g., FIG. 13) are also applicable in an analogous manner to other methods described herein. For example, method 1500 optionally includes one or more of the characteristics of the various methods described above with reference to method 1300. For example, the light source of method 1300 can be the light source of method 1500. For brevity, these details are not repeated below.

FIGS. 14A-14D illustrate exemplary techniques for extending content onto a physical space in accordance with some examples. The techniques in these figures are used to illustrate the processes described below, including the one or more processes described in relation to FIG. 15.

FIG. 14A illustrates physical space 1400, a room with light sources 1401 and display device 1410 (e.g., a television). In some examples, light sources 1401 include one or more features as described herein with respect to any one or more light sources described with respect to FIGS. 6, 8, 10, and/or 12. In some examples, light sources 1401 output an extension of content onto a portion of physical space 1400 surrounding a device (e.g., display device 1410) outputting the content. For example, in FIG. 14A, display device 1410 displays content 1412 (e.g., a star shape, a triangle shape, and/or some other shape that is based on content displayed on display device 1410). As also illustrated in FIG. 14A, light sources 1401 output illumination to create content extension 1414. Content extension 1414 is a pattern of light that is generated based on content 1412 and output into physical space 1400, both behind display device 1410 (e.g., on wall 1402) and in front of display device 1410 (e.g., on floor 1404). Light sources 1401 do not output content extension 1414 onto the display output of display device 1410. For example, light sources 1401 do not output the illumination forming content extension 1414 onto the region defined by screen of display device 1410, which can avoid interfering with display of content 1412.

As illustrated in FIG. 14A, the shape of content extension 1414 is based on content 1412. For example, they are both star shaped. In some examples, a color, texture, size, and/or movement of content extension 1414 is based on content 1412.

FIG. 14B illustrates content extension 1414 moving based on movement of content 1412. In response to a determination that content 1412 moves to the right on display device 1410, light sources 1401 move content extension 1414 to the right in physical space 1400. In some examples, the determination that content 1412 moves based on receiving (e.g., from another device) and/or determining (e.g., by light sources 1401) information representing movement of content 1412 on display device 1410. In some examples, information representing movement of content includes one or more of: location information, movement information, a media stream, a bitmap, or any other information usable to determine movement and/or current location of content.

In some examples, a content extension is different from the content upon which the extension is based (e.g., that is output by another device such as a television). For example, light sources 1401 can output illumination of a content extension that accompanies the output of content by display device 1410, but where the content extension is different than the content. Referring to FIGS. 14A and 14B, instead of displaying content extension 1414, which is a representation of content 1412 that is displayed by display device 1410, light sources 1401 can instead output illumination of one or more content extensions intended (e.g., configured) to accompany content 1412 (e.g., content extension is clouds that are not displayed on display device 1410).

In some examples, a content extension can appear to be an extension of content output by another device. For example, if display device 1410 displays a beam of light that reaches the edge of its display area, light sources 1401 can illuminate a content extension that makes the beam of light appear to extend continuously into physical space 1400. For example, if display device 1410 displays a ball bouncing out of the image displayed on its display area, light sources 1401 can illuminate a content extension that matches the ball (after disappearing from the display area of display device 1410) bouncing in physical space 1400.

In some examples, a content extension is synchronized to content output by another device. For example, content extension 1414 moves with content 1412. Such synchronization can occur even when content extension is different from the content. In the scenario presented above in which cloud shaped content extensions accompany content 1412, upon content 1412 moving to the right (e.g., as in FIG. 14B), the cloud content extensions could correspondingly change in appearance (e.g., move the left to appear stationary) or cease to be displayed.

FIG. 14C illustrates physical space 1400, a room with light sources 1401 and display device 1410 (e.g., a television). In FIG. 14C, display device 1410 displays content 1416A (a region of bright illumination) and content 1416B (a region of low illumination (e.g., is dark)). As also illustrated in FIG. 14C, light sources 1401 output illumination to create content extension 1418A (which illuminates a region of physical space 1400) and content extension 1418B (which illuminates a region of physical space 1400). As illustrated in FIG. 14C, content extension 1418A corresponds to content 1416A on display device 1410. Properties of content extension 1418A are based on content 1416A, including location, size, brightness, and/or movement. For example, light sources 1401 illuminate content extension 1418A to appear with the same color and/or shape as content 1416A. In FIG. 14C, content extension 1418A includes a straight bottom edge corresponding to where content 1416A is partial cut off by the bottom edge of display 1410. As illustrated in FIG. 14C, content extension 1418B corresponds to content 1416B on display device 1410. Properties of content extension 1418B are based on content 1416A, including location, size, brightness, and/or movement. For example, light sources 1401 illuminate content extension 1418B to appear with the same color and/or shape as content 1416B. In FIG. 14C, content extension 1418B is an area of darker illumination that surrounds an area of bright illumination and includes a straight bottom edge corresponding to where content 1416A is partial cut off by the bottom edge of display 1410 (e.g., extrapolate to fill in below the cutoff edge).

FIG. 14D illustrates illumination of physical space 1400 after movement of content 1416A and content 1416B of display device 1410. In response to receiving and/or determining information indicating that content 1416A and content 1416B have moved on the output of display device 1410, light sources 1401 change illumination so that content extension 1418A moves leftward and occupies a region on the left side of physical space 1400, and light sources 1401 change illumination so that content extension 1418B changes to occupy a region on the right side of physical space 1400. As illustrated in FIG. 14D, content extension 1418A and content extension 1418B together resemble the content (content 1416A and content 1416B) displayed by display device 1410. Providing one or more content extensions in this way can result in a highly immersive experience for a user (e.g., viewer of display device 1410).

In some examples, a content extension is based on a map of content that includes content that is not visible on another device. For example, as described above, light sources 1401 can output illumination of content extensions that are not displayed on display device 1410. Light sources 1401 can receive information regarding this non-displayed content from one or more sources, and/or determine such information through analysis (e.g., extrapolation) of the current content of display device 1410. For example, information regarding the non-displayed content can be received as a map (e.g., a three-dimensional map of a virtual world) that includes information regarding content and/or content extensions outside of what is currently displayed on display device 1410. For example, if display device 1410 displays content that is an output of a video game, light sources 1401 can receive information regarding the three-dimensional virtual world (e.g., of the video game level) as a map (e.g., that includes image and/or depth data) and display (in physical space 1400 surrounding display device 1410) an extension of the content that is outside of the viewport of the virtual world defined by the display of display device 1410. In some examples, content behind or near user is reduced in fidelity (e.g., desaturated, displayed with lower brightness relative to content displayed on display device 1410). For example, light sources 1401 output a representation of the virtual world on the walls of physical space 1400, including behind a user (e.g., sitting in front of display device 1410), such that the content extension displayed behind the user is of a reduced image quality and/or brightness (or otherwise altered). In some examples, light sources 1401 detect that a viewer moves their gaze toward an area of reduced image quality and/or brightness, and in response to this detection, increase the image quality and/or brightness of an area (e.g., region of physical space) based on the gaze of the viewer.

FIG. 15 is a flow diagram illustrating a method (e.g., method 1500) for extending content in accordance with some examples. Some operations in method 1500 are, optionally, combined, the orders of some operations are, optionally, changed, and some operations are, optionally, omitted.

As described below, method 1500 provides an intuitive way for extending content. Method 1500 reduces the cognitive burden on a user for extending content, thereby creating a more efficient human-machine interface. For battery-operated computing devices, enabling a user to extend content faster and more efficiently conserves power and increases the time between battery charges.

In some examples, method 1500 is performed at a computer system (e.g., 100, 300, and/or 500) that is in communication with a first device (e.g., a television, a phone, a watch, a tablet, a fitness tracking device, an accessory, and/or a personal computing device) (e.g., 1410) and a light source (e.g., 1401, 1401A, 1401B, 1401C, and/or 1401D) that is separate from (e.g., not included in and/or not physically connected to) the first device (e.g., a projector, an illumination device, a point light source, a spotlight, and/or one or more light sources). In some examples, the computer system is a phone, a watch, a tablet, a fitness tracking device, a wearable device, an accessory, a speaker, a light, a head-mounted display (HMD), and/or a personal computing device. In some examples, the light source is not physically connected to and/or coupled to the computer system. In some examples, the one or more cameras are not physically connected to the light source. In some examples, the first device is a television.

At 1502, the computer system receives a request to extend content being displayed on the first device to a physical space (e.g., 1400) (e.g., a physical environment, an at least partially enclosed area, a room, an office, and/or a building) that includes a first region (e.g., 1402 and/or 1404) (e.g., as described above in relation to method 700) and a second region (e.g., 1402 and/or 1404) (e.g., as described above in relation to method 700) different from the first region. In some examples, detecting the request includes detecting input (e.g., a tap gesture, a long press gesture, a verbal request and/or command, a physical button press, a pointing and/or air gesture, and/or a rotation of a physical input mechanism) corresponding to the request. In some examples, detecting the request includes receiving a message from a different computer system, the message indicating that the request was received by the different computer system. In some examples, detecting the request is irrespective of detecting input. In some examples, detecting the request includes detecting an event has occurred in the content.

At 1504, in response to receiving the request to extend content being displayed on the first device and while content (e.g., 1412, 1416A, and/or 1416B) is being displayed on the first device, in accordance with a determination that the first device is located at a first location in the physical space, the computer system illuminates (e.g., projecting light onto and/or directing light to), via the light source, the first region of the physical space that has a respective spatial arrangement relative to the first location in the physical space with a first light pattern (e.g., 1414, 1418A, and/or 1418B) that is based on content (e.g., movie content, video game content, and/or music video content) that is being displayed on the first device (e.g., projected light is constructed from copying and stretching content (e.g., extending content)) (e.g., projected light includes one or more characteristics (e.g., colors and/or shapes) of the content (e.g., but does not include copying the content)) without illuminating (e.g., without projecting light onto and/or directing light to), via the light source, the second region of the physical space with the first light pattern (e.g., as illustrated in FIGS. 14A, 14B, 14C, and/or 14D). In some examples, illuminating the first region includes activating the light source. In some examples, illuminating the first region includes changing light output by the light source. In some examples, illuminating the first region includes sending a request to the light source to modify light being output by the light source.

At 1506, in response to receiving the request to extend content being displayed on the first device and while content is being displayed on the first device and in accordance with a determination that the first device is located at a second location in the physical space, the computer system illuminates, via the light source, the second region of the physical space that has the respective spatial arrangement relative to the second location in the physical space with the first light pattern that is based on content that is being displayed on the first device (e.g., as illustrated in FIGS. 14A, 14B, 14C, and/or 14D). In some examples, illuminating the second region includes activating the light source. In some examples, illuminating the second region includes changing light output by the light source. In some examples, illuminating the second region includes sending a request to the light source to modify light being output by the light source. Conditionally illuminating a region in accordance with a location of the first device in the physical space allows for illumination to take into account the physical space, thereby providing improved visual feedback to the user, reducing the number of inputs needed to perform an operation, and performing an operation when a set of conditions has been met without requiring further user input.

In some examples, in response to receiving the request to extend content being displayed on the first device and while content is being displayed on the first device: in accordance with the determination that the first device is located at the second location in the physical space, the computer system forgoes illuminating, via the light source, the first region of the physical space with the first light pattern. Illuminating the second region without illuminating the first region allows for illumination to take into account the physical space, thereby providing improved visual feedback to the user, reducing the number of inputs needed to perform an operation, and performing an operation when a set of conditions has been met without requiring further user input.

In some examples, in response to receiving the request to extend content being displayed on the first device and while content is being displayed on the first device: in accordance with the determination that the first device is located at the first location in the physical space, the computer system illuminates, via the light source, a third region (e.g., 1404) of the physical space, wherein the third region is in front of the first device (e.g., between the first device and a user detected in the physical space) (e.g., on the floor in front of the device). In some examples, in response to receiving the request to extend content being displayed on the first device and while content is being displayed on the first device: in accordance with the determination that the first device is located at the second location in the physical space, the computer system illuminates, via the light source, a respective region (e.g., 1404) of the physical space different from the third region of the physical space. In some examples, the respective region is in front of the first device (e.g., between the first device and a user detected in the physical space) (e.g., on the floor in front of the device). Illuminating a region in front of the first device allows for illumination to take into account the physical space, thereby providing improved visual feedback to the user, reducing the number of inputs needed to perform an operation, and performing an operation when a set of conditions has been met without requiring further user input.

In some examples, in response to receiving the request to extend content being displayed on the first device and while content is being displayed on the first device: in accordance with the determination that the first device is located at the first location in the physical space, the computer system illuminates, via the light source, a fourth region (e.g., 1402) of the physical space, wherein the fourth region is behind the first device (e.g., further away from the first device relative to a user detected in the physical space) (e.g., on a wall behind the device). In some examples, in response to receiving the request to extend content being displayed on the first device and while content is being displayed on the first device: in accordance with the determination that the first device is located at the second location in the physical space, the computer system illuminates, via the light source, a respective region (e.g., 1402) of the physical space different from the fourth region of the physical space. In some examples, the respective region is behind the first device (e.g., further away from the first device relative to a user detected in the physical space) (e.g., on a wall behind the device). Illuminating a region behind the first device allows for illumination to take into account the physical space, thereby providing improved visual feedback to the user, reducing the number of inputs needed to perform an operation, and performing an operation when a set of conditions has been met without requiring further user input.

In some examples, the first light pattern includes different content (e.g., different visual content, such as projecting light that is a different color, shape, and/or size) from the content that is being displayed on the first device. In some examples, the different content is synchronized with the content (e.g., the different content changes along with the content, the different content corresponds to the content, and/or the different content is timed to be provided at the same time as respective content of the content) that is being displayed on the first device. The first light pattern including different content than the content that is being displayed on the first device allows for additional context and/or enhancement to be provided to a user during a content experience, thereby providing improved visual feedback to the user, reducing the number of inputs needed to perform an operation, and performing an operation when a set of conditions has been met without requiring further user input.

In some examples, the first light pattern includes a representation (and/or a copy) of the content that is being displayed on the first device (e.g., as illustrated in FIGS. 14A, 14B, 14C, and/or 14D). In some examples, the representation of the content is a modified version of the content that is being displayed on the first device, such as blurred, stretched, dimmed, and/or otherwise modified. The first light pattern including the representation of the content that is being displayed on the first device allows for the content to be expanded outside of the bounds of the first device, thereby providing improved visual feedback to the user and performing an operation when a set of conditions has been met without requiring further user input.

In some examples, the first light pattern includes a simulation (e.g., an interpolation, a virtual representation, and/or an estimate) of light being emitted from the content that is being displayed on the first device (e.g., the first light pattern includes light that is not included in the content that is being displayed on the first device). The first light pattern including the simulation of light being emitted from the content that is being displayed on the first device allows for additional context and/or enhancement to be provided to a user during a content experience, thereby providing improved visual feedback to the user, reducing the number of inputs needed to perform an operation, and performing an operation when a set of conditions has been met without requiring further user input.

In some examples, the content that is being displayed on the first device is part of a multi-dimensional representation (e.g., a two- or three-dimensional map) of an environment (e.g., a virtual and/or non-virtual environment or world). In some examples, the first light pattern is based on content (e.g., visual content, such as objects, background, and/or foreground) of the multi-dimensional representation of the environment that is not currently visible on the first device. The first light pattern being based on the content of the multi-dimensional representation of the environment that is not currently visible on the first device allows for additional context and/or enhancement to be provided to a user during a content experience, thereby providing improved visual feedback to the user, reducing the number of inputs needed to perform an operation, and performing an operation when a set of conditions has been met without requiring further user input.

In some examples, in response to receiving the request to extend content being displayed on the first device and while content is being displayed on the first device: in accordance with the determination that the first device is located at the first location in the physical space and in accordance with a determination that a user is located at a third location in the physical space, the computer system illuminates, via the light source, a region relative to (e.g., behind and/or near) the third location in a lower fidelity (e.g., desaturated and/or displayed with lower brightness) than the first region. In some examples, in response to receiving the request to extend content being displayed on the first device and while content is being displayed on the first device, in accordance with the determination that the first device is located at the second location in the physical space, in accordance with a determination that a user is located at a fourth location (e.g., the third location or a location different from the third location) in the physical space, the computer system illuminates, via the light source, a region relative to (e.g., behind and/or near) the fourth location in a lower fidelity (e.g., desaturated and/or displayed with lower brightness) than the second region. Illuminating the region relative to the third location in the lower fidelity than the first region allows for the user to see more detail closer to the first device than further away, thereby providing improved visual feedback to the user and performing an operation when a set of conditions has been met without requiring further user input.

Note that details of the processes described above with respect to method 1500 (e.g., FIG. 15) are also applicable in an analogous manner to the methods described herein. For example, method 1300 optionally includes one or more of the characteristics of the various methods described above with reference to method 1500. For example, the region of method 1300 can be the region of method 1500. For brevity, these details are not repeated below.

The foregoing description, for purpose of explanation, has been described with reference to specific examples. However, the illustrative discussions above are not intended to be exhaustive or to limit the invention to the precise forms disclosed. Many modifications and/or variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and/or modifications will become apparent to those skilled in the art. Such changes and/or modifications are to be understood as being included within the scope of the disclosure and examples as defined by the claims.

As described above, one aspect of the present technology is the gathering and use of data available from various sources to improve illumination. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide illumination to the user. Accordingly, use of such personal information data enables users to have better illumination. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of targeted illumination services, the present technology can be configured to allow users to select to “opt in” or “opt out” of participation in the collection of personal information data during registration for services or anytime thereafter. In another example, users can select not to provide personal-identifying data for targeted illumination services. In yet another example, users can select to limit the length of time personal-identifying data is maintained or entirely prohibit the development of a baseline illumination profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the illumination services, or publicly available information.

What is claimed is:

1. A method, comprising:
at a computer system that is in communication with a light source:
detecting a request to illuminate a region of a physical space; and
in response to detecting the request to illuminate the region of the physical space:
in accordance with a determination that the region of the physical space has a first property, providing, via the light source, a first type of illumination; and
in accordance with a determination that the region of the physical space has a second property different from the first property, forgoing providing the first type of illumination.

2. The method of claim 1, further comprising:
in response to detecting the request to illuminate the region of the physical space:
in accordance with a determination that the region of the physical space has a third property, providing a second type of illumination, wherein the second type of illumination is less illumination than the first type of illumination.

3. The method of claim 1, further comprising:
in response to detecting the request to illuminate the region of the physical space:
in accordance with a determination that the region of the physical space has a third property, forgoing providing illumination to the region of the physical space.

4. The method of any one of claim 1-3, further comprising:
in response to detecting the request to illuminate the region of the physical space:
in accordance with a determination that the region of the physical space has a fourth property, providing, via the light source, a third type of illumination different from the first type of illumination.

5. The method of any one of claims 1-4, wherein the determination that the region of the physical space has the first property includes a determination that the region has a first amount of reflectivity, and wherein the determination that the region of the physical space has the second property includes a determination that the region has a second amount of reflectivity different from the first amount of reflectivity.

6. The method of any one of claims 1-5, wherein the determination that the region of the physical space has the first property includes a determination that the region has a first amount of transparency, and wherein the determination that the region of the physical space has the second property includes a determination that the region has a second amount of transparency different from the first amount of transparency.

7. The method of any one of claims 1-6, wherein the determination that the region of the physical space has the first property includes a determination of whether a first person is present in the region.

8. The method of any one of claims 1-7, wherein the determination that the region of the physical space has the second property includes a determination of whether a face of a second person is present in the region.

9. The method of any one of claims 1-8, further comprising:
in response to detecting the request to illuminate the region of the physical space:
without regard to a property of the region of the physical space, providing, via the light source, a fourth type of illumination with respect to a second region of the physical space, wherein the second region is different from the region.

10. The method of any one of claims 1-9, wherein the light source is a single light emitting device.

11. The method of any one of claims 1-10, further comprising:
after providing the first type of illumination and in accordance with a determination that the region of the physical space has changed from the first property to a fifth property, providing, via the light source, a fifth type of illumination different from the first type of illumination.

12. The method of claim 11, wherein providing the fifth type of illumination in accordance with the determination that the region of the physical space has changed from the first property to the fifth property includes changing, via the light source, from the first type of illumination to the fifth type of illumination.

13. The method of any one of claims 11-12, further comprising:
after providing the fifth type of illumination, changing, via the light source, from the fifth type of illumination to the first type of illumination.

14. The method of any one of claims 1-13, wherein providing, via the light source, the first type of illumination includes:
in accordance with a determination that the region includes a surface with a first color, causing, via the light source, output of a second color; and
in accordance with a determination that the region includes a surface with a third color different from the first color, causing, via the light source, output of a fourth color different from the third color.

15. The method of any one of claims 1-14, further comprising:
after providing the first type of illumination and in accordance with a determination that a current time of day is a first time of day, changing, via the light source, from the first type of illumination to a sixth type of illumination, wherein the first type of illumination includes a first color temperature, and wherein the sixth type of illumination includes a second color temperature different from the first color temperature.

16. The method of any one of claims 1-15, further comprising:
after providing the first type of illumination, detecting a change in the physical space; and
in response to detecting the change in the physical space:
in accordance with a determination that the physical space has changed in a first manner, changing, via the light source, from the first type of illumination to a seventh type of illumination, wherein the first type of illumination includes a third color temperature, and wherein the seventh type of illumination includes a fourth color temperature different from the third color temperature.

17. The method of any one of claims 1-16, wherein:
the determination that the region of the physical space has the first property includes a determination that is made based on first data being detected by a sensor;
the determination that the region of the physical space has the second property includes a determination that is made based on second data being detected by the sensor;
the second data is different from the first data; and
the sensor is in communication with the computer system.

18. A non-transitory computer-readable medium storing one or more programs configured to be executed by one or more processors of a computer system that is in communication with a light source, the one or more programs including instructions for performing the method of any one of claims 1-17.

19. A computer system that is in communication with a light source, comprising:
one or more processors; and
memory storing one or more programs configured to be executed by the one or more processors, the one or more programs including instructions for performing the method of any one of claims 1-17.

20. A computer system that is in communication with a light source, comprising:
means for performing the method of any one of claims 1-17.

21. A computer program product, comprising one or more programs configured to be executed by one or more processors of a computer system that is in communication with a light source, the one or more programs including instructions for performing the method of any one of claims 1-17.

22. A non-transitory computer-readable storage medium storing one or more programs configured to be executed by one or more processors of a computer system that is in communication with a light source, the one or more programs including instructions for:
detecting a request to illuminate a region of a physical space; and
in response to detecting the request to illuminate the region of the physical space:
in accordance with a determination that the region of the physical space has a first property, providing, via the light source, a first type of illumination; and
in accordance with a determination that the region of the physical space has a second property different from the first property, forgoing providing the first type of illumination.

23. A computer system that is in communication with a light source, comprising:
one or more processors; and
memory storing one or more programs configured to be executed by the one or more processors, the one or more programs including instructions for:
detecting a request to illuminate a region of a physical space; and
in response to detecting the request to illuminate the region of the physical space:
in accordance with a determination that the region of the physical space has a first property, providing, via the light source, a first type of illumination; and
in accordance with a determination that the region of the physical space has a second property different from the first property, forgoing providing the first type of illumination.

24. A computer system that is in communication with a light source, comprising:
means for detecting a request to illuminate a region of a physical space; and
in response to detecting the request to illuminate the region of the physical space:
means for, in accordance with a determination that the region of the physical space has a first property, providing, via the light source, a first type of illumination; and
means for, in accordance with a determination that the region of the physical space has a second property different from the first property, forgoing providing the first type of illumination.

25. A computer program product, comprising one or more programs configured to be executed by one or more processors of a computer system that is in communication with a light source, the one or more programs including instructions for:
detecting a request to illuminate a region of a physical space; and
in response to detecting the request to illuminate the region of the physical space:
in accordance with a determination that the region of the physical space has a first property, providing, via the light source, a first type of illumination; and
in accordance with a determination that the region of the physical space has a second property different from the first property, forgoing providing the first type of illumination.

26. A method, comprising:
at a computer system that is in communication with a light source:
while detecting a user in a physical space, detecting a change in user activity in the physical space; and
in response to detecting the change in user activity in the physical space, changing lighting, via the light source, of the physical space while a user continues to be detected in the physical space.

27. The method of claim 26, wherein detecting the change in user activity in the physical activity includes detecting a change in sleep state of a first user.

28. The method of any one of claims 26-27, wherein detecting the change in user activity in the physical activity includes detecting that a first number of users detected in the physical space has changed from a first number to a second number different from the first number.

29. The method of claim 28, wherein the second number is greater than the first number.

30. The method of claim 28, wherein the second number is less than the first number.

31. The method of any one of claims 26-30, wherein detecting the change in user activity in the physical activity includes detecting that a second number of users detected in the physical space are performing an activity.

32. The method of any one of claims 26-31, wherein changing lighting of the physical space while the user continues to be detected in the physical space includes turning on or turning off at least a portion of lighting of the physical space.

33. The method of any one of claims 26-32, wherein changing lighting of the physical space while the user continues to be detected in the physical space includes changing an extent of lighting within the physical space.

34. The method of any one of claims 26-33, wherein detecting the change in user activity in the physical activity includes detecting that a second user is within a predetermined distance of a location within the physical space.

35. The method of any one of claims 26-34, wherein changing lighting of the physical space while the user continues to be detected in the physical space includes changing a region of the physical space that is illuminated from a first region of the physical space to a second region of the physical space different from the first region of the physical space.

36. The method of claim 35, wherein the first region and the second region are illuminated by the same light source.

37. The method of claim 35, wherein the first region is illuminated via a first light source, and wherein the second region is illuminated via a second light source different from the first light source.

38. The method of any one of claims 26-37, wherein the light source is a single light emitting device.

39. A non-transitory computer-readable medium storing one or more programs configured to be executed by one or more processors of a computer system that is in communication with a light source, the one or more programs including instructions for performing the method of any one of claims 26-38.

40. A computer system that is in communication with a light source, comprising:
one or more processors; and
memory storing one or more programs configured to be executed by the one or more processors, the one or more programs including instructions for performing the method of any one of claims 26-38.

41. A computer system that is in communication with a light source, comprising:
means for performing the method of any one of claims 26-38.

42. A computer program product, comprising one or more programs configured to be executed by one or more processors of a computer system that is in communication with a light source, the one or more programs including instructions for performing the method of any one of claims 26-38.

43. A non-transitory computer-readable storage medium storing one or more programs configured to be executed by one or more processors of a computer system that is in communication with a light source, the one or more programs including instructions for:
while detecting a user in a physical space, detecting a change in user activity in the physical space; and
in response to detecting the change in user activity in the physical space, changing lighting, via the light source, of the physical space while a user continues to be detected in the physical space.

44. A computer system that is in communication with a light source, comprising:
one or more processors; and
memory storing one or more programs configured to be executed by the one or more processors, the one or more programs including instructions for:
while detecting a user in a physical space, detecting a change in user activity in the physical space; and
in response to detecting the change in user activity in the physical space, changing lighting, via the light source, of the physical space while a user continues to be detected in the physical space.

45. A computer system that is in communication with a light source, comprising:
means for, while detecting a user in a physical space, detecting a change in user activity in the physical space; and
means for, in response to detecting the change in user activity in the physical space, changing lighting, via the light source, of the physical space while a user continues to be detected in the physical space.

46. A computer program product, comprising one or more programs configured to be executed by one or more processors of a computer system that is in communication with a light source, the one or more programs including instructions for:
while detecting a user in a physical space, detecting a change in user activity in the physical space; and
in response to detecting the change in user activity in the physical space, changing lighting, via the light source, of the physical space while a user continues to be detected in the physical space.

47. A method, comprising:
at a computer system that is in communication with a light source:
detecting an illumination request that corresponds to a request to illuminate a respective region of a physical space; and
in response to detecting the illumination request:
in accordance with a determination that the request corresponds to a first region of the physical space, illuminating, via the light source, the first region; and
in accordance with a determination that the request corresponds to a second region of the physical space different from the first region, illuminating, via the light source, the second region.

48. The method of claim 47, wherein detecting the illumination request includes detecting a first pointing input in the direction of the respective region of the physical space.

49. The method of any one of claims 47-48, wherein detecting the illumination request includes detecting a request to identify a location of an object.

50. The method of claim 49, wherein the location of the object is specified in the illumination request.

51. The method of claim 49, wherein the location of the object is determined via the computer system.

52. The method of claim 49, wherein:
in response to detecting the illumination request:
in accordance with a determination that the request corresponds to the first region and in accordance with a determination that the object has a first likelihood of being in the first region, the first region is illuminated in a first manner; and
in accordance with a determination that the request corresponds to the first region and in accordance with a determination that the object has a second likelihood of being in the first region, the first region is illuminated in a second manner different from the first manner.

53. The method of any one of claims 47-52, wherein illuminating via the light source, the first region includes:
for a first timeframe, moving the illumination of a first portion of the first region to a second portion of the first region at a first rate; and
after the first timeframe and for a second timeframe moving the illumination of the second portion of the first region to a third portion of the first region at the first rate, wherein the second portion of the first region is adjacent to the first portion of the first region and the third portion of the first region.

54. The method of claim 53, wherein the light source maintains a particular location while moving the illumination of the first portion of the first region to the second portion of the first region and moving the illumination of the second portion of the first region to the third portion of the first region.

55. The method of any one of claims 53-54, wherein detecting the illuminating request includes detecting input, and wherein the one or more portions of the first region are identified based on the input.

56. The method of any one of claims 53-55, wherein:
in accordance with a determination that a size of an object is a first size in the first portion of the first region and a size of a second object is a second size in the second portion of the first region, wherein the first size is smaller than the second size, a size of the illumination of the first portion of the first region is smaller than a size of the illumination of the second portion of the first region; and
in accordance with a determination that a size of the object is the first size in the first portion of the first region and the size of the second object is a third size in the second portion of the first region, wherein the first size is larger than the third size, the size of the illumination of the first portion of the first region is larger than the size of the illumination of the second portion of the first region.

57. The method of any one of claims 47-56, wherein:
the illumination request corresponds to a request for a device, different from the computer system, to output content;
in accordance with the determination that the first region includes the device, the respective region is the first region; and
in accordance with the determination that the second region includes the device, the respective region is the second region.

58. The method of claim 57, wherein the device different from the computer system is a smart speaker.

59. The method of claim 57, wherein the device different from the computer system is a television.

60. The method of any one of claims 47-59, wherein illuminating the first region includes:
in accordance with a determination that the illumination request corresponds to a first object, providing, via the light source, a first type of illumination; and
in accordance with a determination that the illumination request corresponds to a second object different from the first object, providing, via the light source, a second type of illumination different from the first type of illumination.

61. The method of any one of claims 47-60, further comprising:
while illuminating the first region, detecting that a second pointing input is no longer facing the first region; and
in response to detecting that the second pointing input is no longer facing the first region:
in accordance with a determination that a respective input has been detected, continuing to illuminate, via the light source, the first region; and
in accordance with a determination that the respective input has not been detected, ceasing to illuminate, via the light source, the first region.

62. The method of any one of claims 47-61, wherein the illumination request does not include an identifier of the respective region.

63. A non-transitory computer-readable medium storing one or more programs configured to be executed by one or more processors of a computer system that is in communication with a light source, the one or more programs including instructions for performing the method of any one of claims 47-62.

64. A computer system that is in communication with a light source, comprising:
one or more processors; and
memory storing one or more programs configured to be executed by the one or more processors, the one or more programs including instructions for performing the method of any one of claims 47-62.

65. A computer system that is in communication with a light source, comprising:
means for performing the method of any one of claims 47-62.

66. A computer program product, comprising one or more programs configured to be executed by one or more processors of a computer system that is in communication with a light source, the one or more programs including instructions for performing the method of any one of claims 47-62.

67. A non-transitory computer-readable storage medium storing one or more programs configured to be executed by one or more processors of a computer system that is in communication with a light source, the one or more programs including instructions for:
detecting an illumination request that corresponds to a request to illuminate a respective region of a physical space; and
in response to detecting the illumination request:
in accordance with a determination that the request corresponds to a first region of the physical space, illuminating, via the light source, the first region; and
in accordance with a determination that the request corresponds to a second region of the physical space different from the first region, illuminating, via the light source, the second region.

68. A computer system that is in communication with a light source, comprising:
one or more processors; and
memory storing one or more programs configured to be executed by the one or more processors, the one or more programs including instructions for:
detecting an illumination request that corresponds to a request to illuminate a respective region of a physical space; and
in response to detecting the illumination request:
in accordance with a determination that the request corresponds to a first region of the physical space, illuminating, via the light source, the first region; and
in accordance with a determination that the request corresponds to a second region of the physical space different from the first region, illuminating, via the light source, the second region.

69. A computer system that is in communication with a light source, comprising:
means for detecting an illumination request that corresponds to a request to illuminate a respective region of a physical space; and
in response to detecting the illumination request:
means for, in accordance with a determination that the request corresponds to a first region of the physical space, illuminating, via the light source, the first region; and
means for, in accordance with a determination that the request corresponds to a second region of the physical space different from the first region, illuminating, via the light source, the second region.

70. A computer program product, comprising one or more programs configured to be executed by one or more processors of a computer system that is in communication with a light source, the one or more programs including instructions for:
detecting an illumination request that corresponds to a request to illuminate a respective region of a physical space; and
in response to detecting the illumination request:
in accordance with a determination that the request corresponds to a first region of the physical space, illuminating, via the light source, the first region; and
in accordance with a determination that the request corresponds to a second region of the physical space different from the first region, illuminating, via the light source, the second region.

71. A method, comprising:
at a computer system that is in communication with a light source:
detecting a request to illuminate a region of a first physical space; and
in response to detecting the request to illuminate the region of the first physical space:
in accordance with a determination that a second physical space has a first context, illuminating, via the light source, the region of the first physical space to include a first abstract representation corresponding to the first context of the second physical space, wherein the second physical space is outside of the first physical space; and
in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

72. The method of claim 71, wherein illuminating the region to include the first abstract representation includes illuminating a portion of the region to form a simulated silhouette representing a first person.

73. The method of claim 72, wherein the simulated silhouette corresponds to a second person detected in the second physical space.

74. The method of claim 72, wherein the first person is not detected in the second physical space.

75. The method of any one of claims 71-74, wherein illuminating the region to include the first abstract representation includes illuminating a portion of the region to form a simulated silhouette representing a tree.

76. The method of claim 75, wherein the illumination changes over time based on weather in the second physical space.

77. The method of any one of claims 71-76, wherein the first abstract representation indicates a time of day.

78. The method of claim 77, wherein a color characteristic of the first abstract representation is based on the time of day.

79. The method of any one of claims 71-78, wherein the first abstract representation indicates weather of the second physical space.

80. The method of any one of claims 71-79, further comprising:
while illuminating the region of the first physical space to include the first abstract representation corresponding to the first context of the second physical space, detecting that a context of the second physical space has changed from the first context to a third context different from the first context; and
in response to detecting that the context of the second physical space has changed to the third context, illuminating, via the light source, the region of the first physical space to include a third abstract representation corresponding to the third context of the second physical space, wherein the third abstract representation is different from the first abstract representation.

81. The method of claim 80, wherein the third abstract representation includes a representation of a current location of the sun.

82. The method of any one of claims 80-81, wherein:
the first abstract representation includes a first indication of weather of the second physical space;
the third abstract representation includes a second indication of the weather of the second physical space;
the second indication is different from the first indication; and
the second indication represents a change in the weather of the second physical space.

83. The method of any one of claims 71-82, wherein the first abstract representation changes over a period of time.

84. The method of any one of claims 71-83, wherein:
in accordance with a determination that an object in the second physical space is a first size, the first abstract representation is a second size; and
in accordance with a determination that the object in the second physical space is a third size that is different from the first size, the first abstract representation is a fourth size that is different from the second size.

85. The method of any one of claims 71-84, wherein:
in accordance with a determination that a user has selected a first setting, the first abstract representation includes a first detail of the second physical space; and
in accordance with a determination that the user has selected a second setting different from the first setting, the first abstract representation does not include the first detail of the second physical space.

86. The method of any one of claims 71-85, further comprising:
after illuminating the region of the physical space to include an abstract representation corresponding to the second physical space, detecting a request to change the abstract representation to correspond to a third physical space different from the second physical space; and
in response to detecting the request to change the abstract representation to correspond to the third physical space, illuminating, via the light source, the region of the first physical space to include a fourth abstract representation corresponding to a context of the third physical space, wherein the third physical space is outside of the first physical space and the second physical space.

87. The method of claim 86, wherein the region of the first physical space is gradually illuminated over a period of time to include the fourth abstract representation corresponding to the context of the third physical space.

88. The method of any one of claims 86-87, wherein:
in accordance with a determination that the third physical space corresponds to the first physical space, the region of the first physical space is illuminated at a first rate; and
in accordance with a determination that the third physical space does not correspond to the first physical space, the region of the first physical space is illuminated at a second rate, wherein the first rate is faster than the second rate.

89. The method of any one of claims 71-88, wherein:
the first abstract representation includes a representation of a celestial object;
in accordance with a determination that the celestial object is at a first position relative to the second physical space, the representation of the celestial object is positioned at a first location within the first abstract representation; and
in accordance with a determination that the celestial object is at a second position relative to the second physical space, the representation of the celestial object is positioned at a second location within the first abstract representation, wherein the second location is different from the first location, and wherein the first position is different from the second position.

90. The method of claim 89, further comprising:
while the representation of the celestial object is positioned at the first location within the first abstract representation, detecting a passage of time; and
in response to detecting the passage of time and without detecting a respective user input, moving the representation of the celestial object from the first location within the first abstract representation to a third location within the first abstract representation.

91. The method of any one of claims 71-90, wherein illuminating the region of the first physical space to include the first abstract representation includes illuminating a third portion of the region to form a set of one or more silhouettes representing a first set of one or more objects, wherein the first set of one or more objects is positioned within the first physical space.

92. The method of any one of claims 71-91, wherein illuminating the region of the first physical space to include the first abstract representation includes illuminating a fourth portion of the region to form a simulated silhouette representing a second set of one or more objects, wherein the second set of one or more objects is positioned within the second physical space.

93. The method of any one of claims 71-92, wherein the computer system is a first computer system, the method further comprising:
before detecting the request to illuminate the region of the first physical space, receiving, from a second computer system different from the first computer system, a request to establish a communication between the first computer system and the second computer system, wherein the request to illuminate the region of the first physical space is associated with the communication.

94. The method of claim 93, wherein the second physical space corresponds to the communication with the second computer system.

95. The method of any one of claims 93-94, wherein the communication includes a first user and a second user different from the first user, and wherein the second physical space is selected by the first user or the second user.

96. The method of any one of claims 71-95, wherein the computer system is a third computer system, wherein the third computer system is in communication with a display generation component, the method further comprising:
before detecting the request to illuminate the region of the first physical space, receiving, from a fourth computer system different from the third computer system, a second request to establish a communication between the third computer system and the fourth computer system; and
after receiving the second request, displaying, via the display generation component, a user interface element, wherein the request to illuminate the region of the first physical space corresponds to a selection of the user interface element.

97. The method of claim 96, further comprising:
after receiving the second request and before establishing the communication between the third computer system and the fourth computer system, displaying, via the display generation component, a preview of the communication between the third computer system and the fourth computer system, wherein the preview is displayed while the user interface element is displayed.

98. The method of claim 96, wherein the user interface element is displayed after establishing the communication between the third computer system and the fourth computer system.

99. The method of any one of claims 71-98, further comprising:
in response to detecting the request to illuminate the region of the first physical space and while illuminating, via the light source, the region of the first physical space to include the first abstract representation, illuminating, via the light source, the region of the first physical space to include a fifth abstract representation corresponding to a fourth physical space, wherein the fourth physical space is different from the second physical space.

100. The method of any one of claims 71-99, further comprising:
in conjunction with detecting the request to illuminate the region of the first physical space, detecting an input corresponding to a respective time indication; and
in response to detecting the request to illuminate the region of the first physical space:
in accordance with a determination that the respective time indication is a first time indication, illuminating, via the light source, the region of the first physical space to include a sixth abstract representation corresponding to the first time indication; and
in accordance with a determination that the respective time indication is a second time indication different from the first time indication, illuminating, via the light source, the region of the first physical space to include a seventh abstract representation corresponding to the second time indication, wherein the seventh abstract representation is different from the sixth abstract representation.

101. The method of any one of claims 71-100, further comprising:
in conjunction with detecting the request to illuminate the region of the first physical space, detecting an input corresponding to a respective event; and
in response to detecting the input corresponding to the respective event:
in accordance with a determination that the respective event is a first event, illuminating, via the light source, the region of the first physical space to include an eight abstract representation corresponding to the first event; and
in accordance with a determination that the respective event is a second event different from the first event, illuminating, via the light source, the region of the first physical space to include a ninth abstract representation corresponding to the second event, wherein the eighth abstract representation is different from the ninth abstract representation.

102. The method of any one of claims 71-101, wherein illuminating the region of the first physical space to include the first abstract representation includes progressing through various visual states of the first abstract representation, the method further comprising:
detecting a selection of a setting that corresponds to illuminating, via the light source, the region of the first physical space to include the first abstract representation; and
in response to detecting the selection of the setting:
in accordance with a determination that the selection of the setting corresponds to a first setting, the illumination of the region of the first physical space to include the first abstract representation progresses through the various visual states of the first abstract representation at a first rate; and
in accordance with a determination that the selection of the setting corresponds to a second setting that is different from the first setting, the illumination of the region of the first physical space to include the first abstract representation progresses through the various visual states of the first abstract representation at a second rate that is different from the first rate.

103. The method of any one of claims 71-102, further comprising:
while illuminating, via the light source, the region of the first physical space corresponding to the first context of the second physical space, detecting a notification; and
in response to detecting the notification, modifying the illumination of the region of the first physical space.

104. A non-transitory computer-readable medium storing one or more programs configured to be executed by one or more processors of a computer system that is in communication with a light source, the one or more programs including instructions for performing the method of any one of claims 71-103.

105. A computer system that is in communication with a light source, comprising:
one or more processors; and
memory storing one or more programs configured to be executed by the one or more processors, the one or more programs including instructions for performing the method of any one of claims 71-103.

106. A computer system that is in communication with a light source, comprising:
means for performing the method of any one of claims 71-103.

107. A computer program product, comprising one or more programs configured to be executed by one or more processors of a computer system that is in communication with a light source, the one or more programs including instructions for performing the method of any one of claims 71-103.

108. A non-transitory computer-readable storage medium storing one or more programs configured to be executed by one or more processors of a computer system that is in communication with a light source, the one or more programs including instructions for:
detecting a request to illuminate a region of a first physical space; and
in response to detecting the request to illuminate the region of the first physical space:
in accordance with a determination that a second physical space has a first context, illuminating, via the light source, the region of the first physical space to include a first abstract representation corresponding to the first context of the second physical space, wherein the second physical space is outside of the first physical space; and
in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

109. A computer system that is in communication with a light source, comprising:
one or more processors; and
memory storing one or more programs configured to be executed by the one or more processors, the one or more programs including instructions for:
detecting a request to illuminate a region of a first physical space; and
in response to detecting the request to illuminate the region of the first physical space:
in accordance with a determination that a second physical space has a first context, illuminating, via the light source, the region of the first physical space to include a first abstract representation corresponding to the first context of the second physical space, wherein the second physical space is outside of the first physical space; and
in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

110. A computer system that is in communication with a light source, comprising:
means for detecting a request to illuminate a region of a first physical space; and
in response to detecting the request to illuminate the region of the first physical space:
means for, in accordance with a determination that a second physical space has a first context, illuminating, via the light source, the region of the first physical space to include a first abstract representation corresponding to the first context of the second physical space, wherein the second physical space is outside of the first physical space; and
means for, in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

111. A computer program product, comprising one or more programs configured to be executed by one or more processors of a computer system that is in communication with a light source, the one or more programs including instructions for:
detecting a request to illuminate a region of a first physical space; and
in response to detecting the request to illuminate the region of the first physical space:
in accordance with a determination that a second physical space has a first context, illuminating, via the light source, the region of the first physical space to include a first abstract representation corresponding to the first context of the second physical space, wherein the second physical space is outside of the first physical space; and
in accordance with a determination that the second physical space has a second context different from the first context, illuminating, via the light source, the region of the first physical space to include a second abstract representation corresponding to the second context of the second physical space that is different from the first abstract representation corresponding to the first context of the second physical space.

112. A method, comprising:
at a computer system that is in communication with a first device and a light source that is separate from the first device:
receiving a request to extend content being displayed on the first device to a physical space that includes a first region and a second region different from the first region; and
in response to receiving the request to extend content being displayed on the first device and while content is being displayed on the first device:
in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and
in accordance with a determination that the first device is located at a second location in the physical space, illuminating, via the light source, the second region of the physical space that has the respective spatial arrangement relative to the second location in the physical space with the first light pattern that is based on content that is being displayed on the first device.

113. The method of claim 112, further comprising:
in response to receiving the request to extend content being displayed on the first device and while content is being displayed on the first device:
in accordance with the determination that the first device is located at the second location in the physical space, forgoing illuminating, via the light source, the first region of the physical space with the first light pattern.

114. The method of any one of claims 112-113, wherein the first device is a television.

115. The method of any one of claims 112-114, further comprising:
in response to receiving the request to extend content being displayed on the first device and while content is being displayed on the first device:
in accordance with the determination that the first device is located at the first location in the physical space, illuminating, via the light source, a third region of the physical space, wherein the third region is in front of the first device.

116. The method of any one of claims 112-115, further comprising:
in response to receiving the request to extend content being displayed on the first device and while content is being displayed on the first device:
in accordance with the determination that the first device is located at the first location in the physical space, illuminating, via the light source, a fourth region of the physical space, wherein the fourth region is behind the first device.

117. The method of any one of claims 112-116, wherein the first light pattern includes different content from the content that is being displayed on the first device, and wherein the different content is synchronized with the content that is being displayed on the first device.

118. The method of any one of claims 112-117, wherein the first light pattern includes a representation of the content that is being displayed on the first device.

119. The method of any one of claims 112-118, wherein the first light pattern includes a simulation of light being emitted from the content that is being displayed on the first device.

120. The method of any one of claims 112-119, wherein the content that is being displayed on the first device is part of a multi-dimensional representation of an environment, and wherein the first light pattern is based on content of the multi-dimensional representation of the environment that is not currently visible on the first device.

121. The method of claim 120, further comprising:
in response to receiving the request to extend content being displayed on the first device and while content is being displayed on the first device:
in accordance with the determination that the first device is located at the first location in the physical space and in accordance with a determination that a user is located at a third location in the physical space, illuminating, via the light source, a region relative to the third location in a lower fidelity than the first region.

122. A non-transitory computer-readable medium storing one or more programs configured to be executed by one or more processors of a computer system that is in communication with a first device and a light source that is separate from the first device, the one or more programs including instructions for performing the method of any one of claims 112-121.

123. A computer system that is in communication with a first device and a light source that is separate from the first device, comprising:
one or more processors; and
memory storing one or more programs configured to be executed by the one or more processors, the one or more programs including instructions for performing the method of any one of claims 112-121.

124. A computer system that is in communication with a first device and a light source that is separate from the first device, comprising:
means for performing the method of any one of claims 112-121.

125. A computer program product, comprising one or more programs configured to be executed by one or more processors of a computer system that is in communication with a first device and a light source that is separate from the first device, the one or more programs including instructions for performing the method of any one of claims 112-121.

126. A non-transitory computer-readable storage medium storing one or more programs configured to be executed by one or more processors of a computer system that is in communication with a first device and a light source that is separate from the first device, the one or more programs including instructions for:
receiving a request to extend content being displayed on the first device to a physical space that includes a first region and a second region different from the first region; and
in response to receiving the request to extend content being displayed on the first device and while content is being displayed on the first device:
in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and
in accordance with a determination that the first device is located at a second location in the physical space, illuminating, via the light source, the second region of the physical space that has the respective spatial arrangement relative to the second location in the physical space with the first light pattern that is based on content that is being displayed on the first device.

127. A computer system that is in communication with a first device and a light source that is separate from the first device, comprising:
one or more processors; and
memory storing one or more programs configured to be executed by the one or more processors, the one or more programs including instructions for:
receiving a request to extend content being displayed on the first device to a physical space that includes a first region and a second region different from the first region; and
in response to receiving the request to extend content being displayed on the first device and while content is being displayed on the first device:
in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and
in accordance with a determination that the first device is located at a second location in the physical space, illuminating, via the light source, the second region of the physical space that has the respective spatial arrangement relative to the second location in the physical space with the first light pattern that is based on content that is being displayed on the first device.

128. A computer system that is in communication with a first device and a light source that is separate from the first device, comprising:
means for receiving a request to extend content being displayed on the first device to a physical space that includes a first region and a second region different from the first region; and
in response to receiving the request to extend content being displayed on the first device and while content is being displayed on the first device:
means for, in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and
means for, in accordance with a determination that the first device is located at a second location in the physical space, illuminating, via the light source, the second region of the physical space that has the respective spatial arrangement relative to the second location in the physical space with the first light pattern that is based on content that is being displayed on the first device.

129. A computer program product, comprising one or more programs configured to be executed by one or more processors of a computer system that is in communication with a first device and a light source that is separate from the first device, the one or more programs including instructions for:
receiving a request to extend content being displayed on the first device to a physical space that includes a first region and a second region different from the first region; and
in response to receiving the request to extend content being displayed on the first device and while content is being displayed on the first device:
in accordance with a determination that the first device is located at a first location in the physical space, illuminating, via the light source, the first region of the physical space that has a respective spatial arrangement relative to the first location in the physical space with a first light pattern that is based on content that is being displayed on the first device without illuminating, via the light source, the second region of the physical space with the first light pattern; and
in accordance with a determination that the first device is located at a second location in the physical space, illuminating, via the light source, the second region of the physical space that has the respective spatial arrangement relative to the second location in the physical space with the first light pattern that is based on content that is being displayed on the first device.
